(19) United States
(12) Patent Application Publication
(10) Pub. No.: US 2026/0195493 A1
(43) Pub. Date: Jul. 9, 2026

(54) AI-POWERED COLLABORATIVE PLATFORM FOR GENERATION OF DESIGN PLANS

(71) Applicant: Togal.AI Inc., Miami, FL (US)

(72) Inventors: Patrick E. Murphy, Miami, FL (US); Johnny Maghzal, Miami, FL (US)

(73) Assignee: Togal.AI Inc., Miami, FL (US)

(21) Appl. No.: 19/197,879

(22) Filed: May 2, 2025

Related U.S. Application Data
(60) Provisional application No. 63/741,855, filed on Jan. 4, 2025.

(51) Int. Cl. G06F 30/13; G06F 30/27; G06F 111/02

(52) U.S. Cl. CPC G06F 30/13; G06F 30/27; G06F 2111/02

(57) ABSTRACT

Methods, systems, and apparatus for generating and modifying architectural design plans using user commands, sketches, or drawings. The system incorporates an AI engine and a GAN engine to optimize design layouts based on user inputs, design considerations, and client-specific requirements. The system can automatically analyze design elements such as rooms, airflow paths, structural components, and spatial configurations to suggest improvements or flag inconsistencies. The system incorporates context-aware capabilities to evaluate how user-intended changes influence the overall design and its surrounding environment. Users can interact through various devices, providing input through gestures, text, or voice, while the system offers real-time feedback on conflicts, improvements, and compliance issues. Collaborative features enable multiple stakeholders to contribute, and the system provides a detailed, compliant design that adapts to design considerations including geographical, environmental, and technological requirements while maintaining high design integrity and flexibility throughout the process.

### CROSS REFERENCE TO RELATED APPLICATIONS

This application claims the benefit of and priority to U.S. Provisional Application No. 63/741,855, filed Jan. 4, 2025, and entitled AI-POWERED COLLABORATIVE PLATFORM FOR GENERATION AND EDITING OF DESIGN PLANS, the entire disclosure of which is incorporated herein by reference.

### FIELD OF THE INVENTION

The present invention relates to methods, systems, and apparatus for automated generation and modification of architectural design plans. More specifically, the present invention provides AI enhanced controllers that utilize one or more of: user input, sketches, drawings, agentic contributions, and other system input to create, analyze, and optimize architectural design plan layouts. The invention integrates one or both of: artificial intelligence (AI) and generative adversarial networks (GANs) to automatically generate design plans including one or more of: design elements such as spatial configurations, design elements, architectural features, airflow paths, plumbing, electrical, HVAC, and structural components. Additionally, the systems may provide real-time feedback and suggestions for improvements to existing design plans and support collaborative design processes, adapting to design considerations and client-specific requirements. The system may be configured to incorporate context-aware capabilities to evaluate how user-intended changes affect the overall design and environment, enhancing the design's adaptability to various project conditions.

### BACKGROUND OF THE INVENTION

The creation of architectural design plans has long been a foundational task in the fields of architecture, engineering, and construction. Design plans serve as blueprints that guide the development of structures, from simple residential homes to complex commercial buildings. Traditionally, design plans were crafted by hand, with architects and drafters spending considerable time drafting, measuring, and refining layouts on paper. Paper-based designs are often limited in scope and flexibility, requiring painstaking adjustments whenever modifications were required. The advent of computer-aided design (CAD) software revolutionized this process, allowing for precise, digital representations of design plans that could be manipulated, optimized, and stored electronically. CAD software reduced the time and effort required to create detailed architectural plans, introducing an era of efficiency in the design process.

CAD software allows users to generate and modify design plans using a digital user interface. With a wide array of tools and functionalities, CAD provides the capability to place design elements such as walls, doors, windows, and fixtures with precision. Over time, CAD evolved from simple two-dimensional (2D) drafting software into powerful three-dimensional (3D) modeling systems capable of simulating real-world conditions such as lighting, material stress, and airflow. This transformation opened up new possibilities for architects and designers, enabling them to not only create design plans but also visualize how those plans would perform in practice. Through CAD, design plans can now be modified and optimized in real time, allowing for greater flexibility in responding to client needs or construction requirements.

Despite these advancements, the process of generating and modifying design plans remains a labor-intensive task requiring highly skilled users, particularly when adjustments need to be made after the initial layout has been established. Traditionally, when a designer or user wants to change an aspect of the design, such as moving a wall or resizing a room, they must manually adjust the relevant components within the CAD software. This involves identifying the specific elements that need to be altered, considering the impact of the change on the overall design, and manually updating the model to reflect the new layout. For example, moving a window may require adjustments to the surrounding walls, changes to the lighting plan, and updates to the positioning of nearby fixtures. The complexity of these interrelated elements means that even small changes can ripple through the entire design, making modifications a time-consuming and challenging process.

### SUMMARY OF THE DISCLOSURE

Accordingly, the present invention provides innovative platforms that enable automated generation and modification of design plans via the use of advanced artificial intelligence (AI) engines, including the potential integration of a Generative Adversarial Network (GAN) processing. By leveraging one or both of AI and GAN technologies, the present invention transforms how architectural plans are created and revised, enabling users to input design requirements in a variety of ways and receive highly optimized design outputs.

The present invention allows for efficient generation of new design plans, and/or modification of existing design plans based upon user inputs, all while taking into account predefined objectives such as building deployment requirements and preferred design practices. This creates a flexible and adaptive platform for users across the architectural, engineering, and construction industries.

The AI engine and GAN processing integrated into the platform work together or independently to automate the design generation process. The AI engine may use its learned models to interpret user inputs, create structural layouts, and make suggestions based on best practices derived from a broad range of architectural design data. The GAN, with its capacity for generating realistic and creative outputs, helps to produce design elements and layouts that align with user specifications while offering creative alternatives that may not have been considered otherwise. For example, when tasked with generating a residential home design, the GAN can produce a variety of layouts and floor plan options, each optimized for space, aesthetics, and functional flow.

The system accepts various types of input, including written or verbal commands, which allows users with different skill levels to interact with the platform seamlessly. For example, a user may input a command such as “Create a two-story building with three bedrooms on the second floor and a large open kitchen on the first floor.” The system processes this input through the AI engine, interpreting the command and generating a design plan that meets the provided specifications. Alternatively, a verbal command such as “Add a balcony to the second floor, facing the south” may be processed through speech recognition, translated into actionable design elements, and integrated into the current design plan. This flexibility in input methods makes the system adaptable for users who may not be familiar with traditional CAD tools or who prefer more intuitive ways of interacting with design software.

In addition to generating new designs, the platform is also capable of receiving existing design plans as input. Once an existing design is uploaded, the system analyzes the plan for compliance with preferred design practices and building deployment objectives. This analysis may include evaluating whether the layout promotes efficient space utilization, whether the rooms are arranged for optimal functionality, or whether the flow of movement within the building aligns with the intended use. For example, in a commercial building plan, the system may evaluate whether the positioning of offices and meeting rooms encourages collaboration and accessibility, or whether certain areas are underutilized or difficult to access. The platform can highlight these issues and suggest specific revisions to improve the design's alignment with the project's objectives.

The system also allows users to modify existing design plans by providing additional inputs. These inputs can take many forms, from basic written commands such as “Move the kitchen to the north side of the house” to more complex instructions like “Add an outdoor patio adjacent to the living room, with sliding glass doors for access.” Once the input is processed, the AI engine analyzes the impact of the modification on the rest of the design, making important adjustments to maintain the overall functionality and aesthetic consistency of the layout. For example, moving the kitchen may necessitate a reevaluation of plumbing and electrical lines, or the addition of a patio may require shifting the orientation of other nearby rooms to accommodate outdoor access.

When a user provides input to modify an existing design, the system dynamically updates the plan in real time, offering immediate feedback on the changes. For example, if a user wants to enlarge a particular room by removing a wall, the system will adjust not only the room size but also the adjacent spaces, taking into account the structural implications of removing that wall. The AI engine may also offer alternative solutions, such as repositioning furniture or adjusting the layout to maintain the balance of the original design. These real-time modifications help streamline the design process, allowing users to explore different options quickly without having to redraw the entire plan manually.

The platform also facilitates more complex revisions by allowing users to input design preferences that impact multiple aspects of the building layout. For example, if a user prefers an open-concept design for the living and dining areas but wants to maintain privacy in the bedrooms, the system will generate a plan that reflects these preferences while suggesting ways to partition private spaces without compromising the open feel of the shared areas. In a commercial setting, the user may input instructions such as “Maximize natural light in the workspace while maintaining separation between client meeting rooms and employee offices.” The platform responds by adjusting window placements, wall orientations, and room arrangements to meet these goals.

Another example of the system's functionality is its ability to respond to site-specific constraints. A user may input that their building site is on a steep slope, or in a high-wind area, and request a design plan that takes these environmental factors into account. The AI engine processes these constraints and suggests modifications such as reinforced structural elements, wind-resistant roofing, or tiered foundations that adapt to the terrain. The user can further refine these suggestions by providing specific design inputs, like adjusting the slope of the roof or adding terraces to take advantage of the natural landscape.

The platform's adaptability extends to handling specific aesthetic or stylistic requests from users. For example, a user may specify that they want a modern, minimalist aesthetic with clean lines and large, open spaces. The GAN processing can generate a design that adheres to these stylistic preferences while maintaining the functional aspects of the layout. Similarly, a user may input a command such as “Design a colonial-style home with traditional features, including a front porch and symmetrical windows.” The system generates a design plan that incorporates these stylistic elements, offering a layout that is both functional and visually aligned with the user's aesthetic vision.

The platform is not limited to residential or commercial building designs. Users can also input requirements for more specialized structures, such as medical facilities, schools, or retail spaces. For example, a user may request a hospital wing with a layout that promotes efficient patient flow while maintaining privacy for each room. The AI engine processes these requirements and generates a plan that balances patient accessibility with important privacy features, such as placing nursing stations at central locations while allowing patient rooms to have adequate separation.

In scenarios where users are collaborating on a project, the platform allows multiple stakeholders to input their revisions or preferences simultaneously. For example, in a large-scale commercial development, the architect may input structural modifications, while the interior designer adds input regarding the layout of shared spaces. The AI engine processes all inputs in tandem, reconciling any potential conflicts and offering solutions that meet the combined objectives of the team. This collaborative functionality facilitates participation in the design process by all parties, streamlining communication and reducing the need for back-and-forth revisions.

The platform is also equipped with capabilities for generating revisions based on changing requirements throughout the project lifecycle. For example, a project that initially called for a single-story retail space may evolve into a multi-story complex as the client's needs change. The AI engine can process this new input and adjust an original design accordingly. Adjustments and modifications may include one or more of: adding a require number of floors, staircases, and elevators while maintaining an overall aesthetic and functional layout of the building. Similarly, a residential client who starts with a small, single-family home design may later request an expansion to accommodate a growing family. The system processes these inputs and modifies the plan by adding rooms, expanding common areas, or incorporating additional bathrooms.

The platform's flexibility in generating and modifying design plans also extends to user-defined constraints, such as budget or material preferences. For example, a user may input that they prefer sustainable building materials and request a design that reflects this preference. The AI engine processes this request and adjusts the design to include sustainable materials such as reclaimed wood or eco-friendly insulation. Additionally, the system can offer suggestions for materials that align with the user's budgetary constraints, helping to balance cost considerations with the overall design objectives.

The system's ability to analyze design plans for compliance with building deployment objectives also plays a significant role in the revision process. For example, a user may input that the building needs to accommodate a high level of foot traffic, and the platform will adjust the layout to include wider hallways, additional entry points, or designated traffic flow areas. Similarly, if a user specifies that the building must support future expansion, the AI engine may suggest layout configurations that allow for easy modifications, such as placing mechanical systems in locations that will not interfere with future construction.

One of the unique capabilities of the platform may be its ability to suggest revisions even when the user has not explicitly requested them. For example, if the system detects that the current design has inefficient space utilization or that a room layout is suboptimal for its intended use, it can generate suggestions for improvement. A user working on a retail space may input basic requirements for store layout, and the system can suggest additional features such as optimizing aisle spacing for customer flow or adjusting display areas to enhance product visibility.

The platform's functionality extends beyond simple layout generation and revision. It can also provide suggestions for optimizing building performance based on environmental factors or sustainability goals. For example, a user designing a home in a warm climate may input a request for energy-efficient cooling solutions, and the system can generate design modifications such as adding shading devices, optimizing window placements for cross-ventilation, or suggesting energy-efficient insulation materials. Similarly, a commercial developer may request a design that reduces energy consumption, and the platform can suggest energy-efficient lighting layouts, solar panel placements, or green roofing options.

Another embodiment of the system is its ability to handle highly specific user preferences in the context of accessibility and usability. For example, a user designing a facility for elderly care may input requirements for wider doorways, grab bars in bathrooms, and wheelchair-accessible ramps. The AI engine processes these inputs and generates a design that accommodates these accessibility features, so that the layout is functional for all users. Similarly, a user designing a school may input a request for child-friendly layouts, and the platform will adjust the plan to include safe play areas, easy-to-navigate hallways, and classrooms with flexible furniture arrangements.

In addition to generating and modifying design plans, the platform can also simulate how the design will perform in real-world scenarios. For example, a user designing a theater space may input preferences for optimal acoustics and seating arrangements. The AI engine processes these inputs and generates a design plan that maximizes sound quality and sightlines for every seat. The system can also simulate lighting conditions, airflow, and other environmental factors to provide users with a detailed understanding of how the design will function once built.

The platform's versatility also allows it to accommodate different architectural styles and preferences. For example, the GAN engine generates design elements based on predefined style templates such as modern, traditional, or minimalist. A user may input a request for a modern, minimalist design with an emphasis on open spaces and natural light. The GAN processing generates a design that reflects these preferences, creating a layout that features large windows, clean lines, and minimal ornamentation. Alternatively, a user may request a more traditional design with intricate detailing, and the system generates a plan that incorporates ornate moldings, classic symmetry, and traditional materials.

The platform's ability to process input and generate design plans in real time provides users with immediate feedback, allowing them to make informed decisions throughout the design process. For example, a user may input a request to increase the size of a bedroom, and the system immediately adjusts the layout to accommodate the change, while also providing feedback on how the modification affects adjacent rooms. This iterative process allows users to explore different design options and fine-tune their preferences without the need for extensive manual adjustments.

In some embodiments of the present invention, the innovative platform receives as input aspects of a first design plan and generates a dynamic interface allowing a user to view, annotate and/or modify one or more aspects of the first design plan, and generate a second design plan (or modify the existing design plan generated by system accessing one or both of an AI engine and GAN processing. A system according to the present invention accesses the power of AI and/or GANs to generate and/or modify a design plan that includes spatial parameters and spatial designations of design elements.

In some embodiments, the system anticipates an impact of user-requested changes before actually generating or finalizing the design plan. This proactive functionality enables the system to assess whether a proposed modification aligns with preferred design practices and the specific building deployment objectives established for the project. By doing so, the system not only automates the generation of design plans but also serves as an intelligent assistant that interacts with the user, guiding them through the design process and providing feedback on the feasibility or appropriateness of their requests.

For example, a user may input a request to shift a window from a side wall to a wall that separates two adjacent rooms, such as a bedroom and an office. Upon receiving this input, the system (combining AI engine and GAN processing) analyzes the proposed change in the context of the overall design and identifies a potential issue with the request. Specifically, placing a window between two interior rooms is generally not a preferred practice, as it compromises the privacy, functionality, and aesthetics of both spaces. Windows are typically installed on external walls to provide natural light, ventilation, and a connection to the outside environment. When a window is placed between two rooms, it may create an awkward visual element, offer no external light or ventilation benefits, and diminish the intended separation and privacy between the spaces.

In such a scenario, the system determines that the user's requested modification does not comply with the preferred practices of window placement or the deployment objectives that prioritize effective spatial separation and the optimal use of natural light. Instead of blindly executing the change, the system takes an interactive approach, warning the user about the potential violation and explaining why the requested adjustment may lead to undesirable outcomes. For example, the system may notify the user that “Shifting the window to the wall between the bedroom and office will not allow for natural light or ventilation and could reduce privacy between the two rooms. Are you sure you want to proceed with this change?”

By presenting this warning, the system may actively engage with the user, seeking confirmation before implementing a potentially suboptimal design decision. This interactive capability allows the system to function as more than just a passive design tool; it acts as a collaborator that helps users understand the consequences of their decisions in real time. In some embodiments, the system can even suggest alternative solutions that align with both the user's intent and design best practices. For example, it may suggest, “Instead of placing the window between the rooms, consider enlarging the windows on the external wall for more light or adding a skylight to achieve similar results without compromising room separation.”

The system's ability to ask questions and clarify the user's intentions before finalizing changes enhances the overall design process. It helps prevent mistakes that could compromise the building's functionality or aesthetic appeal, reducing the need for revisions later in the project. This conversational interaction may also allow users to explore different design possibilities with the guidance of the system, so that their modifications align with broader architectural principles. By incorporating this dynamic, context-sensitive feedback loop, the platform becomes a powerful tool for users who may not be familiar with all aspects of design but still wish to maintain control over the layout and functionality of their space.

In some embodiments of the present invention, the system provides an interactive user interface that allows a user to hand-draw a design plan, such as by using a mouse, stylus, or touchscreen display. The interactive user interface is operative to offer a flexible and intuitive way for users to create or modify design layouts without requiring the technical knowledge typically associated with CAD software. The hand-drawn design, which may consist of rough sketches of walls, rooms, and spaces, is interpreted by the system, which converts these sketches into a more structured and realistic design plan, potentially using GAN capabilities to refine and optimize the output.

For example, a user may draw a simple sketch of a house layout with a few rough lines representing walls, the positions of rooms, and a large rectangle indicating a central living area. Using advanced image recognition and pattern analysis, the system analyzes the hand-drawn input, recognizing the intended structure and spatial relationships between the drawn elements. It interprets the boundaries of the rooms, the proportions of spaces, and the positioning of walls based on the sketch's overall layout. For example, the system can understand that parallel lines represent walls and that enclosed spaces are likely to represent rooms.

Once the system has interpreted the basic structure from the hand-drawn sketch, it converts the drawing into a more formalized design plan. This conversion process may involve adjusting irregular lines, resizing rooms for more accurate proportions, and aligning walls to create a coherent and functional floor plan. GAN capabilities can assist in this transformation by learning from a vast dataset of architectural designs to generate a refined layout that adheres to architectural standards and preferred practices. For example, if the hand-drawn plan shows an open living room with adjacent bedrooms, the GAN may generate a realistic layout that optimizes space between the rooms, adjusts the dimensions for comfortable living, and includes appropriate doors and windows.

The system can also fill in details that may have been omitted or unclear in the hand-drawn plan. For example, if a user draws rough outlines of a kitchen but does not include specifics like where appliances or counters should go, the system can intelligently suggest and/or generate common kitchen layouts based on the space available, the user's overall design style, and best practices in kitchen design. The GAN may generate suggestions for the placement of counters, cabinets, and appliances in a way that maximizes efficiency and adheres to common design principles for that type of space.

Furthermore, the interactive nature of the interactive user interface allows the user to refine their hand-drawn sketch even after the system interprets it. Once the system generates a realistic design plan, the user can go back and make adjustments, adding or modifying walls, resizing rooms, or shifting elements. The system processes these updates in real time, reinterpreting the changes and refining the design output dynamically. For example, if the user decides to add an additional room or resize a bedroom, the system adjusts the layout, accordingly, reprocessing the hand-drawn input and producing an updated design plan that reflects the new configuration.

In some embodiments, the present the context of the design plan and actively engage with the user to refine specific spaces within the design. The system automatically identifies areas within the plan that require definition and clarification, such as identifying an unmarked area that appears to be designated for a specific function, like a kitchen, based on the spatial arrangement and surrounding elements. Upon recognizing such a space, the system may prompt the user to confirm the intended purpose of the area and provide additional information to complete the design.

For example, during the generation or modification of a design plan, the system may identify an enclosed space near the central living area, adjacent to a dining space, and interpret this as a potential kitchen based on typical building layouts and the spatial relationship between rooms. The system may automatically mark this space and may ask the user, “Is this area intended to be a kitchen?” If the user confirms, the system proceeds by asking for additional details that would help define the kitchen's layout and dimensions.

The system may prompt the user to input area dimensions for the kitchen or any other space. The user may input specific measurements or general requirements, such as “I want the kitchen to be 150 square feet.” The system uses this input to adjust the layout of the kitchen within the context of the surrounding rooms, so that the space is proportionate and functional within the overall design. Additionally, the system may ask follow-up questions to further refine the space, such as “Would you like the kitchen to be open to the living area or enclosed?” or “Where should the main counter and sink be positioned?”

Understanding the broader context of the building may be another important function of the system in such embodiments. The system may ask the user relevant questions to adapt the design to the surrounding environment. For example, the system may prompt the user by asking, “Is there any existing building nearby?” If the user indicates that there is, the system may ask for the direction and proximity of the existing structure in relation to the current design. For example, if there is an adjacent building to the north of the proposed site, the system can consider this when optimizing the placement of windows, entrances, or outdoor spaces in the new building. It may suggest, “Since there is a building to the north, we recommend placing windows on the south side to maximize natural light.”

Furthermore, the system can inquire about the preferred orientation of the proposed building in relation to cardinal directions. It may ask the user, “Would you like the building to face east?” or “What direction should the main entrance face?” Based on the user's response, the system can adjust the positioning of the building, aligning it with the specified orientation. For example, if the user prefers the building to face east, the system may recommend positioning the entrance on the east side and optimizing the placement of windows and outdoor spaces to take advantage of morning sunlight.

Additionally, the system can offer context-based suggestions regarding the overall layout, considering factors such as wind patterns, sunlight exposure, and privacy concerns. For example, if the user confirms that there is an existing building to the north, the system may recommend placing outdoor living areas on the opposite side of the house to maximize privacy and natural light. Similarly, if the building is located in an area where high winds frequently come from the west, the system may suggest orienting the building in a way that reduces wind exposure to key areas like windows and entrances.

In some embodiments of the present invention, receives as input a user preference while generating or modifying design plans. User preferences may involve principles that govern an orientation, layout, and placement of rooms and structures based on natural elements and cardinal directions, aiming to create harmony between the building's occupants and the environment. By considering user preferences, the controller generates design plans that align with these user provided guidelines, offering users a building layout that is not only functional but also aesthetically acceptable.

User preferences may cause the controller to analyze a design plan in terms of almost any input, such as a cardinal direction (North, South, East and West), or physical features nearby, such as a potential view, and recommend specific placements of rooms and elements based on these inputs. For example, a kitchen may be placed in the southeast corner of the house to enjoy a view or increased sunshine into the building. The system may consider user inputs when generating a new design or modifying an existing plan, automatically suggesting that the kitchen be located in the southeast portion of the building.

In some cases, a client may input a command to generate modern and innovative designs that challenge traditional norms. For example, a client may request an ultra-modern design with large, cantilevered structures and minimalist interiors that may not align with cultural principles or common design practices. In such cases, systems according to the present invention may accommodate the request by generating a design that meets the client's futuristic vision while subtly incorporating aspects of traditional principles, such as facilitating good airflow or strategically placing windows for optimal light and energy efficiency. This flexible approach allows the system to merge both innovative design concepts and foundational practices when creating a customized solution for the client.

In some embodiments of the present invention, the system is configured to generate or modify design plans based on one or more considerations, which may include preferred practices, building deployment objectives, building codes, cultural principles, client-specific requirements, or other relevant factors. These considerations can be selectively enabled or prioritized during the design generation, modification, or analysis process, allowing for a highly customizable and context-driven approach to architectural design.

When a user interacts with the system, they may choose to activate or emphasize specific considerations based on their design goals. For example, in a residential project, the client may prioritize cultural principles for the arrangement and orientation of rooms, while also specifying personal preferences, such as open-plan living spaces or a large kitchen. At the same time, the system may be required to adhere to preferred architectural practices that promote efficient space utilization and compliance with building deployment objectives, such as energy efficiency or functional layout. In such cases, the system dynamically incorporates all of these considerations during the design process, so that the resulting plan meets both traditional and modern needs.

The system's AI engine processes these inputs, determining how to weigh and integrate each consideration. For example, if preferred practices suggest that bedrooms should be located away from high-traffic areas for privacy and quiet, while cultural principles recommend positioning the master bedroom in the southwest, the system analyzes how these objectives overlap and generates a plan that satisfies both guidelines. It may recommend placing the master bedroom in the southwest corner of the building, so that it remains distant from common areas such as the living room and kitchen, thereby aligning with both preferred practices and cultural principles. This type of analysis enables the system to harmonize various considerations while avoiding conflicts between them.

In other cases, a user may choose to prioritize building deployment objectives over traditional guidelines like cultural or preferred practices. For example, in the case of a commercial project, the primary objective may be to maximize usable floor space and improve foot traffic flow through retail areas. The system, in such cases, can focus on these objectives, generating a design that optimizes the arrangement of entrances, corridors, and public spaces to facilitate customer movement and provide efficient use of space. If cultural or other traditional guidelines are less important in such a context, the system deprioritizes them or may only suggest subtle adjustments that align with those principles without disrupting the building's functional objectives.

Moreover, the system allows for customization of client-specific requirements, which may sometimes override traditional or industry-standard practices. For example, a client may prefer a modern aesthetic with large glass walls and minimal partitioning, even if cultural or preferred practices recommend more conservative window placements to control heat and light. The system can recognize, determine, or receive client preferences, generating a design that emphasizes modern design elements while subtly incorporating practical suggestions such as advanced glazing techniques or strategic shading to minimize potential issues related to light exposure and energy efficiency.

In embodiments where cultural principles are activated, the system intelligently adjusts room placements and building orientations according to those guidelines, so that spaces like kitchens, bedrooms, and living rooms are aligned with the cardinal directions specified by cultural. At the same time, the system can accommodate other considerations like building deployment objectives, which may require optimizing the layout for construction feasibility or future expansion. For example, the system may suggest a modular design that adheres to cultural guidelines for initial construction but allows for easy modification or expansion without disrupting the overall energy balance of the building.

During the modification of an existing design plan, the system can also adapt to changes in priority or new considerations introduced by the user. For example, a client may initially focus on preferred practices during an initial design phase but later prioritize budget constraints or material sustainability for environmental reasons. The system, recognizing these shifts in emphasis, modifies the plan, accordingly, optimizing material usage, and construction costs while maintaining the core elements of the design that adhere to cultural and other foundational principles.

Additionally, the system allows for interactive user input when generating or modifying design plans, asking the user to clarify which considerations should take precedence in case of conflicting requirements. For example, if the system detects that a client's request for large south-facing windows may conflict with energy efficiency objectives, it may prompt the user with options such as “Would you prefer larger windows for aesthetic reasons or reduced window size to improve energy efficiency?” Based on the user's response, the system adjusts the design accordingly, either favoring the aesthetic preference or implementing more efficient solutions that better align with building deployment objectives.

The system can also be configured to analyze the impact of various considerations in real time, providing feedback and suggestions to the user as the design evolves. For example, if the client requests a specific change, such as relocating a bathroom to an area where it may affect plumbing efficiency or disrupt the flow of nearby rooms, the system analyzes this request and asks, “This change may reduce water usage efficiency and disrupt room flow. Would you like suggestions for alternative placements?” By offering these context-aware prompts, the system facilitates that the design process remains user-centric while also respecting broader architectural principles.

Furthermore, the system's ability to selectively enable or disable certain considerations (e.g., selected by a user) allows for tailored design experiences across different types of projects. For a traditional residential home, the user may prioritize cultural, client preferences, and preferred practices. However, for a large office building, the system may focus primarily on building deployment objectives like maximizing workspace efficiency, optimizing employee movement, and integrating modern sustainability practices such as solar panel placement or energy-efficient HVAC systems.

In some cases, the system may also offer suggestions for balancing multiple considerations. For example, if a client requests a specific design that conflicts with both cultural principles and energy-efficient practices, the system may provide compromise options, such as slightly modifying the window placement to better align with cultural, while also incorporating shading techniques or energy-efficient materials to address energy concerns. These compromise solutions allow the user to meet multiple objectives without sacrificing key aspects of the design.

The integration of AI engine to generate dynamic user interfaces based upon static design plan documents presented new opportunities to overcome the limitations of traditional annotation methods. AI technologies are used to automate updating of annotations in response to changes in the dynamic interface based upon a static design plan, predict the impact of such changes (and/or annotations), and facilitate more effective communication among stakeholders over a time sequence. The present invention facilitates a shift towards more intelligent, responsive, and collaborative design tools allowing spatially relevant annotation provided by one or both of a user and an AI Engine (or other automation).

The proposed invention aims to significantly improve communication and efficiency among architects, engineers, and stakeholders by providing a shared space where users can collaboratively annotate, discuss, and modify design plans in real time. This environment fosters a more inclusive and dynamic design process, where feedback and changes are instantly shared and addressed (through AI-assisted analysis), reducing the need for multiple meetings or extensive email chains.

Accordingly, the present invention provides methods, apparatus and systems for users (e.g.: architects, owners, developers, engineers, compliance reviewers, builders, and other users to annotate a dynamic interface based upon a static two-dimensional (sometimes referred to herein as “2D”) or three dimensional (sometimes referred to herein as “3D”) references, such as floorplans, design plans, blueprints, and the like, with the aid of artificial intelligence (sometimes referred to herein as “AI” and an AI platform programmed to accomplish the methods described herein as an “AI Engine”).

According to the present invention, automated systems, apparatus, and methods provide tools that empower users to select spatial designations, such as those associated with specific segments, elements or components within a design plan and associate one or more annotations with the spatial designation and/or segment, element, or component. In some embodiments, automated processes discern a specific type of element present within a design plan based on a pixel-level examination by the AI engine. Elements may encompass a diverse array of features, including but not limited to: walls, windows, doors, stairwells, staircases, ramps, ceilings, floors, columns, beams, roofs, skylights, facades, and other architectural components. Furthermore, the present invention provides users with the capability to intelligently annotate these elements (including annotating lines and polygons), significantly enhancing the precision and utility of design plan modifications. This dynamic annotation process, (which may be powered by the AI engine) allows for annotations to adapt in real time to changes within the design plans.

In some embodiments, annotations may be designated to remain accurately aligned with an intended design element, even as modifications are made to the design element and/or other aspects of the design plan. The AI engine may facilitate spatial alignment of an annotation by automatically updating annotations based on the AI Engine's analysis of design components' spatial relationships and dimensions. This level of intelligence in annotation not only streamlines the design review and modification process but also enhances collaborative efforts by maintaining a consistent and up-to-date representation of the design intent across all user interactions.

By enabling detailed and dynamic annotations in a user interface based upon a static design plan, the present invention empowers stakeholders involved in a process referencing the design plan to achieve a higher degree of accuracy, efficiency, and collaboration, ultimately leading to the realization of more sophisticated and well-coordinated projects.

Artificial Intelligence (AI) has permeated various sectors, automating, and enhancing tasks that require data analysis, pattern recognition, and decision-making. In the context of design and planning, AI can dramatically transform how annotations, modifications, and interactions with design plans are handled. An AI-powered platform can intelligently interpret and process spatial annotations, automate repetitive tasks, and provide predictive insights, thereby enhancing the design process's efficiency and accuracy.

In some embodiments, automated systems described by the present invention may maintain a dynamic user interface similar to an up-to-date digital twin of a portion of a building. The dynamic user interface may reflect thought processes, alterations in a physical environment, or suggestions for improvements, back to the dynamic user interface based upon the static design plan. Such synchronization may facilitate (by way of non-limiting example) more accurate material lists, cost assessments, workforce allocation, and adherence to best practices, thereby optimizing the collaborative process in planning, executing, and managing architectural projects.

In general, the present invention provides for apparatus and methods related to receiving as input static representations (either physical or electronic, and either two-dimensional or three-dimensional) and generating one or more pixel patterns based upon automated processing of the static representations. The pixel patterns are analyzed using computerized processing techniques to mimic the perception, learning, problem-solving, and decision-making formerly performed by human workers (sometimes referred to herein as artificial intelligence or “AI”). The AI analysis process is repeated for multiple static representations over time, each static representation including a change to the design of a building. The AI processes denote, and track changes made in the sequence of static representations of design documents.

Based upon AI analysis of pixel patterns derived from the two-dimensional references and knowledge accumulated from increasing volumes of analyzed two-dimensional references, interactive user interfaces may be generated that allow for a user to modify dynamic static representations of features gleaned from the two-dimensional reference. The interactive user interfaces may enable users to select specific portions or segments on the design plans, wherein the AI engine employs AI processing to determine the elements or components present within the chosen segment by analyzing the pixel patterns of the two-dimensional references. AI processing of the pixel patterns, based upon the two-dimensional references, may include mathematical analysis of polygons formed by joining select vectors included in the two-dimensional reference. The analysis of pixel patterns and manipulatable vector interfaces and/or polygon-based interfaces is advantageous over human processing in that AI analysis of pixel patterns, vectors and polygons is capable of leveraging knowledge gained from previous work, whether or not a human was involved, hence the importance of integrating our AI with existing databases.

In still another aspect, in some embodiments, enhanced interactive interfaces may include one or more of: user definable and/or editable lines; user definable and/or editable vectors; and user-definable and/or editable polygons. The interactive interface may also be referenced to generate diagrams based on the lines, vectors and polygons defined in the interactive interface. Still further, various embodiments include values for variables that are definable via the interactive interface with AI processing and human input.

According to the present invention, analysis of pixel patterns and enhanced vector diagrams and/or polygon-based diagrams may include one or more of: neural network analysis, opposing (or adversarial) neural networks analysis, machine learning, deep learning, artificial intelligence techniques (including strong AI and weak AI), forward propagation, reverse propagation and other method steps that mimic capabilities normally associated with the human mind, including learning from examples and experience, recognizing patterns and/or objects, understanding and responding to patterns in positions relative to other patterns, making decisions, solving problems. The analysis also combines these and other capabilities to perform functions the skilled labor force traditionally performed.

The methods and apparatus of the present invention are presented herein generally, by way of example, to actions, processes, and deliverables important to industries such as the construction industry, by providing users with the capability to intelligently annotate design plan elements (including annotating lines and polygons). Building upon its innovative capabilities, the present invention further enhances the design and planning process by offering automated suggestions for annotating design plan elements. Leveraging the power of artificial intelligence, the system intelligently generates recommendations for annotations, streamlining the initial stages of the annotation process and facilitating the rapid identification and marking of key design elements, facilitating comprehensive and meaningful annotations from the outset.

Moreover, the invention dynamically updates annotations in response to modifications within the design plan. This responsiveness is not merely reactive; it may be anticipatory, guided by the AI engine's analysis of existing annotation threads and historical data pertaining to similar design elements or modifications. Through this advanced analysis, the platform identifies patterns and commonalities in how certain design changes have been annotated in the past, applying this insight to suggest or automatically adjust annotations in the current context. By integrating past learnings and contextual understanding, the system facilitates that annotations are consistently aligned with best practices and the specific nuances of the project at hand. Consequently, this invention not only adapts to the evolving needs of the design plan but also evolves itself, learning from each interaction to provide more informed, precise, and helpful annotations (or annotation suggestions) over time.

In some specific examples, the present invention uses machine learning and/or artificial intelligence to identify architectural aspects and materials, such as walls, stairwells, floors, ceilings, doors, windows, and HVAC components, within the selected portion of the design plan. The present invention identifies such architectural aspects and other building features, and provides dynamic association between design plan elements such as objects, polygons, or lines and their corresponding annotations. Such embodiment facilitates that when a user moves a design plan element within the digital workspace as part of design plan modification, any associated annotations are automatically moved in tandem with the element. This feature is powered by the underlying artificial intelligence (AI) engine, which intelligently recognizes the linkage between the spatial characteristics of design elements and their annotated descriptions or markers.

Upon initiating a move action for a given design element, the system calculates the new position of the element and simultaneously updates the positions of all related annotations. This process is seamless and requires no additional input from the user, thereby enhancing the efficiency of the design modification process. The system facilitates that annotations retain their spatial relevance to the design elements they describe, regardless of how these elements are repositioned within the design plan. By automating the concurrent movement of annotations with their respective design elements, the invention significantly reduces the risk of errors and streamlines the workflow. Furthermore, the intelligent handling of this feature extends to the recognition of complex movements and transformations of design elements, such as rotations, scaling, or mirroring. The AI engine adeptly adjusts the annotations to maintain their correct orientation and relationship to the elements, providing a robust solution that supports a wide range of design activities.

Further, the system is equipped to generate automated annotations in response to changes within the design plan or specific design plan elements, thereby offering a proactive approach to documenting and communicating these modifications. This functionality may particularly be valuable for tracking alterations over the course of a project's development, so that all stakeholders are promptly informed of updates. Additionally, in instances where changes occur to elements that previously lacked annotations, the system leverages its AI engine to intelligently create appropriate annotations for these newly modified elements. These automated annotations are generated based on a sophisticated analysis conducted by the AI engine, which considers the nature of the change, the context within the overall design plan, and historical data on similar modifications. This capability facilitates that every change, regardless of its prior annotation status, is accurately documented and communicated, enhancing the collaborative and iterative nature of the design process.

In some preferred embodiments, the AI Engine is seamlessly integrated with databases housing a repository of past similar projects. These databases serve as invaluable resources, facilitating the AI engine's learning process by drawing insights from diverse user decisions made in comparable prior works. This integration empowers the AI Engine with a wealth of accumulated knowledge, enhancing its ability to offer informed and contextually relevant recommendations.

Furthermore, according to some embodiments of the present invention, the system can be integrated with advertisement platforms that deliver advertisements to users on the interactive user interfaces. The advertisement may comprise but is not limited to: components from particular brands that align with both the required quality standards and the user's budget, alternative components from diverse brands, comprehensive lists of materials complete with pricing and purchase options, and even contact information or details of contractors and architects available for hire, specializing in the realization of the actual building based on the design plan.

A two-dimensional reference, such as a design floorplan is input into an AI engine and the AI engine converts aspects of the floorplan into components that may be processed by the AI engine, such as, for example, a rasterized version of the floorplan. The floorplan is then processed with machine learning to specify portions that may be specified as discernable components. Discernable components may include, for example, rooms, residential units, hallways, stairs, dead ends, windows, or other discrete aspects of a building.

A scaling process is applied to the floorplan and size descriptors are assigned to the discernable components. In addition, distances, such as, for example, a distance to an exit from the furthest point in a residential unit are calculated.

In general, the present invention provides for apparatus and methods related to receiving as input design plans (either physical or electronic) and generating one or more pixel patterns based upon automated processing of the design plans. The pixel patterns are analyzed using computerized processing techniques to mimic the perception, learning, problem-solving, and decision-making formerly performed by human workers (such computerized processing techniques are sometimes referred to herein as artificial intelligence or “AI” processing or analysis).

Based upon AI analysis of pixel patterns derived from the two-dimensional references and knowledge accumulated from increasing volumes of analyzed two-dimensional references, interactive user interfaces may be generated that allow for a user to modify dynamic design plans of features gleaned from the two-dimensional reference. AI processing of the pixel patterns, based upon the two-dimensional references, may include mathematical analysis of polygons formed by joining select vectors included in the two-dimensional references.

In specific embodiments of the invention, the method involves several key processes: receiving static representations of a design plan as input into a controller housing the AI engine; generating pixel patterns through automated processing of these representations; analyzing multiple static representations over time using the AI engine; representing the design plan (or a portion of it) as a raster image; utilizing the AI engine on the controller to analyze the raster image, identifying components depicted in the design plan; determining the scale of these components; constructing a user interface featuring various components, arranging them to establish boundaries; generating features' areas or lengths based on these boundaries; enabling user selection of a segment within the design plan via the user interface; leveraging the AI engine to identify the component(s) within the chosen segment, employing AI analysis of the segment's polygons; and finally, displaying comprehensive data related to the identified component(s) on the user interface. Furthermore, alternative embodiments may comprise computer systems, apparatus, and computer programs stored on one or more computer storage devices. Each configuration is tailored to execute the aforementioned methods and functionalities.

In specific embodiments of the invention, the process of selecting a segment may involve one or both of the following actions: marking around or on the desired segment or design element directly within the user interface or utilizing a polygon shape tool accessible on the interface, enabling users to drag and position the shape onto the desired segment. Moreover, the selection of a segment can be initiated either manually by a user or automatically by the AI engine. Additionally, when employing the polygon shape tool, users may choose from a range of polygon shapes provided by the AI engine within the user interface for selection and placement.

In specific embodiments of the invention, the AI engine analyzes the selected segment or design element based on pixel-level analysis of the selected segment or design element area within the design plan covered by the user-provided marking or the selected polygon shape. The pixel-level analysis may comprise considering the pixels of the static representation for analysis if the pixels are at and/or around a tolerable distance from the marking or boundaries of the polygon shape. The pixel-level analysis may comprise analyzing the polygon pixel patterns of the segment covered by the selected polygon shape. The pixel-level analysis may further comprise considering the pixels of the static representation for analysis if the pixels are at a predefined distance from each other creating a particular spatial relationship. The spatial relationship may be defined by a user or automatically learned by the AI engine.

In some embodiments of the present invention, the system may include management and interaction of annotations within the design plan to facilitate the integrity and utility of collaborative feedback. In such a system, annotations made by any user cannot be directly deleted or significantly altered by others without the original annotator's consent. Should any user attempt to modify or delete an annotation, the system, powered by the artificial intelligence (AI) Engine, automatically triggers a notification process. This notification is sent to the original user who added the annotation, providing them with the option to approve or disapprove the proposed change or deletion. This mechanism facilitates that each annotation's original intent and value are preserved until the contributor validates the necessity for alteration, thereby maintaining a coherent and collaborative annotation history.

Further enhancing user interaction with annotations, such embodiments may also incorporate features such as the ability for users to ‘like’ annotations made by others. These interactions serve a dual purpose: firstly, as a means of acknowledging the usefulness or relevance of specific annotations within the collaborative environment, and secondly, as a valuable dataset for the AI Engine. The AI Engine utilizes these interactions to learn about the relevance and utility of annotations in relation to the associated design elements. By analyzing patterns in which annotations receive positive engagement, the AI Engine can refine its understanding of what constitutes valuable and pertinent annotations within various contexts of the design plan.

Moreover, such embodiments may leverage additional innovative methods for the AI Engine to learn from annotations. For example, the system may analyze the frequency and context of annotations that consistently lead to design modifications, thereby identifying trends in important feedback that directly influence design outcomes. Another method involves the AI Engine examining the correlation between the spatial positioning of annotations and changes in design elements, enabling the system to predict areas within a design plan that may require more detailed scrutiny or are prone to revisions.

These unique learning mechanisms empower the AI Engine to not only facilitate a more dynamic and interactive annotation environment but also continuously improve the platform's capability to support effective design collaboration. By integrating these features, the invention fosters a rich, interactive, and intelligent design process, where annotations become a central component of learning, decision-making, and innovation in the collaborative development of design plans.

In some embodiments of the present invention, the system accommodates a variety of annotation formats, providing a versatile and robust platform for user interaction with design plans. Users can annotate design elements using text, comments, images, videos, or voice recordings captured via a microphone. This multimodal annotation capability enables users to convey their feedback or instructions in the most appropriate format for the context, enhancing the clarity and effectiveness of communication within the design process.

The AI Engine, integral to the system, utilizes its advanced algorithms to not only process and recognize these diverse forms of annotations but also to suggest improvements. For example, the AI Engine may propose more concise text annotations, recommend additional visual annotations for clarity, or suggest the inclusion of a video or voice annotation to provide a more comprehensive explanation of complex design aspects. The AI Engine learns from user interactions and preferences, continuously adapting its suggestions to optimize the effectiveness of annotations. Furthermore, some embodiments may allow the AI Engine to convert annotations from one format to another where beneficial. For example, a text annotation could be converted into a voice annotation for users who may prefer auditory instructions, or an image annotation could be converted to a video to provide a dynamic view of a design element. The AI Engine is also capable of semantic understanding, where it can contextualize voice annotations and convert spoken words into text annotations, complete with relevant tags and markers on the design plan.

By providing such a diverse range of annotation formats and the intelligent processing of these annotations, the present invention fosters a highly adaptable and user-friendly environment. It facilitates that all contributors can engage with the design plan in the manner that best suits their needs and expertise, while also allowing the AI Engine to learn from and adapt to the varied annotation styles, further enhancing the collaborative design process.

In one embodiment of the present invention, the system employs an AI engine that performs intelligent adjustments to annotations within a two-dimensional (or three-dimensional) design plan. As changes occur within the design, such as the repositioning of walls or the resizing of rooms, the AI engine responds by automatically updating the annotations linked to those elements, thus preserving the annotations' accuracy and relevance.

This embodiment also includes a feature that provides a comprehensive analysis of the implications of design changes. When a user modifies a design element, the AI engine assesses the impact of this modification on various project aspects, including but not limited to, the required materials, associated costs, and labor demands. It compiles this data into an easy-to-understand format, offering users a detailed overview of how the changes affect the overall project.

For example, if an architect decides to expand a room's dimensions, the AI engine updates the material list to reflect the increased quantity of flooring needed, adjust the cost estimation to account for this change, and analyze whether additional labor is required. By automating these calculations, the system streamlines the planning and estimation phases, significantly enhancing communication and collaboration among all stakeholders.

In specific embodiments of the invention, the method encompasses receiving a static representation of at least a portion of a building into a controller and analyzing this representation with an AI engine to identify various components within it, which are then represented as a pattern of pixels in a raster image. This is followed by generating an interactive user interface that includes multiple vertices, utilizing dynamic lines and polygons to depict these identified components as dynamic, interactive elements. The process advances to selecting a design element within this interface for annotation, allowing users to input annotations directly associated with selected design element. Subsequently, the AI engine determines the precise positional coordinates (x, y, z) of the selected design element, so that these coordinates are accurately associated with the corresponding annotations. This methodology facilitates that annotations are not only relevant and accurately placed within the digital representation but also perfectly aligned with the physical location of the design element within the building, thereby maintaining a coherent and synchronized digital-physical mapping of the architectural space.

In one embodiment of the present invention, the system features a sophisticated mechanism for tracking and reflecting real-world modifications within a building's physical structure directly onto its digital counterpart (design plans), effectively maintaining an up-to-date digital twin. Utilizing an array of sensors, IoT devices, and cameras strategically installed throughout the physical building, the system captures any changes or alterations made to the structure. These changes may include architectural modifications, interior design updates, or structural enhancements.

Once a change is detected, the AI Engine analyzes the collected data to understand the nature and scope of the modification. This analysis includes identifying the specific design elements affected, the extent of the changes, and any potential impacts on related components within the design plan. The AI Engine then automatically updates the digital design plan to accurately mirror these physical alterations, so that the digital twin remains a true reflection of the current state of the building.

Moreover, in-depth pixel-level analysis may involve considering spatial relationships between pixels within the static representation, facilitating a predefined distance between them, thus refining the precision of the analysis process.

In some embodiments, the two-dimensional reference input may be file extensions that include but are not limited to: DWG, DXF, PDF, TIFF, PNG, JPEG, GIF, or other types of files based upon a set of engineering drawings. Some two-dimensional reference references may already be in a pixel format, such as, by way of a non-limiting example, a two-dimensional reference in a JPEG, GIF or PNG file format. The engineering drawings may be hand drawings, or they may be computer-generated drawings, such as may be created as the output of CAD files associated with software programs such as AutoDesk™, Microstation™ etc. As some architects, design firms and others who generate engineering designs for buildings may be reluctant to share raw CAD files with others, the present invention provides a solution that does not require raw CAD files.

In other examples, such as for older structures, a drawing or other 2D representation may be stored in paper format or digital version or may not exist or may never have existed. The input may also be in any raster graphics image or vector image format.

The input process may occur with a user creating, scanning into, or accessing such a file containing a raster graphics image or a vector graphics image. The user may access the file on a desktop or standalone computing device or In some embodiments, via an application running on a smart device. In some embodiments, a user may operate a scanner or a smart device with a camera to create the file containing the image on the smart device.

In some embodiments, a system utilizes pixel patterns and polygon patterns in sizing analysis of the selected segments or design elements of design plans. The system incorporates a user-adjustable and/or AI-adjustable feature for sizing variations, utilizing percentage variation in pixel positions relative to other pixel positions within a defined window of the segment selection. It may involve convolutional filters for zero-shot and one-shot approaches, leveraging generative models and template matching. Another embodiment may incorporate relative positioning of pixels, employing mathematical representations, algorithms, and vector-based approaches for analyzing distances, angles, and clustering vectors into symbols. The system aims for optimization based on speed, quality, cost-effectiveness, durability, aesthetics, financial criteria, supply chain, labor costs, subcontractor selection, scope of work, location, equipment, spatial relevance, clearance, covering area, flooring, ceiling, paths, plumbing, gas/chemical lines, cables, electrical wiring, and rule-based criteria. Users can select measurements such as length, area, volume, atmospheric volume, and relative height, further refining the system's analysis. This versatile approach prioritizes user-defined preferences and customizable variables to streamline decision-making and planning.

A primary advantage of AI analysis in this scenario is its capacity to analyze complex pixel patterns, vectors, and polygons using knowledge derived from previous experiences. This knowledge is not confined to the work of a single individual but can be harnessed from a select group of experts or shared learnings from similar past projects. This means that the AI system has access to a vast pool of information and insights, enabling it to make informed and effective decisions. Furthermore, the speed at which AI analysis can derive new and improved work based on the current design plan is a remarkable asset. The capabilities of the AI Engine in generating and managing annotations far exceed human processing abilities, positioning it as an invaluable asset for innovating and enhancing design plans. Through its advanced computational power, the AI Engine can swiftly analyze complex design elements, identifying opportunities for optimization and suggesting refinements that may not be immediately apparent to human users. This functionality extends to the automated generation of annotations, where the AI Engine documents each suggested alteration, providing a detailed rationale and potential impact analysis for the change.

According to the present invention, analysis of pixel patterns and enhanced vector diagrams and/or polygon based diagrams may include one or more of: neural network analysis, opposing (or adversarial) neural networks analysis, machine learning, deep learning, artificial-intelligence techniques (including strong AI and weak AI), forward propagation, reverse propagation and other method steps that mimic capabilities normally associated with the human mind-including learning from examples and experience, recognizing patterns and/or objects, understanding and responding to patterns in positions relative to other patterns, making decisions, solving problems. The analysis also combines these and other capabilities to perform functions the skilled labor force traditionally performed.

### BRIEF DESCRIPTION OF THE DRAWINGS

The accompanying drawings, which are incorporated into and constitute a part of this specification, illustrate several embodiments of the present invention. Together with the description, these drawings serve to illustrate some aspects of the present invention.

FIG. 1 illustrates a schematic diagram of apparatus that may implement the processes and methods of the present invention.

FIG. 1A illustrates method steps that may be implemented in some embodiments of the present invention.

FIG. 1B illustrates a high-level diagram of components included in a system that uses AI to generate an interactive user interface.

FIG. 1C illustrates an exemplary method for annotating a design element on the design plan in the collaborative environment of the present invention.

FIG. 1D illustrates an exemplary interface for providing automated annotation suggestions to users during annotation process.

FIG. 1E illustrates an exemplary settings window with various setting options as per some embodiments of the present invention.

FIG. 1F illustrates an exemplary method for relocating a design element from one position to another on a design plan in some embodiments of the present invention.

FIG. 1G illustrates an exemplary system for generating and modifying a design plan in accordance with the present invention.

FIG. 1H illustrates an exemplary design plan generation and modification process in accordance with the present invention.

FIG. 1I illustrates an exemplary design plan generation and modification system receiving user inputs in some implementations of the present invention.

FIG. 1J illustrates an exemplary system interacting with a user for understanding the context of design plan generation and modification processes in accordance with the present invention.

FIGS. 2A, 2B, 2C and 2D illustrate a static representation of a floor plan and an AI analysis of the same to assess boundaries and design elements.

FIG. 2E illustrates another exemplary design plan generation and modification process in accordance with the present invention.

FIGS. 2F-2G illustrate exemplary context determination method by the controller before finally generating or modifying a design plan in accordance with the present invention.

FIGS. 3A-3D show various views of the AI-analyzed boundaries and design elements overlaid on the original floorplan including a table illustrated to contain hierarchical dominance relationships between area types.

FIGS. 4A-4B illustrate various aspects of dominance-based area allocation.

FIGS. 5A-5D illustrate various aspects of region identification and area allocation.

FIGS. 6A-6C illustrate various aspects of boundary segmentation and classification.

FIG. 7 illustrates aspects of correction protocols and an exemplary method for making changes to a design element of the design plan.

FIG. 8 illustrates exemplary processor architecture for use with the present invention.

FIG. 9 illustrates exemplary mobile device architecture for use with the present invention.

FIGS. 10A-10B illustrate additional method steps that may be executed in some embodiments of the present invention.

FIG. 11 illustrates additional method steps that may be executed in some embodiments of the present invention.

FIG. 12 illustrates a conceptual framework showing multiple layers involved in the AI-powered collaborative system for spatial annotations, creation, and modification of a design plan in accordance with the present invention.

FIG. 13 illustrates an exemplary AI-powered collaborative system in accordance with the present invention.

FIG. 14 illustrates an exemplary automatically generated design plan detailing HVAC system in accordance with the present invention.

FIGS. 15A-15B illustrate exemplary interactive user interfaces including selection of a space in a design plan for further determining if the space may need redesigning.

FIGS. 15C-15D illustrate exemplary redesigning methods of selected areas or features in a design plan.

FIG. 16 illustrates an exemplary user interface of an AI-powered collaborative platform for spatial annotations related to design generation and modification.

FIG. 17 illustrates exemplary method steps that may be practiced in some embodiments of the present invention.

FIGS. 17A-17B illustrate exemplary structural design plans that the controller may generate in accordance with the present invention.

FIGS. 18, 19, 20, 21, and 21A illustrate exemplary method steps that may be executed in some embodiments of the present invention.

### DETAILED DESCRIPTION

The present invention provides systems, methods, and apparatus for modifying a design plan of a building using a combination of an AI engine and a GAN engine, capable of processing and refining architectural elements. The process begins by receiving a design plan, which may encompass various architectural elements such as rooms, walls, doors, windows, and airflow paths. These elements are identified and analyzed by a controller, so that the design plan is accurately broken down into its core components, such as spatial configurations and structural components. The controller interacts with the design plan, creating dynamic components that can be adjusted, such as resizing rooms or rearranging doors and windows, making the interface highly adaptable for modifications.

User inputs can be provided through multiple methods, including text commands, verbal commands, or sketches drawn on the interactive user interface. For example, a user may sketch out a rough placement of rooms or verbally instruct the system to move a window or resize a living space. The controller, through its AI engine, determines the context of these modifications, taking into account predefined design considerations such as structural integrity, preferred building practices, building deployment objectives, or environmental conditions. For example, if a user attempts to reduce the size of a load-bearing wall, the controller analyzes the structural impact and may suggest alternative configurations to maintain the building's safety.

Once the user input is analyzed, the GAN engine generates an updated design plan, incorporating the context of the user's modification. The GAN engine can assist by offering design alternatives, adapting to different styles or facilitating compliance with design considerations. For example, if the building is located in a seismically active region, the AI engine may suggest structural reinforcements to enhance safety. Similarly, for areas following cultural principles, the system may generate designs that align with these spatial guidelines, providing cultural appropriateness in addition to structural integrity.

The present invention provides systems, methods, and apparatus leveraging artificial intelligence and generative adversarial network (GAN) to generate a user interactive interface with elements included in a design plan and spatial designations for the generated elements. More specifically, the present invention introduces an automated platform that enables a user to input preferred characteristics of a design plan into an Artificial Intelligence (“AI”) engine and have the automated system provide an interactive user interface including elements of a design plan and spatial designations of the design elements. The interactive user interface permits a user to collaboratively annotate, modify, and interact with design elements represented as polygons, lines, and objects in architectural and engineering floor plans.

In addition, the method allows for the generation of context-related questions. For example, if a user modifies the placement of a kitchen or bathroom, the controller may ask questions to clarify preferences regarding ventilation, plumbing, or natural lighting. The user's responses to these questions allow the controller to further refine the design plan, offering suggestions or adjustments based on both the user's preferences and the established design considerations. This interactive process facilitates that the final design plan not only reflects user preferences but also adheres to safety, compliance, and aesthetic considerations.

Moreover, the controller can also identify potential conflicts or inconsistencies within the design plan based on the predefined design considerations. If detected, it presents warnings or modification suggestions, enabling the user to make informed decisions. For example, if a proposed room layout results in poor airflow or violates design considerations, the system will alert the user, providing alternative designs or options. This iterative process of analyzing, questioning, and refining the design plan facilitates that the final or updated design plan is optimized for both functionality and aesthetics, while aligning with design considerations and client-specific requirements.

In some embodiments, the method involves automatically generating a design plan of a building based on user inputs through a highly interactive process that combines both AI and GAN technologies. Initially, the controller receives various forms of user inputs, whether it is written text, verbal commands, or hand-drawn sketches, through an interactive user interface. These inputs can relate to any aspect of the design plan, such as room layouts, furniture placement, or structural elements like windows and doors. The controller then analyzes the inputs to create an initial design plan that reflects the user's vision for the building.

The next step involves referencing a database of design considerations, which may include a range of guidelines such as preferred building practices, structural integrity standards, or even aesthetic practices like cultural or Feng Shui principles. If the initial design plan does not comply with these design considerations, the controller identifies one or more conflicts and presents them on the interactive user interface. For example, if the user's proposed room layout violates a preferred building practice or disrupts airflow patterns, the system highlights these issues. The user is then given the opportunity to resolve the conflicts by providing additional inputs or adjusting the design.

To further refine the design, the controller may ask context-related questions based on the user's modifications. For example, if a user specifies a window placement, the system may ask about the desired amount of natural light or privacy concerns to better understand the user's intentions. The controller then assesses how the user's responses impact the overall design, balancing these preferences with the predefined design considerations. If the user inputs compromise functionality or aesthetic appeal, the system may generate an alternate design plan that maintains compliance while adjusting certain elements to meet the user's needs.

In some cases, the user may override certain design considerations. For example, if the user insists on a specific room layout that conflicts with Feng Shui guidelines, the system can generate a design that respects the user's preference while still maintaining structural integrity. The system can also provide alternative suggestions that incorporate cost-saving measures, helping the user make informed decisions about budgetary constraints while maintaining the desired design quality.

Throughout the process, the controller is able to analyze the user's inputs not only in terms of spatial configuration and structural integrity but also in relation to the potential costs associated with the design. For example, if the user's inputs increase construction costs, the system can provide real-time cost estimates and offer suggestions for reducing expenses. This could involve modifying material choices, adjusting room sizes, or suggesting alternative architectural features that are more cost-effective while still aligning with the user's vision and the relevant design considerations.

In a final step, the system generates an updated design plan that incorporates the user inputs, design considerations, and any required compromises. The process is highly adaptive and flexible, allowing for a seamless blend of user preferences and compliance with relevant standards, making it ideal for both professional architects and users with little to no design expertise.

In some embodiments, the apparatus for generating a design plan of a building based on user inputs allows a user to interact with the design plan through a display screen presenting an intuitive interactive user interface. The apparatus comprises a controller equipped with an AI engine and a GAN engine, operating in conjunction to provide real-time responses to user inputs, whether those inputs are written text, verbal commands, or sketches drawn on the interface. Once user inputs are received, the controller analyzes the inputs to generate an initial design plan, which could encompass a wide range of architectural elements such as room layouts, furniture placement, structural components, and more.

The system references a database of design considerations to facilitate that the generated design plan adheres to relevant standards, regulations, and best practices. If any conflicts or discrepancies arise between the user inputs and the design considerations, the apparatus immediately flags those design conflicts on the user interface. For example, a user requesting a specific room arrangement that violates spatial or preferred building practice guidelines will be notified through visual indicators or pop-ups. The user can then modify their inputs or provide further instructions, which will be processed to resolve the conflicts and facilitate that the design plan is both compliant and meets the user's preferences.

In a further embodiment, the apparatus offers a context-sensitive method of modifying a design plan, where the controller evaluates the overall impact of user inputs on the spatial configurations, architectural features, and structural integrity of the building. This context determination involves analyzing how user commands may affect building performance, aesthetics, and compliance with standards. For example, a user modifying a window placement may trigger the system to analyze how that change impacts natural lighting or airflow within the building, and the controller provides real-time feedback to guide the user.

Moreover, if the user input affects important design considerations, such as structural components or airflow paths, the system is capable of generating real-time alternative suggestions. For example, if a user-request to modify the layout of a room would disrupt the airflow path or reduce structural integrity, the controller could recommend adjusting the size of the room or relocating structural supports. These alternative suggestions are intelligently generated based on the AI engine's analysis of the design plan and design considerations, offering practical and compliant solutions.

In yet another embodiment, the apparatus allows for collaborative interaction between multiple users, enabling a team of architects, designers, or project managers to work on the same design plan. Each user can provide annotations, feedback, or approve changes to specific design elements. The controller analyzes the combined inputs and generates an updated design plan that incorporates these collaborative modifications. For example, if one user proposes relocating a wall and another user suggests adjusting the lighting in that room, the system will harmonize both inputs into a coherent, unified design plan.

Additionally, the apparatus allows users to accept or reject alternative suggestions made by the system. When the controller proposes adjustments, such as altering an airflow path, adding a structural support, or changing the dimensions of a space, these recommendations can be reviewed and accepted by the user before being incorporated into the final design. This interactive process facilitates that the design plan not only meets technical requirements but also aligns with the user's preferences and vision for the building.

In some cases, the apparatus may even include recommendations such as placing specific furniture, adjusting the size of certain rooms, or adding new design elements like fixtures or appliances. These suggestions are generated based on the controller's analysis of the design plan and contextual factors such as room function, aesthetic preferences, and practical considerations, ultimately enhancing the user's overall experience with the system.

Thus, this embodiment provides a comprehensive, collaborative, and flexible design tool that leverages AI and GAN technology to streamline the design process, facilitating both creativity and adherence to important standards.

In some embodiments, the present invention provides systems, methods and apparatus for an interactive platform that significantly enhances collaborative processes associated with a dynamic user interface based upon a static design plan reference. Within this interactive platform, users can seamlessly select a spatial designation, (such as, for example, a spatial designation associated with a design element) for annotation within an interactive user interface based upon a static design plan document descriptive of at least a portion of a building or construction site.

An AI engine leverages one or more of machine learning, user input, reference documents, applicable standards, applicable codes, external references, databases, digital content accessible via a communications platform (e.g. the Internet), historical data, and current context to suggest automated annotations, optimizing an annotation process by providing users with intelligent, contextually relevant suggestions that align with a project's specifications and goals.

Coordinates may be associated with corresponding annotations, facilitating that a piece of information is accurately linked to a physical counterpart in a relevant building. This integration of detailed spatial awareness with the platform's annotation capabilities facilitates a dynamic, real-time connection between the digital design plan and the actual physical structure, enhancing the accuracy, efficiency, and effectiveness of the collaborative design and construction process.

In some embodiments of the present invention, the platform incorporates social interaction features that enable users to engage with the annotations made by other users through mechanisms such as commenting, liking, disliking, insertion of a symbol (e.g., emoji, signature, authorization, or other recognizable digital representation).

The present invention provides interaction enabling a dialogue between users, and/or an AI Engine, about design elements and annotations. In another aspect, it also contributes to a feedback system where the AI engine can observe and learn from user interactions. As users comment on or react to annotations, the AI engine may analyze responses, utilizing them for machine learning to refine a quality and relevance of future automated annotation suggestions. Moreover, the systems according to the present invention may also allow for an approval workflow, wherein annotations can be approved or disapproved by authorized users or automatically by the AI engine depending upon positive or negative reactions to the annotations.

Machine monitoring of spatially relevant annotations facilitates machine and user input capability that becomes more accurate over time and adheres to a collective knowledge and preferences of a team, thereby enhancing collaborative processes.

In some embodiments, the invention enables remote collaboration between multiple users, allowing each user to interact with the design plan and contribute through annotations. These annotations may include textual comments, graphical symbols, multimedia files, or detailed notes relating to specific design elements, such as rooms, windows, doors, or structural components. For example, one user may provide feedback on the layout of a room by attaching a multimedia file or adding a graphical symbol to highlight required changes, while another user may leave a textual note suggesting modifications to window placements for better natural lighting.

The system's controller may receive these annotations and automatically evaluate their impact on the overall design plan. Before incorporating any changes, the controller may consider factors such as spatial configurations, compliance with design considerations, and any user-defined design preferences. Once the evaluation is complete, the controller can generate an updated design plan that integrates the annotations from multiple users, providing a streamlined, collaborative process where input from all stakeholders is considered and effectively incorporated into the final design.

In some embodiments of the present invention, an AI engine may leverage sophisticated analysis of annotations associated with a design plan to intelligently determine an order of actions associated with a particular design plan, such as, by way of non-limiting example, an order of installation, service, modification, or other action included in a construction or renovation process associated with a design plan. By evaluating factors such as availability of resources, supply chain, urgency, best practices requirements, project timelines, and skilled labor availability, an AI engine may be used to prioritize tasks in a manner that optimizes workflow efficiency and facilitates that important project milestones are met.

By way of non-limiting illustrative example, if an annotation on a structural aspect (e.g., a support beam) indicates an issue with a safety standard (or other best practice), the AI engine assigns a higher severity level to a task directed to ascertaining whether, prioritizing it over less important modifications. Similarly, if an electrical installation is annotated as a prerequisite for subsequent tasks within the project, the AI engine schedules this installation early in the action order. Dynamic prioritization may enable project progression in a logical and efficient manner, minimizing delays and optimizing resource allocation.

Embodiments of the present invention provide significant advancements in project definition and project management technology, as it not only automates task scheduling processes, but also adapts in real-time to changes associated with a design plan and spatially relevant annotations. By doing so, it supports a more agile and responsive project execution strategy, directly contributing to the success and quality of architectural, engineering, and construction projects.

In some embodiments of the invention, systems focus on enhancing an annotation process by providing automated suggestions. An AI engine analyzes an annotation database comprising historical textual and multimedia annotations. By recognizing patterns and contexts in which annotations were previously used, the system suggests relevant annotations to users as they interact with specific design elements in the digital design plan. Such predictive assistance may streamline an annotation process, promote consistency across projects, and help users to quickly identify and apply best practices and solutions previously successful in similar scenarios.

In a further embodiments of the invention, a sophisticated dynamic cost estimation functionality is embedded within the system, enabling the real-time assessment of the financial implications stemming from alterations made to the digital design plan. When users initiate changes to design elements or make new annotations, the AI engine evaluates these modifications. It does this by calculating the expected changes in material requirements, updating labor needs based on the scope and scale of the adjustments, and revising cost estimations to reflect these new calculations accurately.

This embodiment is particularly innovative in how it leverages connectivity with third-party vendor platforms. Through seamless integration, the platform facilitates immediate access to a wide range of quotes for required materials, enables the efficient hiring of labor tailored to the project's revised needs, and even supports the direct procurement of services and goods. Users benefit from a streamlined interface where design modifications, cost implications, and procurement actions converge in a cohesive workflow.

In some embodiments of the invention, a focus may be placed upon enforcement of best practices, standards, and enumerated requirements within one or more of: design planning activities; design review; construction activities; cost estimation; supply chain activities; contractor (and/or subcontractor) engagements, by leveraging the sophisticated capabilities of the AI engine. An AI system may receive as input one or more annotations and design elements represented as polygons and/or lines, presented within an interactive user interface. In some embodiments, a data source of relevant input or criteria relevant to architecture, engineering, and construction standards may be made available to one or both of a user and an AI Engine to provide input relevant to a spatial designation of a design plan. Input of relevant annotation content and data source content enables an AI Engine to provide notification of one or more of: identification of discrepancies, potential action adverse to a preferred practice, or area of non-compliance with a preferred practice or standard that may exist within a design plan.

In some embodiments, an AI engine may actively engage users by flagging AI noted concerns directly within the user interface. Further, in some embodiments, an automated process may highlight specific elements and/or features included in a design plan and describe a potential concern. For example, actionable modifications or alternative solutions that may place a design into a more desired state may be included in AI and/or user generated spatially relevant annotations. Users may receive tailored alerts and guidance, effectively offering a consultative approach to rectify compliance issues.

In some embodiments, an AI assisted system may preemptively address potential issues of adherence with a desired practice, or design relevant document, and/or other criteria, thereby significantly reducing the likelihood of encountering costly modifications during or after the construction phase.

Moreover, some embodiments may serve to streamline interactions with review bodies and approval processes. By providing a platform that inherently aligns with regulatory expectations, the system facilitates a smoother, more efficient pathway from project conception to completion. The preemptive adherence to a preferred design criteria may accelerate an acceptance process, minimizing delays and fostering a more productive relationship between project stakeholders and/or other parties of interest.

In some other embodiments of the present invention, an AI engine is equipped to simulate “What If” scenarios, providing a dynamic tool for planning and decision-making within the architectural and construction domains. This feature enables users to explore various hypothetical modifications to the design plan, design elements, and annotations and assess their potential impacts without committing to actual changes. By inputting different “What If” conditions, such as altering the materials of a design element, repositioning structural components, or changing the dimensions of space, the AI engine projects the consequent effects on the design's overall integrity, cost implications, compliance with best practices, and even the projected timeline for completion.

For example, a user considering the replacement of a building material with a more sustainable alternative can engage the “What If” simulation to understand how this choice may affect insulation properties, overall building sustainability ratings, and cost. The AI engine analyzes the proposed change, leveraging historical data, current standards, and predictive algorithms to furnish detailed insights, including potential energy savings, adjustments in material costs, and any required alterations to construction techniques.

In some embodiments of the present invention, the collaborative platform integrates a comprehensive question-and-answer feature operative to facilitate communication among the various parties involved in a construction project. This feature allows users to pose questions directly within the interface, specifically targeting aspects of the design plan or related to specific annotations. Utilizing natural language processing and a deep understanding of the project's context, the AI engine sifts through the database of annotations, design elements, and associated documentation to provide accurate, automated answers.

For example, a subcontractor on-site may query the system about the specifications of a particular material annotated within the design plan. The AI engine processes this inquiry, referencing the annotation database and any related documents or comments to furnish a detailed response, including material properties, recommended installation practices, and potential suppliers. This instant access to information accelerates decision-making and problem-solving on the construction site.

Additionally, in some embodiments, a platform may catalog interactions, creating a searchable knowledge base that grows increasingly relevant over time. As questions are asked and answered, an associated AI engine may refine its ability to understand and respond to inquiries, improving the accuracy and relevance of its automated responses.

In the following sections, detailed descriptions of examples and methods will be given. The description of both preferred and alternative examples, though thorough, are exemplary only. It is understood by those skilled in the art, that various modifications and alterations may be apparent and within the scope of the present invention. Unless otherwise indicated by the language of the claims, the examples do not limit the broadness of the aspects of the underlying invention as defined by the claims.

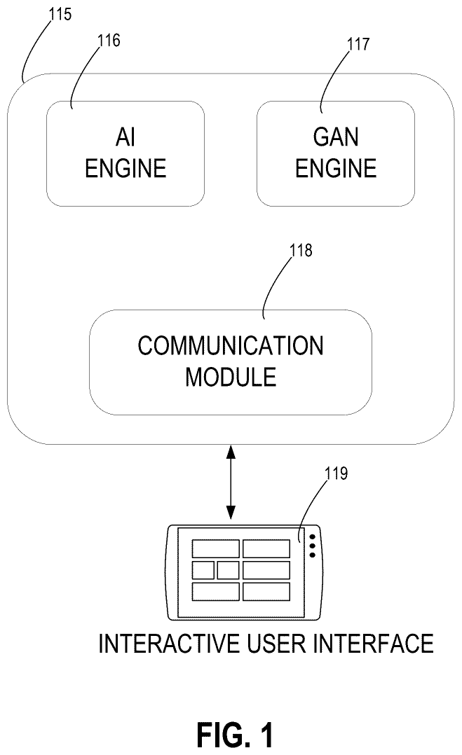

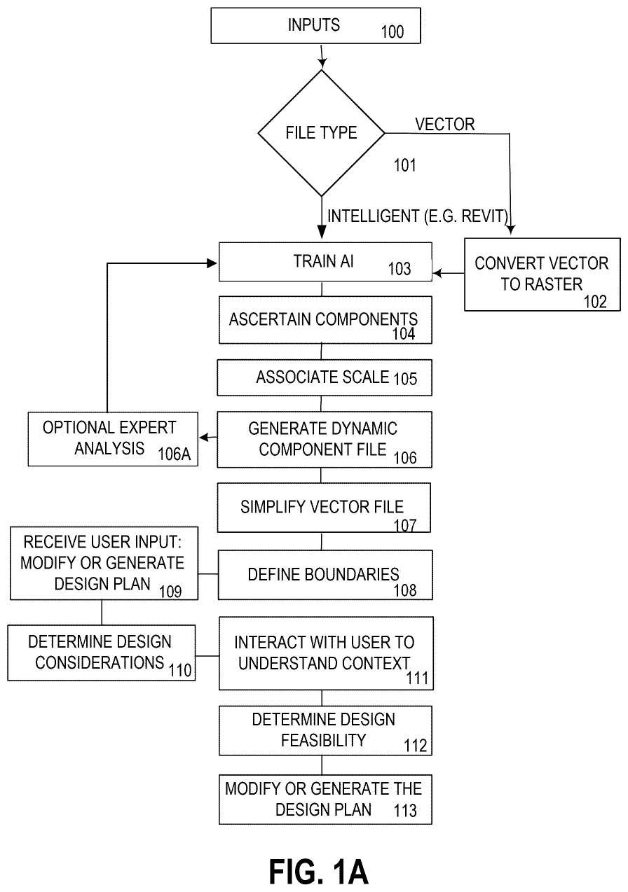

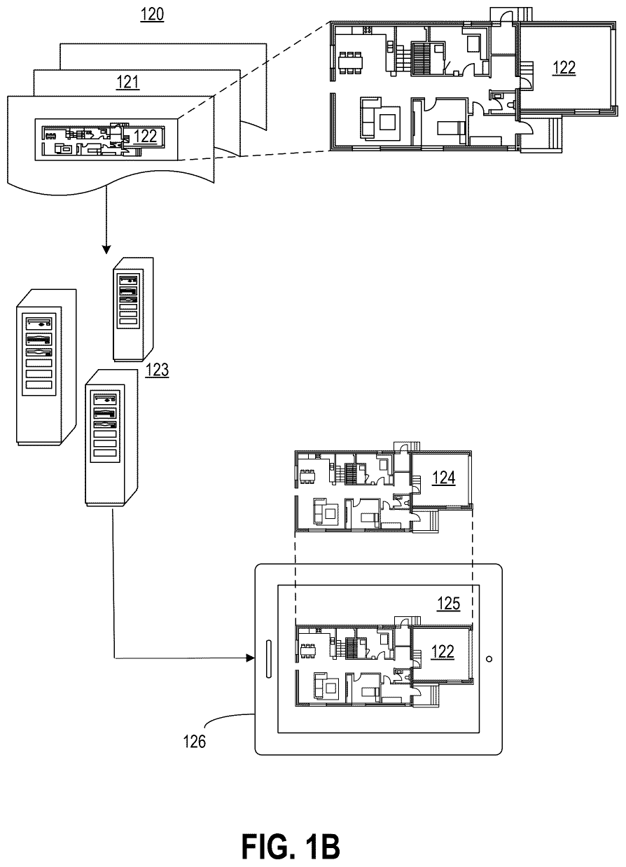

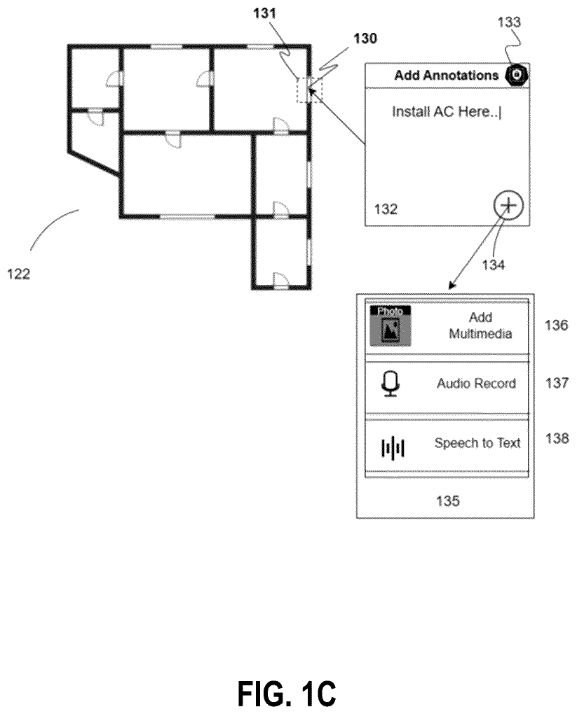

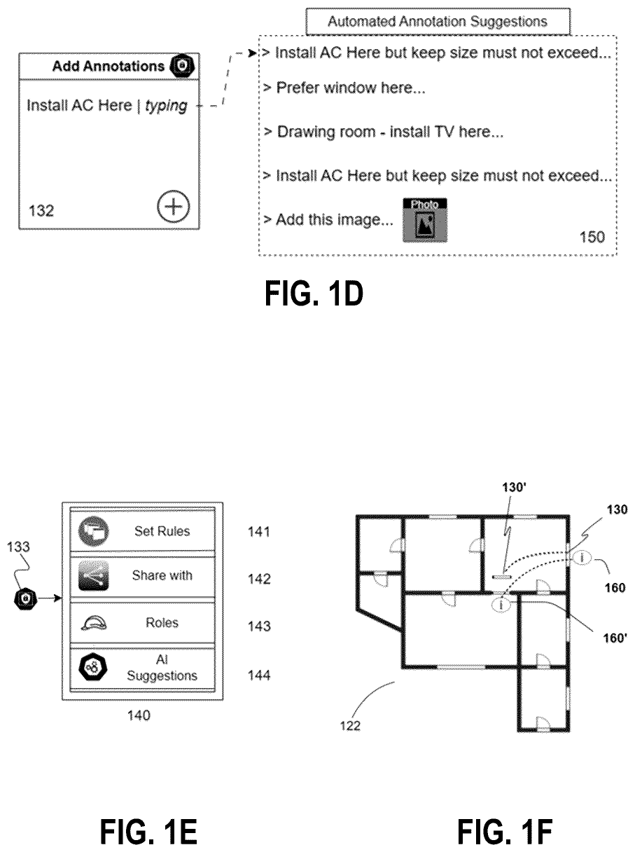

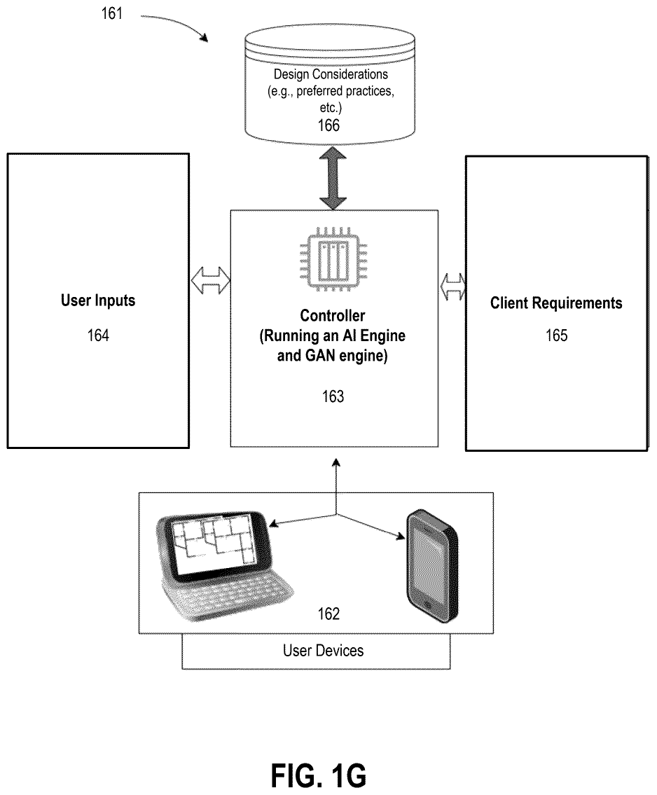

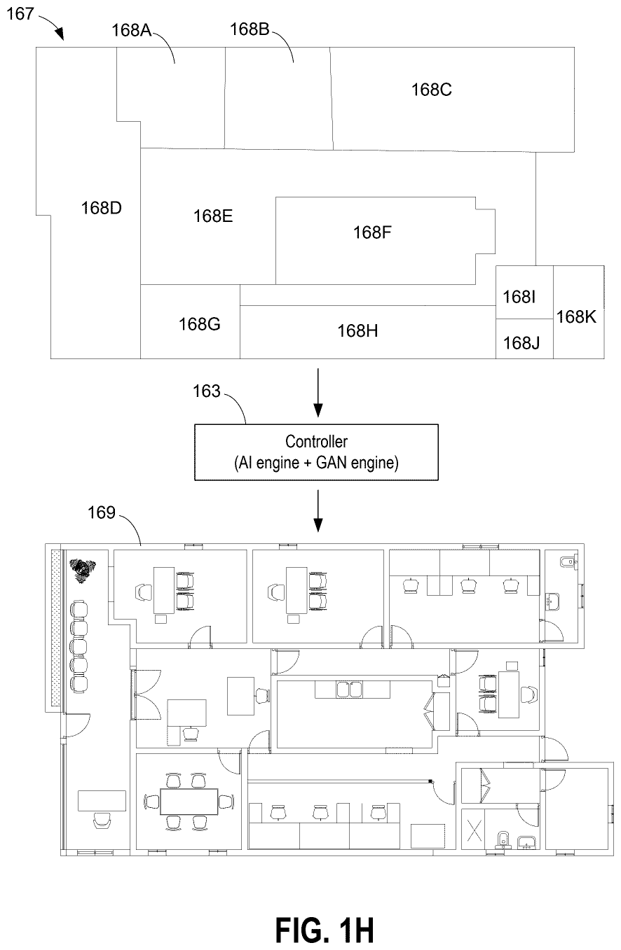

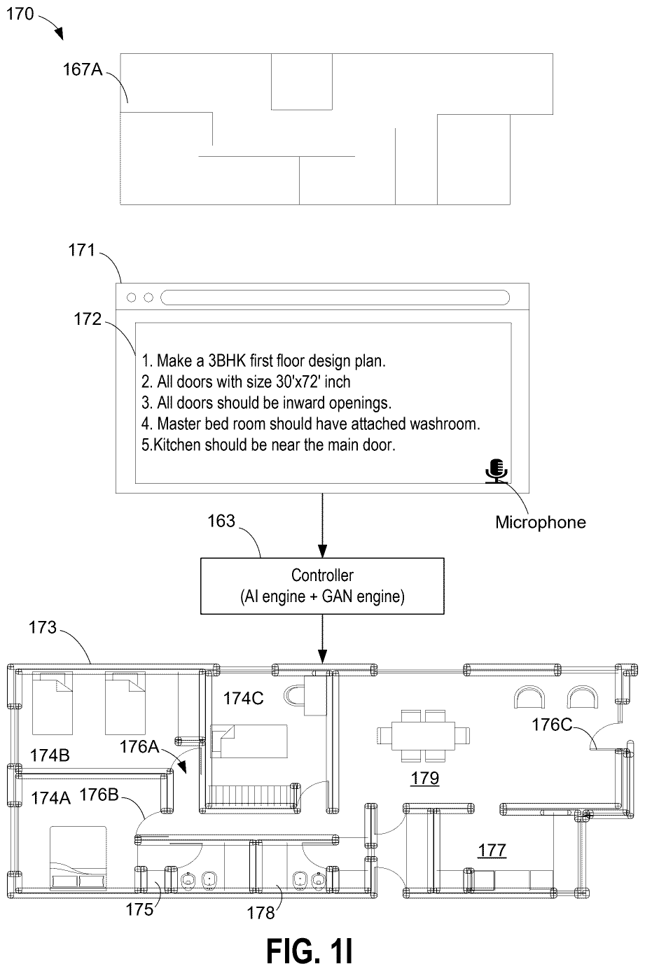

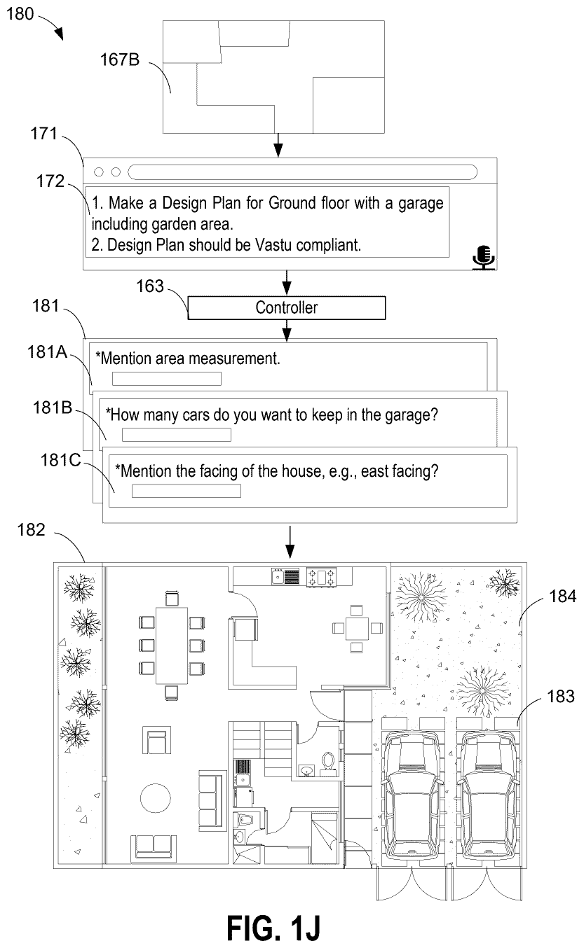

Referring now to FIG. 1, a schematic diagram illustrates components of apparatus that may be used to implement the methods and processes of the present invention. Automated apparatus 115, which may include a controller with a processor and executable software executable upon command by a user and/or automated agent is illustrated. The automated apparatus may include one or both of: an AI Engine 116, and a GAN engine 117. The AI Engine 116, and a GAN engine 117, may be linked to an interactive user device 119 via a communication module 118. The communication module may include hardware and/or software that is operative to present output from the AI Engine 116, and a GAN engine 117 and input into the AI Engine 116, and a GAN engine 117. The interactive user device 119 may include one or more of: an interactive screen, a keyboard, a pointing device, a touchscreen, or other apparatus capable of receiving instructions or presenting output to a human user of automated agent.

According to some embodiments of the present invention, a controller is capable of receiving input in the context of project to generate automated design plans. The context of a project, such as the site location, environmental factors, and user preferences, may be weighted to play a more or less significant role in the generation of design output by the controller. For example, a design output for a beachfront property may differ significantly from one located in a dense urban environment, based upon differences in ambient weather variables, zoning regulations, and available space. Other considerations, such as a design intended for a family with young children may prioritize certain factors, such as safety and accessibility in ways that may not be relevant to a design for a single individual or a commercial enterprise. A controller with AI and GAN engines is capable of incorporating such contextual factors into a generation process, allowing for greater customization and accuracy in output design plans.

In another aspect, in some embodiments, a controller system for automated design plan generation may output revisions and updates based on changing requirements, as those changing requirements are made know to the controller. Updates may be made on a periodic basis, upon user command, and/or in real time. In some projects, an initial design plan may undergo multiple revisions as a user's needs evolve or new variable values are made available to the controller. For example, a user may initially request a simple, single-story layout, only to later decide that they want to add a second floor. Automated systems automated systems according to the present invention are able to accommodate changes without requiring a complete redesign. Controllers deploy sophisticated algorithms that can adjust an existing design while maintaining the integrity of an overall layout, functionality, and aesthetic.

In addition to handling revisions, automated controllers are capable of considering various factors that influence a success of a design. Factors may include, one or more of: placement of design elements, a flow of movement within a space, and integration of mechanical systems such as plumbing, HVAC, and electrical wiring. For example, moving a room to a different part of the layout may affect the placement of plumbing fixtures, requiring adjustments to the overall design. The controller systems of the present invention account for such dependencies, making intelligent adjustments in a fraction of the time that a human would need to consider each variable in play and still preserve the functionality and efficiency of the design.

In another aspect, a controller system according to the present invention provides for automated design plan generation with balanced aesthetic preferences and practical constraints. For example, users may prioritize one or more aspects of a design plan to be generated such as, by way of non-limiting example, one or more of: a visual appeal of a design, practical considerations such as space utilization, structural integrity, energy efficiency, aesthetic appeal, or other variable important to a user in a given set of circumstances. A user may request a particular aspect, such as, for example, a large, open living space with floor-to-ceiling windows, and an AI Agent or other interface or user communication may inform the user that the request may result in increased energy costs or reduced privacy. Automated systems must be able to offer alternative design solutions that balance these competing priorities, allowing users to achieve their aesthetic goals without compromising functionality.

A controller with one or more AI Engines and GAN may accommodate unique user preferences and/or situational requirements. Traditional design methods are often limited in their ability to quickly respond to changes or provide multiple design options, particularly when working within tight timeframes or budgets. Automated controllers and systems according to the present invention provide a wide range of design possibilities to the users, allowing users to experiment with different layouts, configurations, and styles without requiring extensive manual input. This flexibility is particularly valuable in industries such as real estate development, where rapid iteration and customization are often required to meet client expectations.

In addition to providing flexibility, automated design systems provide improved collaboration between stakeholders. In traditional design processes, revisions and updates often require multiple rounds of feedback and approval, with each party involved in the project providing input at different stages. Automated systems streamline such processes by allowing for real-time collaboration, where multiple users can interact with the design simultaneously, making adjustments and providing feedback in real time. This reduces the need for back-and-forth communication and accelerates the overall design process, leading to faster approvals and more efficient project management.

Referring to FIG. 1A, a general flow diagram showing some preferred embodiments of the present invention as illustrated. At step 100, a design plan (which may be a design plan or dynamic architectural design file e.g., a Revit® compatible file) indicating aspects of a building; is input into a controller or other data processing system using a computing device. The design plan may include an item of a known size, such as, by way of a non-limiting example, a scale bar that allows a user to ascertain a scale of the drawing (e.g., 1″=100′ etc.) or an architectural aspect of a known dimension, such as a wall or doorway of a known length (e.g., a doorway known to be three feet wide).

Input of a two-dimensional reference (i.e., design plan) into the controller may occur, for example, via known ways of rendering an image as a vector diagram, such as via a scan of paper-based initial drawings; upload of a vector image file (e.g., encapsulated postscript file (epf file); adobe illustrator file (ai file); or portable document file (pdf file). In other examples, a starting point for estimation may be drawing file in an electronic file containing a model output for an architectural floor plan. In still further examples, other types of images stored in electronic files such as those generated by cameras may be used as inputs for automated processes.

In some embodiments, the design plan may be file extensions that include but are not limited to: DWG, DXF, PDF, TIFF, PNG, JPEG, GIF, or other types of files based upon a set of engineering drawings. Some design plans may already be in a pixel format, such as, by way of a non-limiting example, a two-dimensional reference in a JPEG, GIF or PNG file format. The engineering drawings may be hand drawings, or they may be computer-generated drawings, such as may be created as the output of CAD files associated with software programs such as AutoDesk™, Microstation™ etc. In other examples, such as for older structures, a drawing or other design plan may be stored in paper format or digital version or may not exist or may never have existed. The input may also be in any raster graphics image or vector image format.

The input process may occur with a user creating, scanning into, or accessing such a file containing a raster graphics image or a vector graphics image. The user may access the file on a desktop or standalone computing device or, in some embodiments, via an application running on a smart device. In some embodiments, a user may operate a scanner or a smart device with a charged coupled device to create the file containing the image on the smart device.

In some embodiments, a degree of the processing as described herein may be performed on a controller, which may include a cloud server, a standalone computing device or a smart device. In many examples, the input file may be communicated by the smart device to a controller embodied in a remote server. In some embodiments, the remote server, which is preferably a cloud server, may have significant computing resources that may be applied to AI algorithmic calculations analyzing the image.

In some embodiments, dedicated integrated circuits tailored for deep learning AI calculations (AI Chips) may be utilized within a controller or in concert with a controller. Dedicated AI chips may be located on a controller, such as a server that supports a cloud service or a local setting directly.

In some embodiments, an AI chip tailored to a particular artificial intelligence calculation may be configured into a case that may be connected to a smart device in a wired or wireless manner and may perform a deep learning AI calculation. Such AI chips may be configurable to match a number of hidden levels to be connected, the manner of connection, and physical parameters that correspond to the weighting factors of the connection in the AI engine (sometimes referred to herein as an AI model). In other examples, software-only embodiments of the AI engine may be run on one or more of: local computers, cloud servers, or on smart device processing environments.

At step 101, a controller may determine if a design plan received into the controller includes a vector diagram. If a file type of the received design plan, such as an input architectural floor plan technical drawing, includes at least a portion that is not already in raster graphics image format (for example, that it is in vector format), then the input architectural floor plan technical drawing may be transformed to a pixel or raster graphics image format in step 102. Vector-to-image transforming software may be executed by the controller, or via a specialized processor and associated software.

In some embodiments, the controller may determine the pixel count of a resulting rasterized file. The rasterized file will be rendered suitable for the controller hosting an artificial intelligence engine (“AI engine”) to process, the AI engine may function best with a particular image size or range of image size and may include steps to scale input images to a pixel count range in order to achieve a desired result. Pixel counts may also be assigned to a file to establish the scale of a drawing—for example, 100 pixels equals 10 feet. As an illustrative example, images can be resized to dimensions such as 1024×1024, 512×512, or other dimensions that may be appropriate for the AI engine to function in a better way.

In various examples, the controller may be operative to scale up small images with interleaved average values with superimposed Gaussian noise as an example, or the controller may be operative to scale down large images with pixel removal. A desired result may be detectable by one or both the controller and a user. For example, a desired result may be a most efficient analysis, a highest quality analysis, a fastest analysis, a version suitable for transmission over an available bandwidth for processing, or other metric.

At step 103, training (and/or retraining) of the AI engine is performed. Training may include, for example, manual identification of patterns in a rasterized version of an image included in a design plan that correspond with architectural aspects, walls, fixtures, piping, duct work, wiring or other features that may be present in the two-dimensional reference. The training may also include one or more of: identification of relative positions and/or frequencies and sizes of identified patterns in a rasterized version of the image included in the design plan.

In some embodiments, and in a non-limiting sense, an AI engine used to analyze the design plan may be based on a deep learning artificial neural network framework. The AI engine image processing may extract different aspects of an image included in the design plan that is under analysis. At a high level, the processing may perform segmentation to define boundaries between important features. In engineering drawings defined boundaries may be based on the presence of architectural features, such as walls, doorways, windows, stairs, and the like.

In some embodiments, a structure of the artificial neural network may include multiple layers, such as input layers and hidden layers with interconnections with weighting factors. For learning optimization, the input architectural floor plan technical drawings may be used for artificial intelligence (AI) training to enhance the AI's ability to detect what is inside a boundary. A boundary is an area on a digital image that is defined by a user and tells the software what needs to be analyzed by the AI. Boundaries may also be automatically defined by a controller executing software during certain process steps, such as a user query. A boundary within the context of a design plan may signify the presence of a wall. Using deep artificial neural networks, original architectural floor plans (along with any labeled boundaries) may be used to train AI models to make predictions about what is inside a boundary. In exemplary embodiments, the AI model may be given over ~50,000 similar architectural floor plans to improve boundary-prediction capabilities.

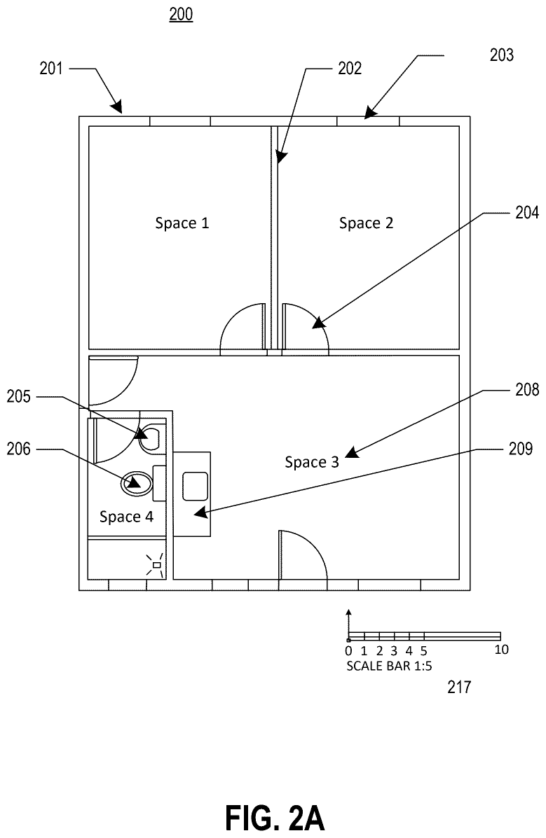

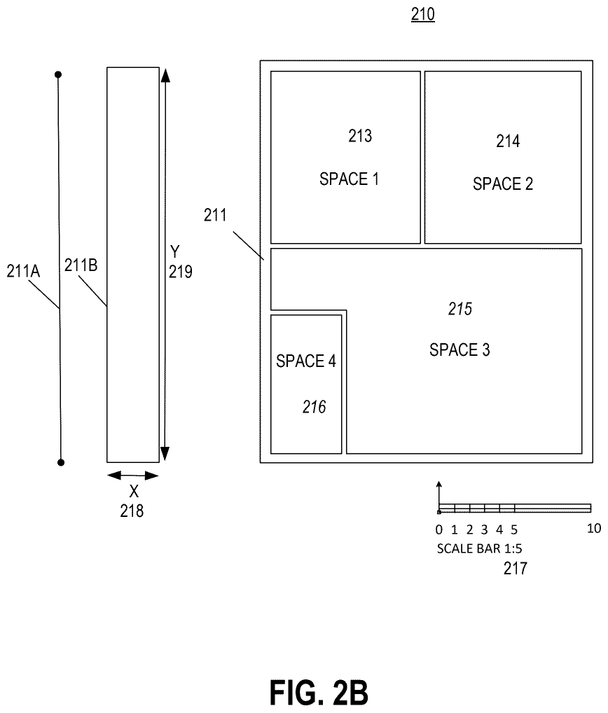

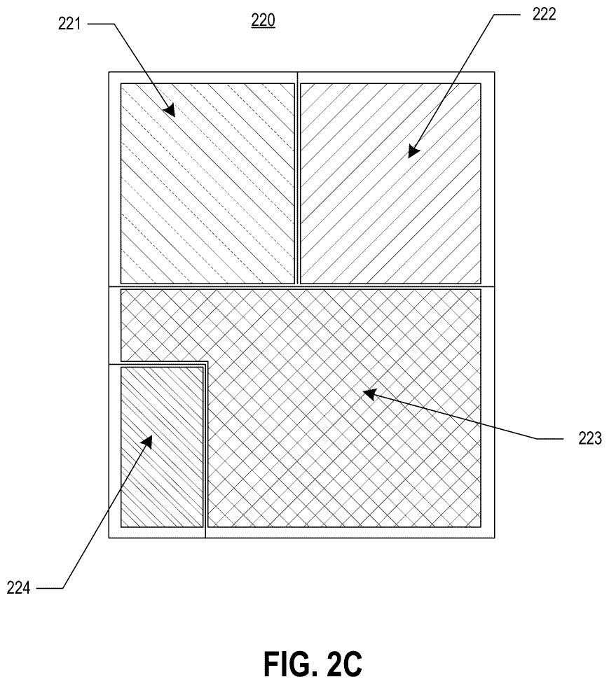

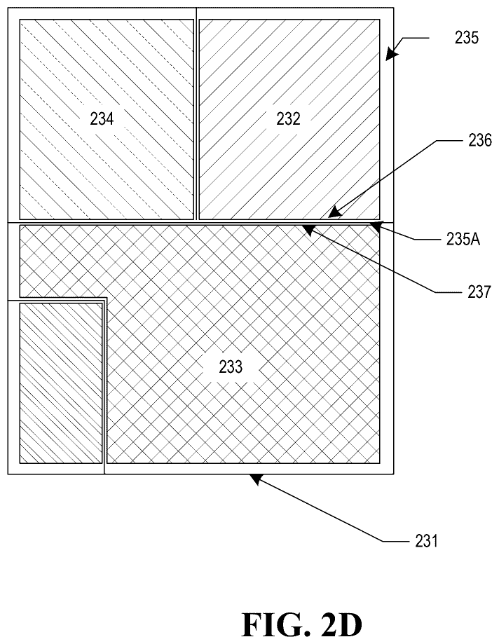

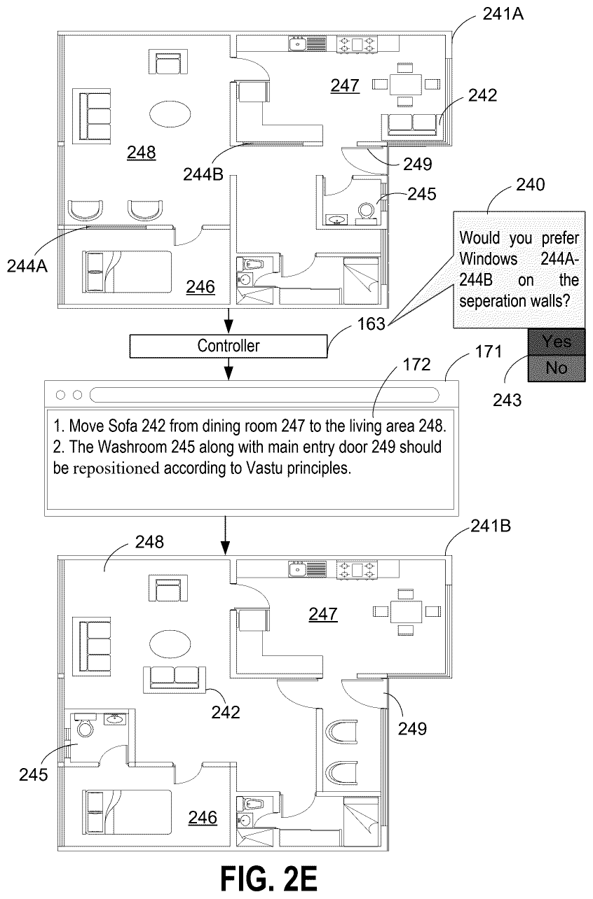

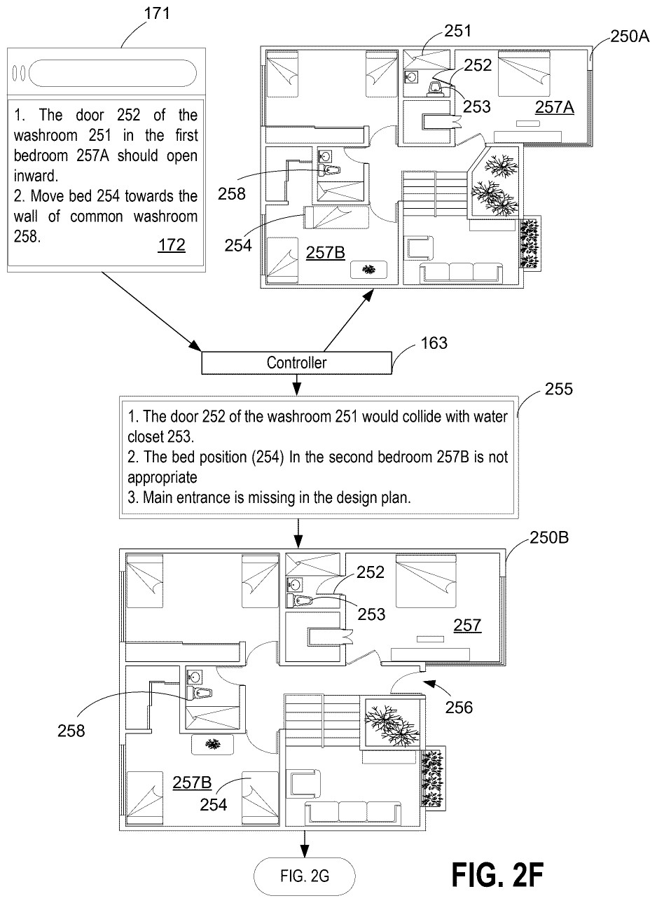

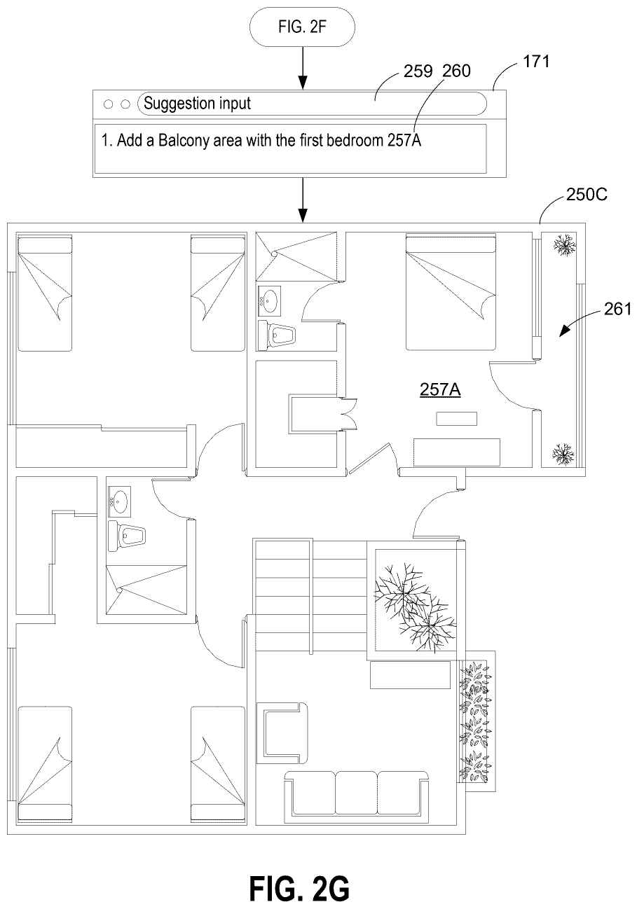

In some embodiments, a training database may utilize a collection of design data that may include one or more of: a combination of a vector graphic two-dimensional references such as floor plans and associated raster graphic version of the two-dimensional references; raster graphic patterns associated with features; and a determination of boundaries may be automatically or manually derived. (An exemplary AI-processed two-dimensional reference that includes a design plan and/or a floorplan 210, with boundaries 211 predicted, is shown in FIG. 2B, based on the floorplan of FIG. 2A).

In still another aspect, in some embodiments, a controller may access data from various types of BIM and Computer Aided Drafting (CAD) design programs and import dimensional and shape aspects of select spaces or portions of the designs as they are related to a design plan.

At step 104, an AI engine may ascertain features included in the design plan, the AI engine may additionally ascertain that a feature is located within a particular set of boundaries or external to the set of boundaries. Features may include, by way of non-limiting example, one or more of: architectural aspects, fixtures, duct work, wiring, piping, or other items included in a two-dimensional reference submitted to be analyzed. The features and boundaries may be determined, for example, via algorithmically processing an input design plan image with a trained AI model. As a non-limiting example, the AI engine may process a raster file that is converted for output as an image file of a floorplan (as illustrated in FIG. 2B, a boundary is represented as a line, a boundary may also be represented as a polygon, which may be a patterned polygon or other user discernable representation, such as a colored line etc.). Features may also be designated on a user interface. A feature may be represented via an artifact, such as, for example, one or more of: a point, a polygon, an icon, or other shapes.

At step 105, a scale (e.g., FIG. 2B item 217) is associated with the two-dimensional reference. In preferred embodiments, the scale is based upon a portion of the two-dimensional reference dedicated for indicating a scale, such as a ruler of a specific length relative to features included in a technical drawing included in the two-dimensional reference. The software then performs a pixel count on the image and applies this scale to the bitmapped image. Alternatively, a user may input a drawing scale or dimension for a particular image, building component, a wall, a boundary, a drawing, or other two-dimensional reference. The drawing scale, may for example, be in inches: feet, centimeters: meters, or any other appropriate scale.

In some embodiments, a scale may be determined by manually measuring a room, a component, or other empirical basis for assessing a scale (including the ruler discussed above). Examples therefore include a scale included as a printed parameter on two-dimensional reference or derived via reference to one or more dimensioned features in the design plan. For example, if it is known that a particular wall is thirty feet in length, a scale may be based upon a length of the wall in a particular rendition of the two-dimensional reference (or design plan) and proportioned according to that length. The known length of the wall can be determined from the markings or text on the design plan or can be specified by a user as an input. A known length or width of any other building component can be determined or entered by the user. Based on such known length or width of one building component, the scale can be proportioned, and dimensions of other building components can be calculated.

At step 106, a controller is operative to generate an interactive user interface with dynamic components (design elements) that may be manipulated by one or both of user interaction and automated processes. Any or all of the components in a user interface may be converted to a version that allows a user to modify an attribute of the components, such as the length, size, beginning point, end point, thickness, or other attribute. In some embodiments, a boundary may be treated as a component or a wall and manipulated in a similar manner.

Other components included in the user interface may include, one or more of: AI engine predicted components, user training aspects, and AI training aspects. In some non-limiting examples of the present invention, a generative adversarial network may include a controller with an AI engine operative to generate a user interface that includes dynamic components. In some embodiments, a generative adversarial network may be trained based on a training database for initial AI feature recognition processes.

An interactive user interface may include one or more of: lines, arcs, or other geometric shapes and/or polygons. In some embodiments, the geometric shapes and/or polygons may comprise boundaries. The components may be dynamic in that they are further definable via user and/or machine manipulation. Components in the interactive user interface may be defined by one or more vertices. In general, a vertex is a data structure that can describe certain attributes, like the position of a point in a two-dimensional or three-dimensional space. It may also include other attributes, such as normal vectors, texture coordinates, colors, or other useful attributes.

At step 106A, in some embodiments, components presented in the interactive user interface may be analyzed by a user and refinements may be made to one or more components (e.g., size, shape and/or position of the component). In some embodiments, user modifications may also be input back to the AI engine to train the AI engine. User modifications provided back to the AI Engine may be referenced to make subsequent AI processes more accurate, efficient, fast, trained and/or enable additional types of AI processes.

At step 107, some embodiments may include a simplification or component refinement process that is performed by the controller. The component refinement process is functional to reduce a number of vertices generated by a transformation process executed via a controller generating the user interface and to further enhance an image included in the user interface. Improvements may include, by way of non-limiting example, one or more of: smooth an edge, define a start, or endpoint, associate a pattern of pixels with a predefined shape corresponding with a known component or otherwise modify a shape formed by a pattern of pixels.

In addition, some embodiments that utilize the recognition step transform features such as windows, doorways, vias and the like to other features and may remove them and/or replace them as elements—such as line segments, vectors, or polygons referenceable to other neighboring features. In a simplification step, one or more steps the AI performs (which may in some embodiments be referred to as an algorithm or a succession of algorithms) may make a determination that wall line segments, and other line segments represent a single element and then proceeds to merge them into a single element (line, vector, or polygon). In some embodiments, straight lines may be specified as a default for simplified elements, but it may also be possible to simplify collections of elements into other types of primitive or complex elements including polylines, polygons, arcs, circles, ellipses, splines, and non-uniform rational basis spline (NURBS) where a single feature object with definitional parameters may supplant a collection of lines and vertices.

The interaction of two elements at a vertex may define one or more new elements. For example, an intersection of two lines at a vertex may be assessed by the AI as an angle that is formed by this combination. As many construction plan drawings are rectilinear in nature, it may be that the simplification step inside a boundary can be considered a reduction in lines and vertices and replacing them with elements and/or polygons.

In another aspect, in some embodiments, one or both of a user and a controller may indicate a component type for a boundary. Component types may include, for example, one or more of line segments, polygons, multiple line segments, multiple polygons, and combinations of line segments and polygons.

At step 108, a controller (such as, by way of non-limiting example, a cloud server) operative as an AI engine may create AI-predicted dynamic boundaries that are arranged to form a representation of the submitted design plan that does not include the boundaries that bound it.

In various embodiments, a boundary may be used to define a unit, such as a residential unit, a commercial office unit, a common area unit, a manufacturing area, a recreational area, a dining area, or other area delineated according to a permitted use.

Some embodiments include an interface that enables user modifications of boundaries and areas defined by the modified boundaries. For example, a boundary may be selected and “dragged” to a new location. The user interface may enable a user to select a line end, a polygon portion, an apex, or other convenient portion and move the selected portion to a new position and thereby redefine the line and/or polygon. An area that includes a boundary as a border will be redefined based upon the modification to the boundary. As such, an area of a room or unit may be redefined by a user via the user interface. Changing an area of a room and/or unit may in turn be used as a basis for modifying an occupant load, defining an egress path, classifying a space, or other purposes.

For example, a change in a boundary may make an area larger. The larger area may be a basis for an increase in occupancy load. The larger area may also result in a longer path from the furthest point in the defined area to a point of egress (e.g., if a user chooses to use a worst case in determining an egress route). Empowering users with flexibility, the present invention allows for modifications to room boundaries, lines, and polygons, enabling the alteration of shapes and sizes to adhere to best practices with automated revision suggestions to design plans. This dynamic feature not only facilitates compliance with regulatory standards but also caters to user preferences or priorities, allowing them to retain the opulence and aesthetic appeal of their spaces. Whether it is aligning with specific best practice requirements or enhancing the overall user experience by accommodating individual tastes, the present invention offers a harmonious blend of functionality and personalization. Users can effortlessly tailor their rooms to meet both regulatory guidelines and their own vision, striking a balance between compliance and the creation of spaces that truly reflect their unique style and preferences.

At step 109, the system receives user input for either generating a whole new design plan or modifying the existing design plan (received at step 100). The user input may relate to any of the components identified in the design plan, including room dimensions, placement of windows, doors, fixtures, or even resizing entire sections of the building. For example, a user may request to shift the position of a window from one wall to another or resize a room to accommodate a new purpose. The system processes this input, incorporating it into the existing design framework. In the case of generating a new design plan, the user may input building specifications like “create a three-bedroom house with an open kitchen and two bathrooms.” This input provides the foundation on which the system generates an optimized layout using AI engine and GAN capability.

At step 110, the system determines the design considerations that need to be applied to the design plan. These considerations may include preferred practices, building deployment objectives, cultural principles, client-specific requirements, or other factors relevant to the project. The system dynamically identifies these considerations based on the user's input and/or the enabled design considerations for the project. For example, if the user has enabled cultural compliance, the system will prioritize room orientation according to cultural guidelines. Similarly, the system may access a design consideration database that includes details on building deployment objectives, such as the need for efficient space utilization in a commercial building or the inclusion of sustainability features like solar panels. The system automatically cross-references the user input with these design considerations to create a compliant and optimized design plan. For example, a user may specify a preference for a modern open-plan living space. The system with a revised design that aligns space efficiency with structural integrity.

At step 111, the system interacts with the user to better understand the context of the design changes or generation. This comprises an interactive process where the system asks relevant questions to clarify ambiguities or uncertainties in the design inputs. For example, if the user requests to shift a window from one wall to another, the system may ask, “Is the new window placement meant to optimize natural light?” or “Do you need this change to maintain a specific view or aesthetic?” Similarly, the system may inquire whether there are existing external structures nearby that could impact design decisions, such as “Is there a neighboring building in close proximity that affects this design?” The system may also ask contextual questions such as, “Would you prefer to align the building to face east for cultural compliance?” These interactions may enable the system to gather all the required information before proceeding to modify or generate the design plan.

At step 112, the system performs a design feasibility check. Even if the requested changes or design generation comply with all the applicable design considerations, the system evaluates whether the proposed design is feasible for construction. This step is important to determine that the design not only meets aesthetic and functional requirements but is also structurally sound and practical for implementation. For example, if a user requests to remove a wall, the system checks whether that wall is load-bearing and if its removal would impact the structural stability of the building. Similarly, if the design includes oversized windows for aesthetic reasons, the system evaluates whether the materials required to support such windows are readily available and if they align with local preferred building practices or material availability. The system may also assess the feasibility of building complex architectural elements, such as curved walls or cantilevered sections, based on the local construction capabilities and available technology. If any issues are detected, the system provides feedback to the user, offering alternative design suggestions to maintain both compliance and feasibility.

At step 113, the system proceeds may modify or generate the design plan based on the user's inputs. This modification or generation process involves updating the architectural elements in the design plan to reflect the user's requests while staying aligned with the overall project objectives. For example, if the user asked to enlarge a room, the system adjusts the dimensions of that room while also recalibrating the space around it to maintain proportionality and functionality in the design. The new or modified design is then displayed to the user through an interactive user interface where further tweaks can be made if required. The system may also provide visual or structural simulations, allowing the user to view how the changes will appear once implemented.

In some embodiments of the present invention, the system may receive a pre-existing design plan for a single-story residential house as the initial input at step 100. This design may include a living room, two bedrooms, a bathroom, and a kitchen. At step 109, the system receives a user request to modify the layout by adding an additional bedroom. To achieve this, the user may input instructions to resize the living room and convert a portion of the space into a new bedroom.

The system (including AI engine and/or GAN engine) processes the user's modification request by analyzing the design and determining the appropriate adjustments to the living room's dimensions and the new bedroom layout. Additionally, the system may automatically resize adjacent components, such as doors and windows, to maintain consistency across the design. The GAN engine may provide various layout suggestions, optimizing the space by suggesting where to position the windows and doors in the new bedroom for optimal light and airflow. These modifications are incorporated into the existing design framework, and the resulting floor plan reflects the new bedroom without disrupting the integrity of the original layout.

In other embodiments, the system may receive an office layout design plan as input at step 100, where window placements have already been defined. At step 109, the system receives user input requesting to shift a design element (e.g., a window) from the southern wall to the eastern wall to improve ventilation and light.

The AI engine analyzes the structural implications of the requested modification, considering factors such as wall load capacity, proximity to HVAC systems, and the existing wall layout. The system may also evaluate the external environmental factors (e.g., sun exposure, wind direction) to optimize the placement. Using GAN engine, the system generates several proposed layouts where the new window placement enhances both aesthetics and functionality. The system interacts with the user, asking if the proposed locations are satisfactory, and upon confirmation, the design element or window position is shifted as per the new optimized plan.

In another embodiment, the system receives a new design request from the user at step 109. The user inputs specifications for generating a new residential building, such as “create a three-bedroom house with an open kitchen, two bathrooms, and a study room.”

The system, using its AI and GAN capabilities, processes the user's input and generates an initial floor plan. The AI engine calculates room configurations and adjacency, facilitating efficient use of space while maintaining the user's specifications. The GAN engine enhances the layout by suggesting optimized placements of utilities, like kitchen and bathroom plumbing, and maximizing natural light through strategic window placements. The generated design plan may be based on the user's initial design plan input (at step 100) but is refined to balance spatial efficiency, aesthetics, and energy conservation, offering a fully optimized layout for the proposed residential building.

In yet another embodiment, the system receives an office building design plan at step 100, which includes two large meeting rooms and a central open office area. At step 109, the user requests to resize one of the meeting rooms to create additional workspace.

Upon receiving this modification request, the AI engine evaluates the spatial impact of reducing the meeting room's size. The system dynamically adjusts the office layout to incorporate additional workstations in the newly created space. At the same time, the GAN engine analyzes the layout to maintain optimal circulation and access, suggesting possible configurations for new furniture arrangements and facilitating that the resized meeting room still meets the user's functional requirements. The system then modifies the design plan, updating the room dimensions and workspace allocations as per the user's input.

In some embodiments, the system receives a request at step 109 for generating a new multi-story office building layout. The user specifies that the building should include two floors, the first floor dedicated to open-plan offices and the second floor allocated for meeting rooms and private offices.

The system processes the user's specifications and generates a two-story layout, using the AI engine to calculate optimal space distribution for work areas, meeting rooms, and circulation pathways. The GAN engine helps optimize the layout by suggesting efficient vertical circulation (e.g., staircases, elevators) and strategic window placement to maximize natural light. Additionally, the system factors in building deployment objectives such as emergency egress routes and load-bearing wall placement, offering the user a fully generated design plan that aligns with their initial specifications while optimizing for functionality and safety.

In some embodiments of the present invention, the AI engine is responsible for managing and enforcing associated rules pertaining to the movement or alteration of design elements that have associated annotations. The system is configured to recognize user roles and privileges, so that only those users with the appropriate permissions can make changes, move, or alter design elements or their associated annotations. If a user without the required rights attempts such actions, the AI engine intervenes, restricting these unauthorized modifications. This enforcement of rules maintains the integrity of the design plan and facilitates compliance with collaborative protocols. It also protects the annotations' continuity and relevance, as any changes to design elements are reflected in real-time, preserving the accuracy and context of the collaborative effort.

In some embodiments of the present invention, the AI engine may include a learning mechanism that constantly evaluates past annotations in relation to similar design elements. This historical analysis allows the AI engine to identify patterns and preferences in the annotation behaviors of users. Consequently, when a specific design element is selected for annotation, the AI engine may proactively suggest potential annotations, drawing from its repository of learned data. These automated annotation suggestions aim to streamline the annotation process by anticipating user needs and promoting consistency across the design plan. This feature not only saves time but also enhances the overall quality of the annotations by leveraging the collective intelligence gathered from previous interactions within the platform.

Referring now to FIG. 1B, a high-level diagram illustrates components included in a system 120 that uses AI to generate an interactive and collaborative user interface 125 and programmable apparatus (controller) 123 operative to execute method steps useful in one or both of: adding annotations to design elements within a static representation of a design plan, and managing alterations to these design elements while automatically adjusting the associated annotations and rules in real-time. This process may involve identifying design elements that may benefit from additional information or clarification, prompting users to add relevant annotations. Furthermore, when design elements are moved or altered, the AI engine facilitates that all related annotations are dynamically updated, altered or kept intact to reflect these changes, maintaining the accuracy, association, and relevance of the annotations. Simultaneously, the system may enforce automated, predefined, or user-defined rules regarding who can make alterations to those design elements and/or associated annotations, based on user roles and permissions, thereby preserving the integrity of the design plan, and facilitating a collaborative yet controlled design environment.

According to some embodiments of the present invention, a two-dimensional reference 121, such as a design plan, floor plan, blueprint, or other document includes a pictorial representation 122 of at least a portion of a building. The pictorial representation 122 may include, for example, a portable document format (PDF) document, jpeg, PNG, or other important non-dynamic file format, or a hardcopy document. The pictorial representation 122 includes an image descriptive of architectural aspects of the building, such as, by way of non-limiting example, one or more of: walls, doors, doorways, hallways, rooms, residential units, office units, bathrooms, stairs, stairwells, windows, fixtures, real estate accouterments, and the like.

The two-dimensional reference 121 may be electronically provided to a controller 123 running an AI engine and a GAN engine. The controller 123 may include, for example, one or more of: a cloud server, an onsite server, a network server, or other computing device, capable of running executable software and thereby activating the AI engine. Presentation of the two-dimensional reference may include, for example, scanning a hardcopy version of the two-dimensional document into electronic format and transmitting the electronic format to the controller 123 running the AI engine.

According to the present invention, the AI engine may use raw data, manipulated data, interpreted data, new data and data types generated from existing data. Data may include one or more of: text, image, numerical, pixel patterns, polygons, vectors, molecular, neural, digital, and analog data modalities.

Data sources may include, one or more of: a user portal; Internet accessible resources; shipping data, fuel use tracking; manufacturer data; product data sheet; geolocation device, or other receptacle or generator of data related to material used in a building or other construction project.

AI engine processing may include one more of: converting image data to pixel patterns and/or polygon patterns, manipulating pixel patterns and/or polygon patterns, analyzing pixel patterns and/or polygon patterns, optical character recognition, alphanumeric analysis, symbol recognition and the like. Proposed action strategies, protocols and opportunities may be associated with an ascertained state.

The present invention provides for the deployment of computational frameworks combining disparate aspects of technology to perform tasks that are beyond the ability of traditional design and build systems or human intelligence. These systems aggregate large volumes of disparate data that may or may not be intuitively linked to building design, carbon footprint, eco-friendliness, compliance codes, supply chain availability, anticipated ambient climate conditions, measured ambient climate conditions, building activities, or other data source, and utilize multiple modalities data manipulation, algorithms, and statistical models to generate proposed action strategies for a patient (or group of similarly situated patients). Modalities of data manipulation may include, but are not limited to:

Machine Learning (ML): A subset of AI where systems learn from data. Instead of being explicitly programmed, they adjust their operations to optimize for a certain outcome based on the input they receive.

Deep Learning: A subfield of ML using neural networks with many layers (hence “deep”) to analyze various factors of data, such as, for example, convolutional neural networks (CNNs) used in image recognition. For example, convolutional neural networks may receive as input image data from scans of various types and generate pixel patterns representative of the scans. The pixel patterns may be compared to a library of other pixel patterns and/or manipulated to emulate progression of a disease state and/or a treatment protocol over time.

Natural Language Processing (NLP): Allows systems to understand, interpret, and generate human language. NLP may provide interpretations of voice data. Voice data may be made accessible, for example, via recording made during design plan review and assessment and/or during supply chain activities.

Robotics: Robots may operate using AI principles, enabling the robots to perform tasks in accurate, specific, and consistent ways. Robots may also be utilized during data collection, such as during building scans (e.g., 3D image acquisition scans), as built measurement acquisition, infrared heat image acquisition and the like.

Knowledge Representation: The methods and apparatus taught herein may receive data in a native or enhanced state and manipulate and transform the received data into a machine learning understandable form.

Reasoning: The methods and apparatus taught herein may solve deploy logical deduction via expert systems and the like to facilitate decision-making.

Perception: The methods and apparatus taught herein may use algorithms and complex relational processes that allow machines to interpret disparate data sets, including image data, sound data, and alphanumeric data.

Apparatus and methods may be arranged to form one or more of: Neural Networks; Genetic Algorithms; Expert Systems; and Reinforcement Learning.

In some embodiments, GPUs may be used to accomplish large-scale machine-learning models using parallel processing capabilities. Hardware accelerators may be utilized for deep learning tasks. In some embodiments, tensor processing units and/or neuromorphic computing mechanisms may be used to analyze data sets. Cloud platforms may be used with AI processes, such as deep learning that require significant computational resources.

Electronic and/or electromechanical apparatus may provide data to be processed using the methods and apparatus presented herein. Apparatus may include, by way of a non-limiting example, one or more of: three-dimensional (3D) image scans, heat imaging acquisition, design plan scanners, building monitoring electronic sensors, drone-based electronic scans, satellite-based data acquisition or other means of acquiring data that may be transformed into digital and/or analog data sets.

Some AI Engine generated treatment strategies may include suggested courses of action that may be weighted based upon one or more of: projected effectiveness; timing, geographic location, and a material's ability to be transported; cost; and project criticality, including timeline relative to other actions and/or tasks that must be completed, such as for example, a sequence of construction steps, inspections, and financing requirements.

The controller is operative to generate a collaborative user interface 125 on a user computing device 126. The user computing device may include a smart device, workstation, tablet, laptop or other user equipment with a processor, storage, and display.

The user interface 125 includes a reproduction of the pictorial representation 122 and an overlay 124 with one or more user-manipulatable components, such as, by way of non-limiting examples: boundaries, line segments, polygons, images, icons, points, and the like. The line segments may have calculated lengths that may be mathematically manipulated and/or summarized. Aspects such as polygons, line segments, shapes, icons, and points may be counted, added, subtracted, extrapolated, and have other functions performed on them.

In addition, renditions of the user interface 125 may be created and saved, and/or communicated to other users, or controllers, compared to subsequent interface renditions, archived and/or submitted to additional AI analysis.

In some embodiments, a first user interface 125 rendition may be modified by a user to create a second user interface 125 and submitted to AI analysis to perform tasks including assisting users in adding better annotations to a selected design element. This assistance is based on the AI's analysis of the selected design element and a historical review of similar annotations associated with such design elements. The AI engine continuously learns from the ways users add annotations to different types of design elements, enabling it to suggest the most relevant and useful annotations for any given element. This learning process allows the AI engine to provide tailored suggestions that improve over time, reflecting the collective experience and insights of the user community on the collaborative platform of the present invention. By leveraging past annotation patterns, the AI facilitates a more intuitive and efficient annotation process, enhancing the collaborative design effort.

In the context of the present invention, design elements may also refer to the various components that contribute to the overall layout, functionality, and aesthetic appeal of a building or space. These elements include, but are not limited to, rooms, walls, doors, windows, staircases, partitions, fixtures, furniture, and finishes. Rooms may be designated for specific functions, such as living rooms, bedrooms, kitchens, or bathrooms, with their size and shape tailored to the intended use. Walls define the boundaries of spaces and may serve structural, aesthetic, or privacy functions, while partitions provide flexible divisions within open areas. Doors and windows are important for access, ventilation, natural light, and aesthetics, with their placement affecting the flow and usability of a space. Fixtures, such as sinks, toilets, lighting, and built-in cabinetry, are important for the functionality of spaces like bathrooms and kitchens. Furniture placement, including beds, desks, sofas, and dining tables, defines how a space will be used, enhancing comfort and practicality. Additionally, design elements may include aesthetic features such as color schemes, textures, flooring materials, and decorative finishes, which contribute to the visual and tactile experience within a space. These elements are also configured to comply with spatial and functional requirements, user preferences, and environmental factors such as lighting, acoustics, and air circulation, all of which are considered in the design plan generated by the system.

Referring now to FIG. 1C, the illustration showcases an exemplary aspect of the present invention's collaborative environment, demonstrating how a user may annotate a design element on a design plan. In this exemplary embodiment, the user interface 125 displays a static pictorial representation 122 of a design plan, containing various dynamic design elements such as lines, polygons, rooms, walls, and boundaries. A user may initiate the annotation process by selecting 131 a design element 130 on the design plan, which can be done by marking on or around the desired design element 130 or by simply double-clicking on the design element 130.

Upon selection, a pop-up window 132 appears, providing a space where the user can type in text annotations that will be linked with the chosen design element 130. Alongside the text entry field, the pop-up window 132 may also include an additional options button 134. This button 134, when selected, unveils a suite of annotation tools 135, offering a range of methods to enrich the annotations.

For example, the user can choose to attach multimedia content 136, like photos or video clips, which may serve as a visual supplement to the textual annotations for the selected design element 130. If the user wishes to add an audio note, they can do so using the audio record function 137, capturing their verbal instructions or comments directly via a microphone. Moreover, the user also has the convenience of using a speech-to-text feature 138, where spoken words are transcribed into written text annotations. This functionality simplifies the process of adding detailed descriptions or instructions, as the user's voice is automatically converted to text and associated with the selected design element 130 as an annotation.

In some embodiments of the present invention, the interactive user interface may be engineered to offer an intuitive mechanism for annotating within a shared design plan. When a user selects a design element, such as a polygon, a line, a room or a wall, the system may respond by presenting a context-sensitive annotation interface. This interface is contextually programmed to suggest annotation tools and options relevant to the type of design element selected. For example, upon selecting an area where an air conditioning unit is to be installed, the interface may prioritize or suggest multimedia annotations that provide visual cues or installation guidelines.

Referring now to FIG. 1D, the diagram illustrates an exemplary feature of the present invention's interface to aid users in the annotation process. The figure displays a user actively engaging with an annotation pop-up window 132 for a selected design element within the collaborative platform. As the user begins to type, for example, “Install AC Here,” the system's AI engine intervenes with automated annotation suggestions as shown in an automated annotation suggestions window 150.

These suggestions, shown in the automated annotation suggestions window 150, are generated based on a variety of factors, including the current context of the design element, the user's typing activity, and historical data collected from past user interactions with similar design elements. The exemplary annotation suggestions may include but are not limited to: “Install AC Here but size must not exceed . . . ”, “Prefer window here . . . ”, or other recommendations like “Drawing room—install TV here . . . ”. Each suggestion aims to prompt the user with common annotations or considerations that align with the selected design element's purpose and location.

Additionally, the interface may also facilitate inclusion of multimedia annotations, as evidenced by the “Add this image . . . ” option accompanied by a photo icon for a recommended photo extracted from an annotation database to be associated with the annotation. This interactive feature suggests that users can enrich their annotations with visual aids directly related to the selected design element, which may include images or diagrams relevant to the installation or positioning instructions (i.e., annotations) being entered.

This automated annotation suggestions feature showcases the system's dynamic response to user input, effectively marrying the AI's predictive capabilities with the user's manual annotations. It enhances user experience by minimizing repetitive typing, guiding users through a library of common annotations, and providing quick-access options for multimedia attachments. This intelligent assistance is indicative of the platform's design to expedite the annotation process, reduce potential errors, and facilitate consistency in documentation throughout the collaborative design environment.

In some embodiments of the present invention, the system's AI engine utilizes an extensive annotation database to provide automated annotation suggestions that may also include a multimedia library. When a user initiates an annotation-adding process for a selected design element, the AI engine queries this library to retrieve and suggest one or more images (or maybe video clips) that are relevant to the design element in question. This library comprises a collection of images and video clips previously used in annotations, which have been tagged and indexed according to the design elements they correspond to.

Furthermore, the AI is capable of generating automated images and video clips based on its historical analysis of similar past annotations. It uses learned patterns and user behavior to predict and present the most pertinent visual aids that could enhance the current annotation. This predictive ability is grounded in the AI's continuous learning process, where it assimilates information from each annotation interaction, gradually refining the relevance and precision of its image suggestions.

Such an embodiment streamlines the annotation process by providing users with quick access to a curated set of images and video clips, reducing the need for manual searches and facilitating a high level of consistency and detail in the annotations associated with specific design elements. Whether the user is specifying installation details, highlighting design features, or indicating modifications, the AI engine's integration with a multimedia library enriches the collaborative experience and aids in the conveyance of clear, concise, and visually supported information.

By way of non-limiting examples, according to the present invention, a design plan may be received as a static image two-dimensional reference. The design plan may be described using lines and arcs, and represent architectural layouts in a simplified geometrical way. In such a representation, architectural elements, such as, by way of non-limiting examples: walls, doors, windows, and architectural details, may be shown using straight lines (for linear elements) and arcs (for curved elements). A floorplan interpreted in terms of lines and arcs and/or patterns of pixels may include one or more of:

Exterior Walls: typically represented by thick lines. The thickness of a line may indicate the wall's thickness.

Interior Walls: which may be shown as slightly thinner lines compared to exterior walls, representing partitions or dividers within a space or other interior area.

Hinged Doors: a straight line representing a door's location and an arc showing the door's swing direction and extent.

Sliding Doors: two parallel lines (representing door panels) may include an arrow or dashed line indicating a sliding direction.

Double Doors: two straight lines representing door panels with arcs indicating each door's swing direction.

Which may, for example, be represented as thin lines or breaks in walls, sometimes with a zigzag line to indicate a window's presence or with a double line which indicates a double-pane window.

Straight Stairs: a series of parallel lines showing steps. Often, an arrow may be used to indicate the upward direction.

Spiral Stairs: may be represented using concentric arcs or circles, showing the curvature of the stairwell.

Cabinets, Countertops, Islands: straight lines and arcs may represent a shape and placement of cabinets, countertops, and islands.

Sinks, bathtubs: may typically be represented using a combination of lines and arcs to depict their shapes.

Rounded Corners: instead of sharp, angular intersections between walls, arcs are used to show the curve.

Circular Rooms or Features: may be represented using full circles or arcs.

Electrical: may be shown with dotted lines or specific symbols indicating outlets, switches, and fixtures.

Plumbing: may be represented via dotted or dashed lines to represent hidden plumbing within walls or under floors.

When interpreting or representing a floorplan using lines and arcs, conventions used in architectural drawings may be referenced. In some embodiments, a legend or key that describes what each line, arc, or symbol means, may facilitate clarity in understanding the design.

FIG. 1E shows a settings window 140 that emerges when a user engages with the settings option 133 on the annotations pop-up window 132. This settings window 140 serves as a control panel for managing the collaborative and interactive features of the platform tailored to user annotations and design elements.

The “Set Rules” function 141 enables users to establish comprehensive guidelines for managing interactions with the design plan. Users can define protocols for editing, altering, deleting, or relocating both design elements and their associated annotations within the collaborative platform. Serving as a robust governance mechanism, this function facilitates that any modifications to the design plan or its components are consistent with predefined conditions. These conditions may be customized to meet the unique demands of a specific project, cater to individual user preferences, align with organizational policies, or comply with applicable best practices and regulations.

Furthermore, a “Set Rules” function 141 may include programmable logic allowing for an automated or manual adjustment of rules as the project evolves or as new information becomes available to the AI engine, facilitating ongoing relevance and adherence to the latest standards and practices.

In some embodiments of the present invention, the settings window may be a nexus of innovative controls that adapt to the intricate dynamics of the collaborative design environment. The “Set Rules” function 141 may be engineered with an algorithm that can predict and propose rule sets based on the project type, historical data, and individual user performance, thus preempting the need for manual input, and offering a starting point for rule customization. The “Set Rules” function 141 may allow users to construct a detailed matrix of permissions, specifying who can make edits, how elements can be adjusted, and under what circumstances annotations can be moved or deleted. This rule-setting may go beyond general restrictions, offering granular control, such as time-bound editing rights or element-specific permissions that facilitate changes are made responsibly and in accordance with the project's lifecycle or phase-specific requirements.

With the “Share with” function 142, users can distribute the annotations and design elements to selected team members or stakeholders. Beyond standard methods like email, the system may incorporate features such as direct in-platform tagging, integration with project management tools for task assignments, or even using unique identifiers like QR codes that, when scanned, grant access to specific annotations or design elements. In some embodiments of the present invention, the “Share with” function 142 may employ machine learning algorithms to suggest potential team members for collaboration based on their past contributions, expertise, and current availability, going beyond manual tagging and email sharing. This feature may integrate with organizational calendars and resource planning tools to automatically suggest the best times and team members for collaborative sessions within the platform.

The “Share with” function 142 may extend collaboration by integrating with advanced user identification systems, enabling sharing through biometric recognitions, such as fingerprint or retina scans, for high-security projects. It may also incorporate smart notifications that alert users when a relevant component is shared with them, streamlining the review and feedback process.

The “Roles” setting 143 defines and/or assigns specific permissions to different users or team members. This feature not only controls who can change or approve annotations but also can extend to defining hierarchies of approval, enabling tiered levels of access where senior designers or project managers may have override capabilities or exclusive editing rights. In some embodiments of the present invention, for “Roles” setting 143, the system may dynamically suggest role changes for users by analyzing their interaction patterns with the platform. For example, if a user frequently adds substantial contributions to a particular design element, the system may suggest elevating their role for that element or similar elements, streamlining the workflow and empowering effective contributors.

Lastly, the “AI Suggestions” option 144 may provide users with the ability to influence the AI engine's learning path, particularly concerning the relevance of automated annotation suggestions. Users can give feedback on the AI's suggestions to enhance its future performance. For example, a senior architect may train the AI to recognize and suggest energy efficiency tips for certain design elements, or an engineer may focus the AI's learning on structural integrity notes. Additionally, depending on their authority, users may influence the AI's learning on a personal level for individualized suggestions or on a collective level to improve the engine's utility for the entire team.

In some embodiments of the present invention, the “AI Suggestions” option 144 may include a feedback loop where the AI engine not only learns from the annotations made but also from the user's response to its suggestions, including ignored, accepted, or modified inputs. This allows the AI engine to refine its suggestion accuracy, not just in the context of the current project but across similar future projects. Additionally, the AI engine may offer versioning control suggestions, advising on the ideal moments to create new versions of the design plan, design element and annotations based on the volume and significance of recent annotations and changes.

Referring now to FIG. 1F, an exemplary process is illustrated wherein a user engages with the collaborative platform to relocate a design element 130 which carries an associated annotation 160. Upon moving the design element to a new position, now indicated as 130′, the system's AI engine automatically relocates the associated annotation to 160′ associated with the moved design element 130′, maintaining the contextual link between the annotation and the design element.

In some embodiments, the AI engine is equipped to not only move the annotation but also to assess and implement slight adjustments to the annotation's content or presentation. These modifications may be based on factors such as the nature of the movement, the final placement of the design element, or the spatial relationship to other design elements and annotations. For example, if a window, originally on the north-facing wall, is moved to a south-facing wall, the annotation may be updated to reflect the change in sunlight exposure.

Additionally, the AI engine may provide visual cues to indicate that an element has been moved, such as highlighting the original and new locations or creating a trail from the original to the new position. In some other embodiments, the AI engine may suggest updates to related annotations based on the element's new location, such as recommending changes in material or dimensions that are more suited to the new position within the structure or building.

Furthermore, the system may track the movement history, allowing users to view and revert to previous positions if needed. This feature supports iterative design processes where relocation decisions are explored and evaluated in real time. It may also aid in maintaining a comprehensive audit trail that can be invaluable during the review stages or in post-project analyses.

Referring now to FIG. 1G, an exemplary system 161 for generating and modifying a design plan in accordance with the present invention, is illustrated. The system 161 is an interconnected architecture that facilitates communication between various components involved in the design plan creation and modification process. FIG. 1G shows how user devices 162, user inputs 164, client requirements 165, and design considerations 166 work together through a centralized controller 163 (similar to the controller 123 shown in FIG. 1B) running an AI engine and a GAN engine, providing an integrated platform for the development of architectural and design plans.

The user devices 162 represent any electronic device that allows a user to interact with the design system. These devices may include but are not limited to desktop computers, laptops, tablets, and smartphones. For example, an architect may use a tablet with stylus support to sketch initial layouts, while a project manager may use a laptop to input precise measurements or modify existing plans. Each user device 162 may be equipped with a display screen that acts as the user's primary interface for interacting with the controller 163. The display screen may show design plans in a digital format (e.g., a first interactive user interface), allowing the user to zoom in, modify sections, or generate new layouts in real-time.

The controller 163 is included in the system 161, running one or both the AI engine and the GAN engine to automate and optimize the design generation or modification process. The AI engine may be tasked with interpreting user inputs, recognizing patterns, and suggesting design modifications based on architectural best practices, while the GAN engine assists in generating realistic, creative design solutions by analyzing large datasets. For example, a user may input basic structural elements of a residential building, and the GAN engine can generate various optimized design options that balance space usage, aesthetic appeal, and functionality.

The user devices 162 may also be equipped with a digital storage medium that holds the executable software codes for interacting with the system 161. This software, when executed by the processor in the controller 163, facilitates various functions such as receiving inputs, processing design plans, and generating outputs for user review. For example, if an architect uploads an initial design plan, the software allows for seamless interaction, letting the user modify, resize, or shift elements in the design plan based on specific needs.

The controller 163 plays a key role in processing user inputs 164, which may include specific instructions regarding the design plan. User inputs 164 can be highly varied and specific to the context of a building project. For example, a user may provide inputs 164 related to a plot size, specifying dimensions such as “2000 square feet” where the proposed building will be constructed. This helps the system 161 allocate the available space optimally. Other user inputs 164 may include the number of rooms to be included in the building design plan, for example, “five bedrooms, two bathrooms, a kitchen, and a living room.” These inputs can also specify more technical elements, such as the types of spaces (e.g., open-plan vs. closed-plan areas, workspaces, restrooms, bedrooms, water closet areas, or communal areas) and the dimensions of each space, for example, “living room: 20 feet by 15 feet.”

Once the user inputs 164 are entered into the system 161 through the display screen of the user device 162, the controller 163 processes the information, using the AI and GAN engines to generate or modify the design plan accordingly. The controller 163 can perform advanced tasks such as adjusting room dimensions, changing space configurations, or suggesting alternative layouts to accommodate the user's requirements. For example, if a user inputs the need for a large kitchen that takes up a considerable portion of the ground floor, the system 161 may automatically adjust adjacent room sizes or suggest alternative room configurations to meet this requirement.

User inputs 164 within the system 161 may be provided through various methods of interaction, allowing for flexibility and accessibility in the design and modification of building plans. The system 161 is functional to accommodate multiple input formats to make the process intuitive and user-friendly, catering to professionals and non-professionals alike. These inputs can be provided via gestures, verbal commands, and written or typed text, each of which is processed by the controller 163 running the AI engine and GAN engine. The user devices 162, such as tablets, smartphones, or computers, provide the interfaces for receiving these inputs and translating them into actionable commands for design plan generation or modification.

In some embodiments, the system 161 may be configured to receive gesture-based inputs, allowing users to interact with the design plan using intuitive hand movements or stylus actions. For example, a user interacting with a tablet or a touchscreen device 162 may swipe, pinch, or drag elements on the display screen to adjust the layout or scale of a design. This mode of input can be particularly useful when users want to make rapid adjustments to the design, such as resizing a room by dragging its boundary lines or shifting the position of windows and doors with a simple finger movement.

The system 161 processes these gesture inputs and translates them into commands that the AI engine can use to modify the design. For example, if a user performs a “pinch to zoom” gesture to focus on a particular area of the building plan, the system 161 can zoom in on that section, allowing the user to make more precise adjustments. A swipe gesture may move entire sections of the floor plan, such as repositioning a bedroom or rearranging common areas like the kitchen or living room. Gestural inputs may provide a tactile, responsive way for users to interact with the design without the need for complex commands or text-based input.

In some advanced embodiments, the system 161 may support air gestures, allowing users to interact with the design plan without directly touching the screen. For example, in a presentation or collaborative design session, a user may use hand movements in front of a sensor-equipped device (e.g., 162) to make changes to the layout or highlight specific areas of interest. The system 161 may track these gestures using motion sensors and translate them into commands, enhancing the interactivity and engagement of the design process.

Another method of providing user inputs 164 may be through verbal commands. In some embodiments, the user device 162 may be equipped with a microphone that can capture the user's voice and interpret verbal instructions for design modification or generation. This feature allows users to provide input in a hands-free manner, making the design process more efficient and accessible, particularly when the user is multitasking or physically engaged in other activities.

For example, a user may say, “Add a window to the east wall of the living room,” and the system 161, using natural language processing (NLP) capabilities integrated within the AI engine, may recognize the command and apply the requested modification to the design plan. Verbal inputs can also be used for larger-scale changes, such as generating entire sections of the design. A user may state, “Create an open-plan kitchen with an island in the center,” and the system 161 may analyze the verbal input, cross-reference it with design considerations 166 (e.g., a database of space utilization, flow optimization, or compliances), and generate a layout based on the user's specifications.

The system's ability to interpret natural language allows it to ask clarifying questions when needed. For example, if the user says, “Move the bathroom,” the system 161 may respond verbally through a speaker on the user device 162 or via on-screen prompts, asking, “Where would you like to move the bathroom?” or “Please specify the new dimensions of the bathroom.” This interactive dialogue between the user and the system 161 facilitates more precise control over design modifications and enhances the overall user experience.

The use of verbal inputs also extends to environmental commands. For example, during a site walkthrough, a user may use a voice-activated device to say, “What's the distance between the kitchen and the living room?” and the system 161 can calculate and verbally deliver the measurement based on the current design plan. This type of real-time interaction enhances the system's utility in both the design and construction phases.

In more traditional use cases, user inputs 164 may also be provided through written or typed text. This method allows users to enter precise specifications for the design or modification of a building plan using keyboards or digital text entry interfaces on user devices 162. Written inputs are particularly useful when exact measurements, descriptions, or specific requirements need to be conveyed to the system 161.

For example, a user working on a large office layout may type, “Create three conference rooms on the second floor, each with dimensions of 15 feet by 20 feet.” The system 161 interprets this text input, cross-references it with design considerations 166, such as structural support for the second floor, and generates the requested conference rooms within the provided parameters. Text inputs can also be used to provide more detailed descriptions for specific design elements, such as typing, “Add recessed lighting in the living room and kitchen,” or “Shift the garage entrance to the north side of the house.”

The flexibility of providing inputs via gestures, verbal commands, and written text allows the system 161 to cater to a wide range of users, from experienced architects who need precise control over design parameters to clients or stakeholders who prefer a more intuitive and conversational approach. This multi-modal input system significantly enhances the accessibility and ease of use of the design process, making it possible for diverse users to engage with architectural planning in a way that best suits their preferences and needs. By integrating these various input methods, the controller 163 becomes an interactive hub, processing and refining inputs from multiple sources, resulting in a fluid, responsive design process that adapts to the specific needs and preferences of the user.

In addition to user inputs 164, the controller 163 may also access or determine client requirements 165. Client requirements 165 refer to the specific preferences or constraints provided by a customer or client for whom the design plan is being created or modified. These requirements 165 can vary widely depending on the type of project. For example, in a residential project, the client may request a specific architectural style, such as a modern minimalist design with large open spaces and floor-to-ceiling windows. Alternatively, in a commercial building project, the client may prioritize maximizing floor space for workstations and meeting rooms. The system 161 is capable of balancing these client-specific preferences while also adhering to functional and structural requirements.

Moreover, client requirements 165 may include considerations for future scalability or adaptability. For example, a client planning to expand their family home may request that the system 161 design a layout that allows for easy expansion, such as the addition of a second floor or an extra wing. The system 161 takes these inputs and applies AI-driven optimizations, so that the current design accommodates future modifications without requiring a complete overhaul of the original plan. In some embodiment, client requirements 165 may not be required or may be missing, for example, when a client himself is using the system 161 for generating or modifying a design plan.

Beyond user inputs 164 and client requirements 165, the controller 163 also considers design considerations 166 when generating or modifying the design plan. Design considerations 166 may include a variety of factors that govern the functionality, aesthetics, and regulatory compliance of the building. These considerations can be drawn from a database that stores preferred practices, building deployment objectives, structural guidelines, cultural principles, building codes, or other relevant standards. For example, in a project where energy efficiency is a priority, the design considerations 166 may include guidelines on optimizing natural light, reducing energy consumption through insulation, and placing windows and ventilation systems in optimal positions.

In some embodiments, the design considerations 166 may also factor in building deployment objectives, such as maximizing space efficiency in high-traffic commercial environments. For example, a retail store may need wide open areas for customer movement, while a corporate office may prioritize efficient use of space for cubicles and private offices. The system may automatically adjust room layouts, entrance locations, and aisle widths based on these objectives, so that the design meets both the functional needs of the client, and the architectural best practices stored in the design consideration database 166.

Design considerations 166 can also incorporate cultural or traditional guidelines, such as cultural or Feng Shui, which dictate room placement and building orientation based on spiritual or philosophical principles. For example, in a project where cultural principles are applied, the system 161 may orient the kitchen to the southeast and position the master bedroom in the southwest corner of the building. The AI engine and GAN engine work together to incorporate these traditional guidelines into the modern design framework, creating or modifying a design plan that aligns with both functional and cultural requirements.

Design considerations 166 may include a wide range of compliance standards to be considered for determining if the design plan adheres to various regulations and best practices. These include (but are not limited to):

ADA (Americans with Disabilities Act) compliance, which regulates that buildings are accessible to individuals with disabilities by including features such as wide doorways, ramps, and accessible bathrooms.

Fire safety codes, which regulate the placement of fire exits, stairwells, fire-rated doors, and sprinkler systems to provide safe evacuation routes and fire prevention measures.

Building codes and structural regulations, which govern aspects like wall thickness, ceiling height, and load-bearing capacities to provide structural integrity and safety.

Energy efficiency standards, such as LEED certification, promote sustainable building practices by optimizing insulation, lighting, and HVAC systems to reduce energy consumption.

Occupancy and safety codes, which specify room sizes, ventilation, and egress paths based on the number of occupants to facilitate comfort and safety.

Environmental regulations, which require the use of sustainable materials, renewable energy sources, and minimal environmental impact.

Plumbing and electrical codes, regulating proper installation and safety of plumbing, drainage, and electrical systems.

Cultural or traditional guidelines, such as cultural or stylistic rule sets or guidance parameters, which may be referenced to influence architectural aspect placement and building orientation, based on stylistics or cultural guidelines.

Design considerations 166 may be used in conjunction with user inputs 164 and client requirements 165 to generate and/or modify design plans that meet legal, functional, and aesthetic requests and/or expectations.

The controller 163 may periodically and/or continuously reference one or more of: the user inputs 164, the client requirements 165 and design considerations 166 throughout the design generation or modification process. This allows the system 161 to balance user input with standardized guidelines and personal preferences. For example, a client may request a specific aesthetic, such as modern minimalism, which would be considered alongside design best practices related to space utilization, lighting, and material choices. The system 161 then generates a design plan that satisfies both the client's preferences and the broader architectural principles stored in the design consideration database.

In some embodiments, the system 161 may offer real-time feedback to a user as they input their design preferences. For example, if the user requests to shift a bedroom to the northwest corner of the house, the system 161 may determine whether this aligns with cultural guidelines and suggest an alternative placement if required. The controller 163 can also present visual representations of the modified design plan, allowing users to review and adjust elements dynamically. For example, if a user resizes a room, the system 161 can instantly update the layout on the display screen of the user device 162, showing how the change affects the overall floor plan.

The system's use of GAN engine capabilities further enhances the design process by generating multiple optimized layouts based on the inputs provided. For example, a user may input dimensions and specifications for a house, but the GAN engine generates several layout options that optimize space usage and light exposure. The user can then choose from these options or further modify a suggested design based on additional preferences.

In addition to user-driven design, the system 161 may also incorporate automated optimization based on external factors, such as environmental conditions. For example, if the system 161 is designing a building in a hot climate, it may automatically factor in the need for natural ventilation and shading, suggesting room layouts that minimize sun exposure while maximizing airflow. The AI engine evaluates these environmental factors in conjunction with the client's inputs and preferences, resulting in a balanced, optimized design. In such embodiment, the system 161 may also be fed with location information of the proposed building. In some cases, the system 161 may automatically determine the location of the proposed building, for example, based on GPS of the user devices 162, postal code of the proposed building, or accessed from a database. This location may then be used for determining the environmental factors to be considered in the design plan generation or modification processes.

Furthermore, the system 161 is functional to handle complex design iterations, where multiple layers of input are combined to generate or modify a design plan. For example, in a large-scale commercial project, multiple stakeholders may input design preferences (i.e., collaborative system), such as the building owner requesting a focus on aesthetic appeal, while the architects prioritize space efficiency for workstations. The system 161 seamlessly integrates these varying inputs, cross-referencing them with applicable design considerations and client requirements to produce a cohesive final design plan.

The system 161 can also facilitate design validation through automated checks for compliance with building regulations or industry-specific standards. For example, if a hospital is being designed, the system 161 may apply healthcare facility standards, determining if hallways are wide enough for gurney movement, and operating rooms are properly ventilated and isolated. The controller 163 may access a database (e.g., 166) of regulatory requirements, cross-referencing them with the design considerations to determine if the generated or modified design meets all required criteria.

In some embodiments, the user devices 162 may also include augmented reality (AR) or virtual reality (VR) capabilities, allowing users to visualize the design plan in an immersive environment. For example, a client may use a VR headset to virtually walk through their future building, experiencing the spatial layout and design elements in a highly realistic manner. This immersive interaction provides a deeper level of engagement and allows for more informed design modifications.

Additionally, the system 161 may adapt to iterative feedback. As users continue to input modifications, the controller 163 refines the design plan by learning from previous adjustments, improving the AI engine's capacity to predict user preferences and optimize layouts. For example, if a user repeatedly adjusts room dimensions in favor of larger communal spaces, the system may prioritize similar space allocations in future iterations.

The system 161 may also function as a collaborative system, facilitating real-time interaction between multiple users across different locations. This collaborative capability enables architects, designers, clients, engineers, and other stakeholders to participate in the design generation and modification process simultaneously, making it easier to coordinate and incorporate feedback from all parties involved. Through the user devices 162, each participant can contribute inputs, make annotations, and provide suggestions, which the system 161 processes in real-time through the controller 163 running the AI engine and GAN engine.

For example, an architect in one location can modify the structural layout of a building while a project manager in another location can add budget-related constraints or deadlines. Meanwhile, the client can review the proposed design and provide immediate feedback, such as requesting changes to room sizes or aesthetic features. The system 161 processes all of these inputs collaboratively, integrating them into a unified design plan that reflects the needs and priorities of each stakeholder.

The collaborative nature of the system 161 also enables efficient version control and design iteration. Multiple users can access the design plan simultaneously, and any changes made by one user are immediately visible to the others, so that everyone is working with the most up-to-date version. This real-time collaboration streamlines communication, reduces the risk of misinterpretation, and speeds up the overall design process. Furthermore, the system 161 can store different iterations of the design plan, allowing users to track changes, compare previous versions, and revert to earlier designs if required.

In some embodiments, apart from the user inputs 164, client requirements 165, and design considerations 166, the system 161 may also integrate or consider design annotations into the design plan generation and modification processes. These design annotations, as discussed in FIGS. 1C-1F, may provide additional context and guidance for the system 161, offering detailed notes, symbols, or comments that describe specific elements or sections of the design plan. For example, annotations may highlight structural elements such as load-bearing walls, piping, or electrical conduits, so that the system 161 considers these features when generating or modifying the design. This may particularly be useful in collaborative system where more than one user is working on the same design plan generation or modification process, where annotations added by one user may be considered by the system 161 for generating or modifying the design plan for other users.

In some embodiments, the controller 163 employs its AI engine and GAN engine to automatically generate or modify design plans. GANs, a class of machine learning systems, involve two neural networks, the generator and the discriminator, working together in a competitive process. The generator network creates new design elements, while the discriminator evaluates the authenticity of these elements by distinguishing between generated outputs and actual data (in this case, design elements derived from real architectural plans). Through iterative learning, the generator becomes more skilled at producing realistic and compliant design plans, and the discriminator refines its evaluation criteria, driving the entire system toward optimal design solutions.

### Working of GAN in Design Plan Generation:

In some embodiments, the GAN's generator starts by receiving input parameters from the user, which may include commands such as room dimensions, window placements, or overall building layout preferences. Initially, the generator creates rough spatial configurations and architectural features based on this input, considering variables such as preferred building practices, structural integrity, and environmental conditions stored in a design considerations database.

The GAN's discriminator then steps in to evaluate the generated design plan. It cross-checks the design against various predefined design considerations, including user preferences and regulatory compliance, such as accessibility (e.g., ADA), seismic safety, or energy efficiency. If the discriminator detects issues, like the room configuration leading to insufficient airflow, or non-compliance with structural guidelines, the generator may adjust the design plan accordingly, leading to further refinements. This adversarial process repeats until the discriminator no longer distinguishes between a generated design and a “real” design that fully complies with specified design considerations.

### GAN Techniques in Design Plan Generation:

GANs are a class of machine learning algorithms that include two neural networks: a generator and a discriminator. The generator creates data, such as images or designs, while the discriminator evaluates the quality of the generated data by comparing it to real-world examples. Through this adversarial process, the generator improves its ability to produce outputs that closely resemble the target data. In the context of architectural design, GANs can be trained on a large dataset of design plans, learning patterns and rules that govern building layouts, room configurations, and aesthetic choices. Once trained, the GAN can generate new design plans based on user inputs, providing an automated alternative to the traditional manual design process.

Conditional GANs (cGANs): In some embodiments, the controller may use Conditional GANs, which generate design plans conditioned on user inputs such as text commands, sketches, or floor area constraints. For example, if a user specifies “a 3-bedroom house with an open kitchen,” the generator uses this specific input to structure the design around the requested features. The cGAN facilitates that the output design matches the user's command while maintaining spatial integrity and architectural feasibility.

CycleGANs: Another method the controller may use is CycleGANs, particularly when converting between design styles or layouts. For example, a user may request a traditional layout be converted into a modern, open-floor concept. CycleGANs can translate the structural framework of one style into another while retaining core design elements such as room placements and circulation paths.

Progressive GANs (PGANs): Progressive GANs build the design plan from a low-resolution layout to a high-resolution detailed plan. Initially, a rough outline of the building's layout is generated with basic room shapes and arrangements. As the process iterates, more details are added, such as door placements, window configurations, and structural elements like beams and columns, leading to a comprehensive and detailed architectural design.

GANs generate design plans in an automated manner. By leveraging large datasets of existing designs, GANs learn to create layouts that reflect established patterns and best practices. For example, if a user inputs basic requirements such as “a two-bedroom house with a large kitchen and open living space,” the GAN generates multiple design options that meet those criteria. The automated nature of this process allows for rapid exploration of different design possibilities, enabling users to experiment with various layouts and configurations without needing extensive knowledge of architectural principles. This capability may particularly be useful for individuals or small businesses with limited access to professional design services, as it democratizes the design process by making it accessible to a wider audience.

### Other Machine Learning Techniques:

While GANs form the core of the system's design generation capability, other machine learning techniques are used to refine and optimize the process:

Convolutional Neural Networks (CNNs): The system employs CNNs for image recognition tasks related to sketch-based inputs. When a user sketches a rough floor plan or building layout, the controller interprets these sketches using CNNs. The CNN analyzes the user's drawing, identifies key elements such as walls, doors, and windows, and translates them into digital components of the design plan.

Recurrent Neural Networks (RNNs): The system may use RNNs, especially when dealing with sequential user inputs or verbal commands. For example, if a user provides instructions in a sequence like “Place the window here, shift the door left, and increase room size by 50 square feet,” the RNN processes these inputs in order, retaining memory of earlier commands to make coherent adjustments to the design plan.

Deep Reinforcement Learning (DRL): The controller may also incorporate DRL, where the AI learns through trial and error to improve the design based on feedback loops. The AI evaluates multiple generated designs and selects the most optimal plan based on a reward system tied to design quality, user satisfaction, and compliance with regulations.

### Examples of Design Generation and Modification:

User Commands: A user inputs, “Generate a 2-bedroom apartment with a balcony and optimize natural light flow.” The generator creates a floor plan with two bedrooms and a balcony, positioning windows to maximize light intake based on the building's orientation and geographic location. The discriminator evaluates whether the generated plan complies with preferred building practices regarding lighting, and if issues arise (e.g., insufficient light in one room), the generator iterates to adjust window sizes and placements until the desired optimization is achieved.

Modification Request: The user requests, “Expand the kitchen by 30 square feet and place an island in the center.” The system analyzes the current design, reallocates space by slightly reducing adjacent rooms, and places the island in the center while maintaining circulation flow and aesthetic balance. If the expansion creates spatial issues (such as conflicting with other rooms), the discriminator flags the conflict, prompting further adjustments.

Structural Modifications: In another example, a user asks to modify structural elements, saying, “Add two more support columns in the living room to comply with hurricane or earthquake safety guidelines.” The controller may activate its AI engine to analyze the building's seismic requirements, identifies optimal column placements, and adjusts the room layout accordingly to maintain both structural integrity and aesthetic appeal.

Context-Driven Design Adjustments: If a user sketches a basic layout and requests the system to “Make it compliant with preferred building practices or a set of preferred principles,” the system may use its design considerations database to assess the sketch for potential conflicts. The controller may be operative to analyze a spatial configuration of walls, doorways, and other elements, adjusting them to meet regulatory guidelines, such as minimum door widths for accessibility or proper ventilation placement.

Employing its GAN capabilities and/or other machine learning techniques, the controller in this embodiment facilitates a highly flexible, adaptive, and interactive design process. It can cater to both broad user requests and detailed commands, facilitating that the generated or modified design plan aligns with both user intent and compliance requirements, all while optimizing aesthetic and functional aspects of the building.

Referring now to FIG. 1H, an exemplary design plan generation and modification process in accordance with the present invention, is illustrated. The system 161, as described in FIG. 1G, facilitates the creation of detailed architectural design plans by providing a user interface on user devices 162, through which users can hand-draw or sketch out a preliminary design layout 167. The design layout 167 can be broadly defined by the user, indicating various spaces or areas, which are processed and interpreted by the system's controller 163 running both the AI engine and the GAN engine.

In FIG. 1H, the hand-drawn design layout 167 contains various spaces labeled 168A-168K, which the user can loosely define without needing to worry about precise technical details. For example, the user may sketch a rough floor plan outlining large sections such as a living room, dining room, bathrooms, and/or an office. The controller 163 processes this sketched input, interpreting these areas based on factors like relative size, proximity to other areas, and common spatial configurations. The AI engine identifies patterns and relationships between the areas, making educated assumptions about the intended functions of each space.

For example, based on the proximity of area 168G to area 168H, the controller 163 may interpret 168G as a dining room and 168H as the adjacent kitchen. This inference may be supported by the relationship between these areas, as kitchens and dining rooms are often placed near one another for ease of food preparation and serving. Similarly, the controller 163 may interpret that areas 168I and 168J together represent a bathroom, with 168I serving as the shower area and 168J as the water closet.

The controller 163 further analyzes the drawn areas to determine the types of spaces represented by other sections. For example, based on the dimensions and placement of area 168K, it may be identified as a hanging balcony connected to an adjacent room or bathroom. Office spaces can also be inferred if areas 168A-168F are larger open areas that are frequently associated with workstations and collaborative spaces. By using the AI engine to analyze the size, shape, and arrangement of these hand-drawn areas, the controller 163 is able to assign logical functions to each space without requiring the user to input detailed specifications.

Once the controller 163 has interpreted the general layout, the system's GAN engine generates a fully realized detailed design plan 169, automatically filling in details based on the initial interpretation. For example, in the dining room 168G, the controller 163 can add seating arrangements, tables, and lighting fixtures appropriate for a dining area. In the kitchen 168H, the GAN engine can generate realistic placements for kitchen appliances such as a refrigerator, stove, and sink, optimizing the workflow and providing easy access between cooking and prep areas. The generated design plan 169 may also include cabinetry, countertops, and islands, aligning with modern kitchen layouts.

In the bathroom spaces 168I and 168J, the detailed design plan 169 may include plumbing fixtures such as a showerhead, bathtub, toilet, and sink, with appropriate distances between them to meet spatial and functional requirements (e.g., based on design considerations 166 as discussed in FIG. 1G). Additionally, the controller 163 may incorporate suggestions for lighting and ventilation in these spaces, so that the bathroom is practical for everyday use. The AI engine cross-references the interpreted areas with design standards, such as leaving sufficient space for movement and facilitating that all fixtures are easily accessible.

For office spaces or workstations, the controller 163 may generate seating arrangements, desks, and collaborative spaces based on the layout provided in 168A-168F. For example, if 168A is interpreted as a large open workspace, the GAN engine can automatically arrange desks and chairs to maximize both space efficiency and workflow productivity. It may also add elements like whiteboards or partitions if the user's sketch suggests an area for meetings or presentations. The controller 163 can also determine the optimal placement of shared resources, such as printers or conference rooms, based on the typical layout of office environments.

The controller 163 also adds details like plumbing fixtures, lighting fixtures, furniture, and appliances to the generated design plan 169. In the kitchen, for example, the controller 163 may add the most efficient placement of appliances based on the room's configuration, such as placing the stove near the sink for easy cooking prep. For office spaces, the controller 163 can incorporate modular furniture that allows for flexibility in workspace arrangements, based on the needs of the occupants.

In some embodiments, the controller 163 may also generate lighting designs that optimize natural and artificial light in each area. For example, the controller 163 may recommend or create the placement of windows in 168F to maximize natural daylight in a living room space, or add pendant lighting above a kitchen island in area 168H to provide task-specific illumination. For larger office spaces, the controller 163 may include overhead lighting fixtures that evenly distribute light across workstations, providing adequate illumination for all employees.

Additionally, the controller 163 may generate suggestions for appliances and fixtures that align with modern, efficient design. For example, in a bathroom space 168I-168J, the controller 163 may recommend or place water-efficient faucets and toilets, or heated flooring options to enhance comfort. In the kitchen 168H, it may suggest energy-efficient appliances that reduce power consumption while maintaining functionality, such as an induction stove or a low-energy refrigerator.

Furthermore, the controller 163 also provides the option for the user to interact with these elements through the user interface (e.g., 125 in FIG. 1B), enabling the user to modify or customize the design further after the initial generation. For example, if the user prefers a different type of lighting in the dining room or wishes to rearrange the seating in the living room, they can easily make these adjustments, which the controller 163 then recalibrates and regenerates into the updated design plan 169.

By processing the hand-drawn layout 167 and converting it into a highly detailed and functional design plan 169, the controller 163 streamlines the design process, making it more accessible for users who may not have advanced technical drawing skills. Through the integration of the AI engine and GAN engine, the controller 163 can interpret broad design ideas and transform them into sophisticated, detailed plans that include everything from the placement of furniture to the installation of plumbing and electrical systems.

This ability to automatically generate detailed design plans from basic sketches or inputs not only reduces the time and effort required to produce architectural designs but also enables a higher level of customization and precision, all while adhering to practical and aesthetic considerations for each area. The system's flexibility allows for wide application across residential, commercial, and office spaces, making it a powerful tool for both professional designers and clients looking to create or modify spaces according to their specific needs and preferences.

In some embodiments of the present invention, the design layout 167 may also be a two-dimensional reference 121 (shown in FIG. 1B), such as a traditional design plan or architectural drawing, which can be input into the controller 163 for further modification. The two-dimensional reference 121 may be a scanned or digitized version of a hand-drawn floor plan, a CAD (Computer-Aided Design) file, or a blueprint in electronic format, such as DWG, DXF, or PDF. With a two-dimensional reference 121 received by the controller 163, the system 161 may process the two-dimensional reference 121 using one or more of logic, Boolean operation, an AI engine and a GAN engine to interpret structural elements and spaces depicted in the two-dimensional reference 121.

The user can provide inputs 164 through the user device 162 to modify specific elements of the two-dimensional reference 121. For example, a user may request to resize a room, shift a wall, add new rooms, or change the position of windows and doors. In this case, the system 161 processes these inputs and automatically updates the design layout 167 based on the modifications. For example, if the user inputs a request to increase the size of a kitchen, the system 161 will automatically adjust the surrounding spaces to accommodate the change, so that the design remains functional and balanced.

Alternatively, the controller 163 may autonomously modify the two-dimensional reference 121 (167) based on pre-determined design considerations or client requirements 165. For example, if the system 161 detects that certain spaces do not meet ergonomic or accessibility standards (such as insufficient space between kitchen counters), it can automatically adjust these areas to meet the required guidelines. In another scenario, the system 161 may optimize the design based on energy efficiency by adjusting the placement of windows to maximize natural light.

In some embodiments, the invention enables remote collaboration between multiple users, allowing each user to interact with the design plan (e.g., the design layout 167) and contribute through annotations (as discussed in FIGS. 1C-1D). These annotations may include textual comments, graphical symbols, multimedia files, or detailed notes relating to specific design elements, such as rooms, windows, doors, or structural components. For example, one user may provide feedback on the layout of a room by attaching a multimedia file or adding a graphical symbol to highlight required changes, while another user may leave a textual note suggesting modifications to window placements for better natural lighting.

The system's controller (163) may receive these annotations and automatically evaluate their impact on the overall design plan. Before incorporating any changes, the controller may consider factors such as spatial configurations, compliance with design considerations, and any user-defined design preferences. Once the evaluation is complete, the controller can generate an updated design plan (e.g., 169) that integrates the annotations from multiple users, providing a streamlined, collaborative process where input from all stakeholders is considered and effectively incorporated into the final design.

Referring now to FIG. 1I, an exemplary design plan generation and modification system 170 is illustrated in accordance with some implementations of the present invention. The system 170 demonstrates how a user can input design commands via an interactive user interface 171, which processes those inputs through the controller 163, running an AI engine and GAN engine, to generate a detailed design plan 173. The user interface 171 provides an intuitive platform for users to input commands 172, such as specific architectural or layout instructions, which the system 170 uses to create the design in real-time.

The user commands 172 in this example include specific design requests (may be through a microphone for verbal commands), such as creating a 3BHK first-floor design plan, specifying door sizes of 30″×72″, indicating that all doors should be inward-opening, and placing the master bedroom with an attached washroom while generating a kitchen near the main door. These inputs are entered directly into the user interface 171, which may be displayed on a user device (162) such as a tablet, laptop, or desktop computer. The system 170 processes these inputs using the controller 163 and may then cross-reference them with client requirements (165) and design considerations (166) to generate the most optimized and compliant layout.

After processing the user commands 172, the controller 163 produces a detailed design plan 173 that fulfills the provided instructions. For example, the 3BHK design requested by the user results in the generation of three bedrooms—174A, 174B, and 174C—with one of these, 174A, designated as the master bedroom. The controller 163 places an attached washroom 175 adjacent to this master bedroom 174A, so that it meets the specific requirement for a private bathroom. This process highlights the precision with which the controller 163 interprets user commands 172 and translates them into architectural details.

The system 170 also addresses the user's specific instructions regarding door sizes and placements. It generates all the doors 176A-176C in the layout 173 according to the specified dimensions of 30″×72″, providing uniformity across the design. Additionally, the system 170 configures each door to open inward, as per the user's request. This level of customization allows for highly specific architectural details to be integrated into the design plan 173, all processed seamlessly by the AI-driven controller 163.

Another instruction provided by the user was to place the kitchen 177 near the main door 176C of the design plan 173. In response, the system 170 places the kitchen 177 adjacent to the main door 176C, optimizing the layout for ease of access and functional flow. In this embodiment, the AI engine may consider additional factors, such as space utilization, ergonomic design, and proximity to other important rooms (such as the dining area). For example, a dining space 179 may be positioned or generated close to the kitchen 177, providing efficient movement between these two commonly connected areas.

The controller 163 may also address the lack of specific instructions regarding the other bedrooms 174B and 174C, where the user did not request attached washrooms. In this case, the system 170 may autonomously generates a common washroom 178 accessible from these two bedrooms, demonstrating the system's ability to make practical design decisions based on incomplete inputs. This feature facilitates that the generated design plan 173 is both functional and adheres to general best practices even when the user provides limited or ambiguous instructions.

Further detailing may also be generated by the system 170, such as the addition of beds in each bedroom 174A-174C. The AI engine interprets these spaces as residential sleeping areas and incorporates appropriate furnishings into the design. In the washrooms, such as 175 and 178, the system 170 may generate required plumbing fixtures, including water closets, sinks, and potentially showers or bathtubs, depending on the room's size and layout.

The system 170 may also add features to the dining space 179, such as a dining table and chairs, facilitating that the dining space 179 is not only functional but also aesthetically acceptable to a user. This automated detailing extends to other areas of the design, such as adding kitchen appliances (e.g., refrigerator, stove, and cabinets) in the kitchen 177. The system 170 automatically places these items based on standard ergonomic guidelines and space optimization techniques, thereby enhancing both the functionality and practicality of the design.

In some embodiments, the system 170 can handle even more complex user inputs. For example, if the user wanted to add a balcony or request a home office space within the layout, these inputs would be processed and incorporated by the controller 163. The AI engine may generate a study nook within the existing space or expand the floor plan to include a small office connected to one of the bedrooms 174A-174C, depending on the user's preferences and the available space in the design.

Moreover, the controller 163 can modify the design plan 173 further based on real-time feedback from the user. For example, if the user wishes to adjust the size of the master bedroom 174A after reviewing the initial design, they may input new dimensions into the user interface 171. The system 170 processes this input and automatically updates the floor plan 173, shifting adjacent rooms and features as needed to accommodate the change. This real-time interaction enables dynamic design adjustments and allows the user to remain in full control of the design process.

The system's ability to handle multiple user inputs simultaneously means that multiple stakeholders, such as architects, interior designers, and clients, can collaboratively modify the design in real-time. For example, a client may focus on the aesthetic layout, while the architect may modify the structural elements. The controller 163 may process and integrate these inputs harmoniously, producing a final design that reflects the combined efforts of all parties involved.

In some embodiments of the present invention, a user may first input an initial design plan 167A, which can be a rough or basic floor layout, and then provide additional commands 172 to further modify the design 167A. These commands 172 may be provided in written, verbal, or gestural formats, allowing for flexible interaction between the user and the system 170. The controller 163, running the AI engine and GAN engine, processes these inputs and adjusts the design plan 167A to generate a more refined and detailed design plan 173.

For example, the user may begin by inputting a simple design plan 167A, which includes large open areas, but lacks specific details like room dimensions or the placement of fixtures. Once this basic layout is in place, the user can begin providing commands 172 to modify the design. These commands may be written, such as typing “resize the bedrooms to 15 feet by 20 feet” or “add two windows on the north wall of the living room.” The system 170 processes these written commands and updates the design plan 167A accordingly, resizing rooms, placing windows, and adjusting the layout in real time. The modified design is then output as the updated detailed design plan 173, with all changes integrated into the architecture.

In some embodiments, user inputs or commands (e.g., 164 or 172) to the system may be specific, allowing for highly personalized modifications to the design plan. For example, a user may issue commands such as, “I need the window 5 feet to the right,” prompting the system to adjust the window placement accordingly in the design plan, while facilitating that other elements like walls or structural integrity are maintained. The user may also specify dimensional requirements like, “The door should be 30 inches wide,” guiding the system to incorporate the specified door dimensions. Additionally, more complex commands could include functional considerations like, “Swing the door inside, check for collision with the water closet,” prompting the system to evaluate the potential interaction between the door's movement and nearby fixtures like the water closet, automatically adjusting the layout if required to avoid conflicts.

More expansive user inputs can relate to spatial modifications, such as “Increase the size of the kitchen by 20 square feet,” where the system would intelligently reconfigure surrounding spaces to accommodate the larger kitchen.

For more comprehensive inputs, a user may provide instructions regarding an entire floor plan. For example, the user may state, “I have a plot of 2000 square feet, and I need a floor plan for a 3-storey building.” In response, the system could generate the design plan for each floor based on the user's specific requirements:

For the 1st floor, the user may request “2 rooms with attached bathrooms, two windows in each room, a kitchen, a drawing room, and an office space,” which the system interprets by configuring the layout and positioning the rooms, facilitating that the windows and bathrooms meet the specifications provided.

For the 2nd floor, the user may input “5 rooms and a lobby,” and the system generates the floor plan with an appropriate number of rooms and central lobby space, adjusting dimensions and configurations as needed to balance spatial efficiency.

For the 3rd floor, a more intricate command may include “4 rooms and a balcony with entrance from two rooms, a shared balcony,” leading the system to design the shared balcony with access from two adjacent rooms, integrating the balcony into the floor plan seamlessly.

These inputs allow the system, with its AI and GAN engines, to generate dynamic design plans that adapt to specific user commands while considering spatial configurations, design elements, and architectural integrity. The system can also check compliance with local preferred building practices, assess potential design conflicts, and provide suggestions for optimizing the layout based on predefined design considerations.

Referring now to FIG. 1J, an exemplary system 180 may interact with a user to better understand the context of design plan generation and modification processes in accordance with the present invention. The system 180 facilitates interaction between the user and the controller 163 to refine and clarify the design plan based on user input. The user may initially provide a design plan 167B, which can either be a pre-existing two-dimensional reference or a hand-drawn sketch. This initial input may serve as a starting point for generating or modifying a detailed architectural design plan.

Once the design plan 167B is input into the controller 163, the user may provide additional commands 172 through an interactive user interface 171. The commands 172 may include instructions such as “Make a design plan for the ground floor with a garage including a garden area,” or specific requirements like “Make the design plan cultural compliant,” as shown in the interactive user interface 171. These commands 172 may guide the controller 163 in either generating a new design plan based on design plan 167B or modifying the existing design plan 167B according to the user's preferences.

Upon receiving the commands 172 and the initial design plan 167B, the controller 163 may need further clarification to generate an optimal design. In some cases, the controller 163 may present a pop-up window 181 with a series of questions 181A-181C to better understand the user's requirements. For example, the controller 163 may ask questions like 181A “Mention area measurement”, 181B “How many cars do you want to keep in the garage?” and 181C “Mention the facing of the house, e.g., east-facing?”. These questions may help the controller 163 gather the specific details required to create a well-defined and accurate design plan.

The user can then respond to these questions through the interface 171. For example, if the user responds to question 181B that they wish to keep two cars in the garage, the controller 163 processes this response and generates a garage 183 with enough space to accommodate two cars. This adjustment is reflected in the detailed design plan 182, which the controller 163 generates based on the user's preferences and the input provided in response to the system's queries.

Similarly, if the user provides an area measurement in response to question 181A, the controller 163 will incorporate this information to scale the design plan appropriately. This may include adjusting the size of rooms, garden spaces, or other areas to match the specified dimensions. For example, if the user specifies a 2,000 square foot area, the controller 163 will allocate space accordingly across various sections of the design, such as the garden area 184 and living spaces.

In the case of question 181C, where the controller asks for the orientation of the house, the user may respond with a preference, such as “east-facing.” The controller 163 may then factor this information into the design plan 182, so that the layout, placement of windows, entrances, and other architectural features align with this orientation. This may particularly be important for users adhering to cultural principles, which dictate specific orientations for various parts of the house.

The controller 163 processes all of these inputs and generates a detailed design plan 182, which includes specific architectural and functional details. For example, the garage 183 is sized to fit two cars based on the user's input, and the garden area 184 is created as per the command (172) provided by the user. Additionally, the controller 163 may automatically add other elements, such as a driveway leading to the garage 183 or pathways through the garden 184, enhancing the functionality and aesthetics of the overall design 182.

Other commands 172 may include specifying the number of rooms, types of materials to be used, or preferences regarding room sizes and layouts. For example, a user may input, “Add a guest bedroom with an attached bathroom,” and the controller 163 will update the design 182 to include this feature. Additionally, if the user specifies a preference for certain materials or finishes (e.g., marble flooring in the living room or wooden cabinets in the kitchen), the controller 163 can incorporate these details into the detailed design plan 182.

Furthermore, the controller 163 may also make suggestions based on the provided input and design constraints. For example, if the user selects a small plot size but requests both a large garden and a spacious garage, the controller 163 may recommend reducing the size of the garden 184 or garage 183 to maintain an efficient use of space. The user can accept or decline these recommendations, further interacting with the system 180 to refine the design 182 until it meets their expectations.

The system's ability to interact with the user, ask clarifying questions like 181A-181C, and process responses in real time enables a highly customized and user-friendly design experience. The resulting detailed design plan 182 is a product of continuous interaction, adjusting the layout based on both user input and the system's intelligent processing capabilities. This method allows for the seamless integration of user preferences, compliance requirements (such as cultural principles), and architectural best practices into a final, functional design.

In some embodiments of the present invention, the system 180 may be configured to provide subsequent questions throughout the design generation or modification process to further refine and enhance the final design plan. This interactive process allows the system 180 to engage with the user at multiple stages, seeking clarifications or additional inputs when required. The user, in turn, can respond by providing subsequent commands, so that the design evolves according to their preferences and requirements.

For example, after receiving initial input from the user, such as the size and location of specific rooms, the system 180 may generate follow-up questions. These questions may be related to details like the placement of windows, door orientations, material preferences, or even the layout of outdoor spaces such as gardens or patios. For example, the system may ask, “Would you like the living room to have an east-facing window for more natural light?” or “Do you prefer the garage to have a side entrance?” The user can respond with commands or specific instructions, which the system 180 processes to update the design plan 182 accordingly.

The number of questions and commands exchanged during the process may vary depending on the complexity of the design and the user's requirements. For simpler designs, fewer interactions may be needed, whereas more intricate layouts may require additional inputs and refinements. These questions and commands are merely exemplary, as the system 180 can dynamically adapt to the needs of each project and continue interacting with the user until a satisfactory design is achieved.

In the various figures, some of reference numbers are repeatedly used to represent corresponding components and elements across different embodiments to maintain consistency and clarity in the description of the invention. This approach allows for easier understanding and cross-referencing, as the reader can quickly identify recurring elements, such as the controller 163, user inputs 164, or design plan 167, which appear in multiple figures with the same functionality or purpose. By using consistent reference numbers, the description may have a quality check to ascertain that there is no confusion about a role of respective elements as they are depicted in different contexts or stages of the design process. Additionally, the use of uniform reference numbers facilitates efficient navigation through the patent document, helping the reader track the relationships and interactions between elements as they evolve through various embodiments and processes.

Referring now to FIG. 2A, a given two-dimensional reference 200 may have a number of elements that an observer and/or an AI engine may classify as features 201-209 such as, for example, one or more of: exterior walls 201; interior walls 202; doorways 204; windows 203; plumbing components, such as sinks 205, toilets 206, showers 207, water closets or other water or gas related items; kitchen counters 209 and the like. The two-dimensional references 200 may also include narrative or text 208 of various kinds throughout the two-dimensional references.

Identification and characterization of various features 201-209 and/or text may be included in the input two-dimensional references. Generation of values for variables included in generating a bid may be facilitated by splitting features into groups called ‘disparate features’ 201-209 and boundary definitions and generation of a numerical value associated with the features, wherein numerical values may include one or more of: a quantity of a particular type of feature; size parameters associated with features, such as the square area of a wall or floor; complexity of features (e.g. a number of angles or curves included in a perimeter of an area; a type of hardware that may be used to construct a portion of a building, a quantity of a type of hardware that may be used to construct a portion of the building; or other variable value.

In some embodiments, a recognition step may function to replace or ignore a feature. For example, for a task goal of the result shown in FIG. 2B, features such as windows 203, and doorways, 204, may be recognized and replaced with other features consistent with exterior walls 201 or interior walls 202 (as shown in FIG. 2A). Other features may be removed, such as the text 208, the plumbing features and other internal appliances and furniture which may be shown on drawings used as input to the processing. Again, such feature recognition may be useful to accomplish other goals, but for a goal of boundary 211 definition that delineates a floorplan 210 as illustrated in FIG. 2B a pictorial representation may be purposefully devoid of such features, as illustrated.

Referring now to FIG. 2B, a boundary 211 is illustrated around a grouping of defined spaces 213-216. Spaces are areas within a boundary (which may include but are not limited to rooms, hallways, stairwells etc.).

FIG. 2B illustrates an AI predicted boundary 211 based upon an analysis of the floorplan 210 illustrated in FIG. 2A. A transition from FIG. 2A to FIG. 2B illustrates how an AI engine successfully distinguishes between wall features and other features such as a shower 207, kitchen counter 209, toilet 206, bathroom sink 205, etc. shown in FIG. 2A.

In another aspect, in some embodiments, a boundary may include a polygon 211B. A polygon may be any shape that is consistent with a design submitted for AI analysis. For example, a rectangular polygon 211B may be based upon a wall segment 211A and have a width X 218 and a length Y 219. Boundaries that include polygons are useful, for example, in creating a three-dimensional representation of a design plan.

According to the present invention, a boundary may be represented on a user interface as one or both of: one or more line segments, and one or more polygons. In addition, a feature may be represented as a single point, a polygon, an icon, or a set of polygons. In some embodiments, a point may be placed in a centroid position for the feature and the centroid points may be counted, summarized, subtracted, averaged, or otherwise included in mathematical processes.

In some embodiments, an analytical use for a boundary may influence how a boundary is represented. For example, determination of a length of a wall section, or size of a feature may be supported via a boundary that includes a line segment. A count of feature type may be supported with a boundary that includes a single point or predefined polygon or set of polygons. Extrapolation of a two-dimensional reference into a three-dimensional representation may be supported with a boundary that includes polygons.

In one embodiment of the present invention, the AI engine is adept at analyzing a static representation of a floor plan to identify and generate a selectable array of editable components, such as walls, doors, and fixtures. These dynamic elements are then presented in an interactive user interface, where users can effortlessly select specific design elements to add annotations or to modify those elements directly. For example, a user can choose a window on the digital floor plan and opt to change its dimensions, or select a wall to annotate with instructions for material specifications. The AI's analytical prowess facilitates that these selections and subsequent modifications are intelligently integrated within the overall design framework, enabling a fluid and intuitive design alteration experience that supports real-time collaboration and planning accuracy.

A scale 217 may be used to indicate a size of features included in a technical drawing included in the two-dimensional reference. As indicated above, executable software may be operative with a controller to count pixels on an image and apply a scale to a bitmapped image. Alternatively, a user may input a drawing scale for a particular image, drawing or other two-dimensional reference. Typical units referenced in a scale include inches: feet, centimeters: meters, or any other appropriate unit.

In some embodiments, a scale 217 may be determined by manually measuring a room, a component, or other empirical basis for assessing a relative size. Examples therefore include a scale included as a printed parameter on two-dimensional reference or obtained from dimensioned features in the drawing. For example, if it is known that a particular wall is thirty feet in length, a scale may be based upon a length of the wall in a particular rendition of the two-dimensional reference and proportioned according to that length.

Referring now to FIG. 2C, a user interface 220 is illustrated with multiple regions 221-224. The multiple regions 221-224 may be presented via different hatch representations or other distinguishing pattern (in some embodiments regions may also be represented as various colors etc.). During training of AI engines, and in some embodiments, when a submitted design drawing includes highly customized or unique features, a user may wish to adjust an automated identification of boundaries and automated filling of space within the boundaries.

During training of processes executed by a controller, such as those included in an AI engine made operative by the controller, and in some embodiments, when a submitted design drawing includes highly customized or unique features, an automated identification of boundaries and automated filling of space within the boundaries may be included in the interactive user interface may not be according to a particular need of a user. Therefore, in some embodiments of the present invention, an interactive user interface may be generated that presents a user with a display of one or more boundaries and pattern or color filled areas arranged as a reproduction of a two-dimensional reference input into the AI engine.

In some embodiments, the controller may generate a user interface 220 that includes indications of assigned vertices and boundaries, and one or more filled areas or regions with user changeable editing features to allow the user to modify the vertices and boundaries. For example, the user interface may enable a user to transition an element such as a vertex to a different location, change an arc of a curve, move a boundary, or change an aspect of polylines, polygons, arcs, circles, ellipses, splines, NURBS or predefined subsets of the interface. The user can thereby “correct” an assignment error made by the AI engine, or simply rearrange aspects included in the interface for a particular purpose or liking.

In some embodiments, modifications and/or corrections of this type can be documented and included in training datasets of the AI model, also in processes described in later portions of the specification.

Discrete regions may be regions associated with an estimation function. A region that is contained within a defined wall feature may be treated in different ways such as ignoring all areas within a boundary, to counting all areas within a boundary (even though regions do not include boundaries). If the AI engine counts the area, it may also make an automated decision on how to allocate the region to an adjacent region or regions that the region defines.

Referring to FIG. 2D, an exemplary user interface 230 illustrates a user interface floorplan model 231 with boundaries 236-237 between adjacent regions 233-234 with interior boundaries 236-237 that may be included in an appropriate region of a dynamic component. The AI may incorporate a hierarchy where some types of regions may be dominant over others, as described in more detail in later sections. Regions with similar dominance ranks may share space, or regions with higher dominance ranks may be automatically assigned to a boundary. In general, a dominance ranking schema will result in an area being allocated to the space with the higher dominance rank. In some embodiments, a dominance rank will allocate an area that may be used in determining an occupancy load. Moreover, in those embodiments that analyze a dynamic file (such as, for example, a Revit® compatible file) a dominance rank may be included, or added to, one or more dynamic features and be modified as the dynamic feature is modified. In some embodiments, the incorporation of a dominance rank may be instrumental in delivering automated suggestions for the revision of design plans. The dominance rank may serve as a strategic guide, steering the focus towards regions (or design elements) of higher dominance rank.

For example, regions with a higher dominance rank may be recommended to remain as unchanged or slightly changed in the suggested revisions in addition to making sure that revised designs of the regions are according to a set of practices and/or guidelines. An annotation process related to the selected design elements or dynamic components may be presented based on the dominance rank of regions, dynamic components representing the regions, and the selected design elements on the design plans. This approach scrutinizes the annotations added to the regions or design elements with a higher dominance rank on the overall design, facilitating that modifications align with both regulatory requirements and the foundational elements that contribute significantly to the design's integrity.

In some embodiments, an area 235A between interior boundaries 236-237 and an exterior boundary 235 may be fully assigned to an adjacent region 232-234. An area 235A between interior boundaries 236-237 may be divided between adjacent regions 232-234 to the interior boundaries 236-237. In some embodiments, an area 235A between boundaries 236-237 may be allocated equally, or it may be allocated based upon a dominance scheme where one type of area is parametrically assessed as dominant based upon parameters such as its area, its perimeter, its exterior perimeter, its interior perimeter, and the like. Parameters may also be based upon items that are automatically counted using AI analysis of pixel patterns that identify a pattern as an item, such as, by way of non-limiting example, one or more of: doors or other paths of egress; plumbing fixtures; fixed obstacles; stairs; inclines; and declines.

In some examples, a boundary 235-237 and associated area 235A may be allocated to a region 232-234 according to an allocation schema, such as, for example, an area dominance hierarchy, to prioritize a kitchen over a bathroom, or a larger space over a smaller space. In some embodiments, user selectable parameters (e.g., a bathroom having parameters such as two showers and two sinks may be more dominant over a kitchen having parameters of a single sink with no dishwasher). These parameters may be used to determine boundary and/or area dominance. A resulting computed floorplan model may include a designation of an area associated with a region as illustrated in FIG. 2D. In various embodiments, different calculated features are included in a user interface floorplan model 231 such as features representing aspects of a wall, such as, for example, center lines, the extent of the walls, zones where doors open and the like, and these features may be displayed in selected circumstances.

Some embodiments may also include AI analysis of a dynamic file, such as a Revit or Revit compatible file and/or a raster file with patterns of dots, the AI may generate a likelihood that a region or area represented by one or both of a polygon or pattern of dots, includes a common path or dead end or an area definable for determining an occupancy load, egress capacity, travel distance and/or other factor that may influence annotation process as discussed above for FIG. 1A.

Once boundaries have been defined a variety of calculations may be made by the system. A controller may be operative to perform method steps resulting in calculation of a variable representative of a floorplan area, which in some embodiments may be performed by integrating areas between different line features that define the regions.

Alternatively, or in addition to method steps operative to calculate a value for a variable representative of an area, a controller may be operative to generate a value for element lengths, which values may also be calculated. For example, if ceiling heights are measured, presented in drawings, or otherwise determined, then volume for the room and surface area calculations for the walls may be made. There may be numerous dimensional calculations that may be made based on the different types of model output and the user-inputted calibration factors and other parameters entered by the user.

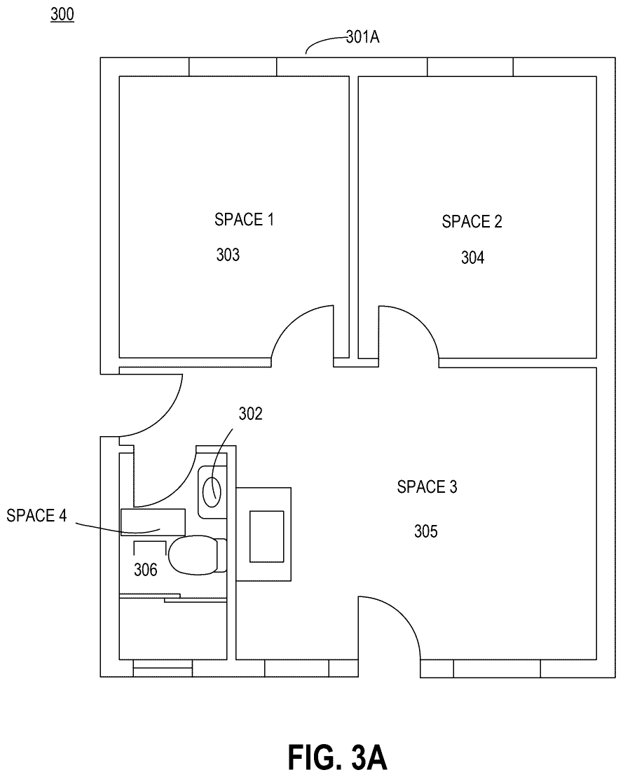

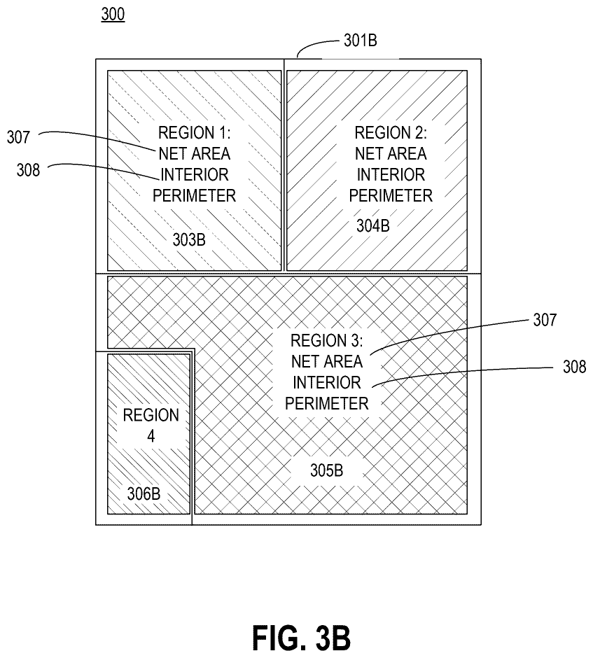

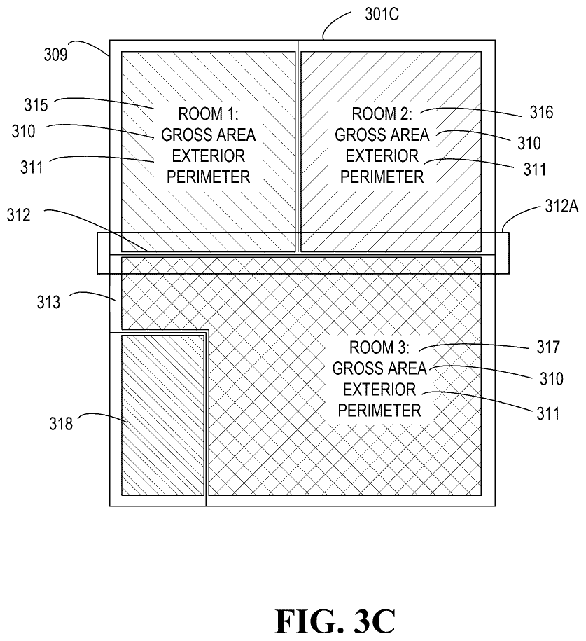

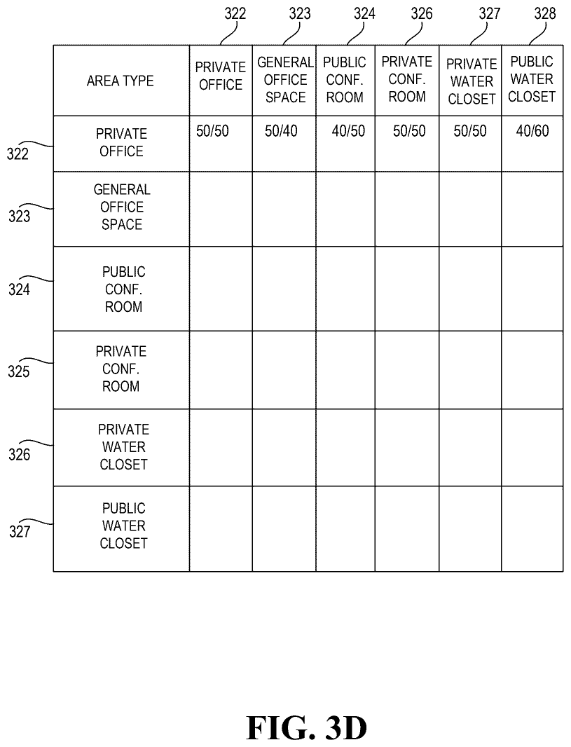

In some embodiments, the system employs a method for generating or modifying a design plan based on the concept of dominance and boundary areas (as described in FIG. 2D, and FIGS. 3A-3D). The process begins with the controller receiving a design plan, which can be a two-dimensional representation of a portion of a building. This design plan includes various spatial configurations, such as rooms, corridors, doors, windows, or other architectural features.

The controller, using its AI engine and GAN engine, analyzes the received design plan to determine the dominant elements within the spatial configuration. Dominance refers to certain design elements that hold significant importance in the layout, such as larger rooms, key structural components, or frequently accessed areas that influence other design aspects of the building. For example, a dominant element like a living room or a master bedroom may dictate the surrounding space allocations, circulation areas, or adjacency to other rooms like kitchens or bathrooms.

In such embodiments, the AI engine identifies the boundary areas of each design element within the design plan. A boundary area refers to the virtual or physical space around each element, which may influence its relationship with adjacent elements. The controller evaluates the boundary areas and calculates the available space for expansion, contraction, or modification of each element based on the user's commands or specific design considerations.

For example, if a user inputs a command like “Increase the size of the living room by 50 square feet,” the system may first analyze the dominance of the living room in the current layout. It then assesses the available boundary area around the living room to determine how much space can be added without negatively affecting adjacent rooms or pathways. The controller automatically shifts or adjusts the positions of neighboring rooms and elements, such as corridors, to accommodate the user's request. If there is insufficient space, the system may prompt the user to consider other areas where space can be redistributed or to merge rooms.

The GAN engine, in this context, is responsible for predicting and generating new boundary areas and spatial layouts based on learned patterns from previously trained data sets. It can generate multiple variations of how the design plan can evolve, keeping the dominant elements and boundary areas in mind. For example, if increasing the living room size reduces the boundary area of a corridor, the GAN engine may suggest widening the corridor by modifying the adjacent rooms or relocating elements like doors or windows.

In another scenario, the system may be tasked with modifying a bathroom's boundary area to fit additional fixtures like a shower or a bathtub. Here, the AI engine may assess the dominance of the water closet and sink areas, so that important elements like accessibility and user movement within the space are maintained. The boundary area around these fixtures would be evaluated, and the system may automatically propose a modified layout, balancing the user inputs with predefined design considerations.

In some embodiments, a controller may be provided with two-dimensional references that include a series of architectural drawings with disparate drawings representing different elevations within a structure. A three-dimensional model may be effectively built based upon a sequenced stacking of the disparate drawings representing different levels of elevations. In other examples, the series of drawings may include cross-sectional representation as well as elevation representation. A cross-section drawing, for example, may be used to infer a common three-dimensional nature that can be attributed to the features, boundaries and areas that are extracted by the processes discussed herein. Elevation drawings may also present a structure in a three-dimensional perspective. Feature recognition processes may also be used to create three-dimensional model aspects.

Referring now to FIG. 2E, it illustrates another exemplary process of design plan generation and modification in accordance with the present invention. The design plan 241A is initially provided as input into the controller 163 for further modification. The design plan 241A includes key spaces, such as a bedroom 246, a dining room 247, and a living area 248. The user interacts with the system through a user interface 171, providing commands 172 to make adjustments to the design plan 241A.

For example, the user may issue commands 172 such as, “1. Move Sofa 242 from the dining room 247 to the living area 248,” and “2. The washroom 245 along with the main entry door 249 should be repositioned according to cultural principles.” These commands are processed by the controller 163, which modifies the design plan 241A to reflect these changes. In response, the controller 163 generates a modified design plan 241B, wherein the sofa 242 is relocated from the dining room 247 to the living area 248, enhancing the space configuration and separating the dining and seating areas more clearly.

In addition to moving the sofa 242, the controller 163 addresses the second command by analyzing the location of the washroom 245 and the main entry door 249. The controller 163 modifies these elements according to cultural principles, which may involve shifting the washroom 245 to a new position and reorienting the main entry door 249 for better alignment with the user's cultural or spiritual preferences. In the new design plan 241B, the washroom 245 is now attached to the bedroom 246, converting it into a master bedroom with an en-suite bathroom, creating a more private and practical layout for the residents.

Beyond executing specific user commands, the controller 163 also analyzes other aspects of the design plan 241A to identify potential design flaws or areas for improvement. For example, the controller 163 may automatically detect that the windows 244A-244B are positioned on the separation walls between rooms, which could lead to privacy concerns for the occupants. Having windows on separation walls may allow visibility or noise leakage between the rooms, diminishing the intended function of privacy for spaces like bedrooms or bathrooms. To address this, the controller 163 may automatically generate a pop-up warning 240 to notify the user of this potential issue.

The pop-up warning 240 may ask, “Would you prefer windows 244A-244B on the separation walls?” This notification allows the user to make an informed decision about the placement of the windows. The controller 163 provides the user with response options 243, such as “Yes” and “No,” to proceed with or remove the windows 244A-244B. The response options 243 may be color-coded for clarity: in this example, the “No” option, which is the desirable choice to remove the windows 244A-244B from the separation walls, is presented in green, while the “Yes” option, which could retain the windows 244A-244B, is shown in red. This visual distinction helps guide the user toward making choices that enhance the design's functionality and comfort.

If the user selects the “No” option, indicating that they do not want windows 244A-244B on the separation walls, the controller 163 modifies the design plan 241A by removing the windows 244A-244B from the separation walls. The updated design plan 241B reflects this change, improving the privacy between rooms and facilitating a more optimal layout. For example, the removal of the windows 244A-244B may better segregate spaces like the bedroom 246 and dining room 247, enhancing the overall user experience and comfort within the household.

Furthermore, the system can provide additional modifications based on the user's interactions and the analysis performed by the controller 163. For example, if the user provides feedback on the pop-up warning 240, the system may automatically adjust other related elements, such as window placements on external walls or suggestions for alternative ventilation strategies. The system's dynamic responsiveness allows for continuous improvements to the design as the user provides input.

This process exemplifies how the system's interactive features and real-time feedback loops work together to create a more user-friendly and effective design process. Whether modifying room layouts, adjusting window placements, or considering cultural principles like cultural, the system adapts to the user's commands while maintaining the integrity and functionality of the design. The controller 163 serves as the core engine driving these modifications, continuously analyzing, responding, and refining the design to meet user preferences and architectural best practices.

Referring now to FIG. 2F, it illustrates an exemplary method of context determination by the controller 163 before generating or modifying a design plan in accordance with the present invention. In this example, a user may need to modify an initial design plan 250A, and can provide specific commands 172 through a user interface 171. The user's commands 172 may include, for example, “1. The door 252 of the washroom 251 in the first bedroom 257A should open inward,” and “2. Move the bed 254 towards the wall of the common washroom 258.” These commands 172 are intended to adjust the configuration of the layout based on the user's preferences or requirements.

The controller 163 receives these commands 172 and processes them by analyzing the potential impacts that the changes may have on the overall layout of the design plan 250A. As part of the context determination process, the controller 163 evaluates how these modifications interact with the current structure and elements of the design plan 250A. This step is important, as the intended changes may create inconsistencies or issues within the layout that the user may not have initially considered. For example, the controller 163 may analyze whether moving the door 252 inward would affect the usability of the washroom 251 in the first bedroom 257A, or whether moving the bed 254 would interfere with the flow of space in the second bedroom 257B.

After evaluating the impacts of the user's commands 172, the controller 163 may choose to generate a modified design plan or provide feedback to the user highlighting potential issues. In this scenario, the controller 163 detects that the proposed modifications will lead to several design conflicts and thus presents a pop-up 255 to inform the user. The pop-up message may include feedback such as: “1. The door 252 of the washroom 251 would collide with the water closet 253,” “2. The position of the bed 254 in the second bedroom 257B is not appropriate,” and “3. The main entrance is missing in the design plan.” This step is an important part of the interactive process, allowing the user to be aware of the unintended consequences of their commands 172 and providing an opportunity to revise their input before finalizing the layout.

The user can respond to the pop-up 255 by amending their commands 172 or accepting the feedback provided by the controller 163. If the user acknowledges the issues identified by the controller 163 and agrees with the recommended changes, the controller 163 will proceed to generate an updated design plan 250B that resolves the identified conflicts. For example, in the revised design plan 250B, the water closet 253 in the washroom 251 is repositioned to avoid a collision with the door 252 (with the intended inward swing), so that the door 252 can open inward without obstruction.

Additionally, the controller 163 may also reposition the bed 254 in the second bedroom 257B to improve the spatial arrangement. In this embodiment, the bed 254 may be moved away from the common washroom 258, providing a more comfortable and functional bedroom layout. Moreover, if the controller 163 detects that the main entrance is missing from the original design plan 250A, it may suggest or automatically add an appropriate entryway 256 in the updated design 250B, so that the house layout remains practical and coherent.

This embodiment emphasizes the importance of context determination by the controller 163 before generating or modifying a design plan. Instead of simply executing user commands 172 in a linear manner, the controller 163 (utilizing AI engine) intelligently analyzes how these commands interact with the existing elements of the design and provides meaningful feedback to prevent potential issues. This process allows the system to refine the design incrementally, resulting in a final layout that not only meets the user's preferences but also remains functional and adheres to practical architectural principles.

For example, without the context determination by the controller 163, simply moving the door 252 inward as requested by the user could have caused the door 252 to collide with the water closet 253, rendering the washroom 251 impractical. Similarly, relocating the bed 254 without considering the layout of the common washroom 258 could have resulted in an awkward or inconvenient bedroom configuration. By evaluating these interactions and providing feedback through the pop-up 255, the controller 163 avoids such issues and facilitates that the final design plan 250B is both user-friendly and functionally sound.

This interactive process between the controller 163 and the user, where commands 172 are analyzed for context, conflicts are highlighted, and design plans are adjusted accordingly, represents a significant advancement in automated design systems. It allows users to maintain control over the design process while benefiting from intelligent, AI-driven insights that optimize the layout and prevent potential design flaws.

In some embodiments, the system for automatically generating a building design plan begins by receiving user inputs through an interactive interface. The user may provide inputs via written text, voice commands, or by drawing a sketch directly on the interface. These inputs guide the creation of a design plan for a portion or the entirety of a building. For example, a user may specify the size and layout of rooms, the placement of doors and windows, or the orientation of certain architectural elements.

Once the user inputs are received, the system processes these inputs to generate an initial design plan (250A). This design plan is then analyzed by referencing a database of design considerations, which may include structural guidelines, geographic-specific preferred building practices, or aesthetic principles like cultural or Feng Shui. If any aspects of the design plan conflict with the design considerations, the system presents these conflicts to the user on the interface. For example, the system may flag a room that does not meet minimum size requirements or a window that is not properly aligned according to environmental considerations.

The user may be prompted with context-specific questions to clarify or adjust their inputs. These questions may ask for additional details regarding the placement of design elements like doors or windows, or seek clarification on preferences for materials or styles. The user's responses are then processed, and the system evaluates how these inputs impact the overall functionality, aesthetics, or compliance of the design.

In cases where the user's responses introduce potential compromises to the design's functionality or aesthetic appeal, the system generates alternate design options. These alternatives balance the user's preferences with compliance to the design considerations, so that the design remains structurally sound while meeting the user's goals. The user can review these alternative plans and, if required, override certain design considerations, prioritizing their preferences.

The system may also analyze the cost implications of the user inputs and present an estimate. Additionally, it can provide cost-saving suggestions, such as recommending alternative materials or more efficient spatial configurations, while still adhering to the user's design objectives. Based on the user's feedback, the system generates an updated design plan that incorporates both the original user inputs and any additional adjustments made during the conflict resolution process.

In the context of the present invention, spatial configuration refers to the arrangement, layout, and relationship of various architectural and design elements within a defined space in a building. It encompasses the placement and dimensions of rooms, corridors, walls, doors, windows, and other structural components, as well as the organization of furniture, fixtures, appliances, and utilities. Spatial configuration also includes the flow and connectivity between different spaces, such as the relationship between living areas, kitchens, bedrooms, and bathrooms. It further considers the circulation paths for both humans and air, facilitating proper airflow and ventilation within the building. Other elements involved in spatial configuration include the orientation of spaces concerning natural light sources, the placement of load-bearing structures, and the interaction between indoor and outdoor spaces like balconies, gardens, or terraces. In some cases, spatial configuration also accounts for the integration of accessibility features such as ramps, elevators, and adequate clearance for individuals with disabilities, facilitating optimal functionality, comfort, and aesthetics within the built environment.

Referring now to FIG. 2G, it illustrates the process by which the user can further modify an already generated design plan 250B (in FIG. 2F) by providing subsequent commands through the user interface 171. Once the design plan 250B has been created, the system allows for additional modifications to be made based on user input, making the design process dynamic and interactive. The controller 163 processes these inputs, updating the design plan accordingly in real time.

In this embodiment, the controller 163 not only responds to the user's subsequent commands, but also provides automatic command suggestions 259 in the user interface 171. These command suggestions 259 are generated by the system based on an analysis of the current design plan 250B and may include potential improvements or modifications. For example, the system may automatically suggest the addition of a balcony or adjustments to room layouts, depending on the context and requirements of the user's previous inputs.

The suggestions 260 provided by the controller 163 may be displayed in the user interface 171, offering options such as adding more natural light to a bedroom, increasing the size of a kitchen, or, in the case depicted in FIG. 2G, attaching a balcony to the first bedroom 257A. These suggestions 260 are tailored to optimize the functionality and design of the space while taking into account the user's previous preferences and design criteria.

The user has the flexibility to either accept the suggestions 260 as they are or modify them further by adding their own commands 172. For example, if the system suggests attaching a balcony to the first bedroom 257A, the user may decide to accept this suggestion but modify the size or location of the balcony. Alternatively, the user may provide additional commands, such as specifying the type of railing or materials to be used for the balcony, or requesting that the balcony also be accessible from another room.

If the user chooses to accept the suggestions 260 as they are, the controller 163 then generates an updated design plan 250C. In this particular example, the updated design plan 250C includes an attached balcony 261 with the first bedroom 257A. This balcony, which may provide additional outdoor space and enhance the usability of the bedroom 257A, is automatically integrated into the design based on the system's suggestions and the user's acceptance of these suggestions.

This interaction between the controller 163 and the user highlights the system's ability to not only follow user commands but also provide intelligent recommendations that improve the overall design. For example, the system may detect that the first bedroom 257A is positioned in a way that makes it ideal for a balcony, considering factors such as the room's size, orientation, and proximity to other spaces in the design. The system then suggests this addition as a way to enhance the design, offering both practical benefits and aesthetic appeal.

Moreover, the user may modify other elements of the design plan 250B based on their specific preferences. For example, the user may want to increase the size of the living room or shift the position of the washroom 251 based on their lifestyle needs. The system allows for these changes to be implemented through simple commands 172, and the controller 163 processes these inputs to generate an updated design plan 250C that reflects the user's evolving vision for the space.

The embodiment depicted in FIGS. 2F-2G demonstrates the iterative nature of the design process enabled by the system. At each stage, the controller 163 is capable of analyzing the design in its current form, providing command suggestions 259, and adapting the plan based on the user's input. This facilitates that the design remains flexible and can evolve over time as new ideas or needs arise.

For example, if the user initially wanted a small balcony attached to the first bedroom 257A, but later realizes they would prefer a larger outdoor space, they can easily modify this through the system. The controller 163 will process this new input, adjust the design, and present the user with the revised design plan 250C, complete with the larger balcony or any other modifications requested.

FIG. 2G illustrates how the controller 163 not only responds to user commands 172, but also proactively generates command suggestions 259 to improve the design. These suggestions are context-sensitive and based on the system's analysis of the design plan 250B, offering the user options to enhance the design. The user can accept, modify, or reject these suggestions, allowing for an interactive, collaborative design process that results in an optimized final design plan 250C. This embodiment showcases the system's ability to facilitate both user-driven modifications and automated improvements, creating a dynamic and responsive design tool.

Referring now to FIGS. 3A-3C, a user interface 300 may generate multiple different user views, each view has different aspects related to the two-dimensional reference drawing inputted. For example, referring now to FIG. 3A, a user interface 300 with a replication view 301A may include replication of an original floor plan represented by a two-dimensional reference, without any controller-added features, vectors, lines, or polygons integrated or overlaid into the floorplan. The replication view 301A includes various spaces 303-306 that are undefined in the replication view 301A but may be defined during the processes described herein. For example, some or all of a space 303-306 may correlate to a region in a region view 301B.

The replication view 301A, may also include one or more fixtures 302. A rasterized version (or pixel version) of the fixtures 302 may be identified via an AI engine. If a pattern is present that is not identified as a fixture 302, a user may train the AI engine to recognize the pattern as a fixture of a particular type. The controller may generate a tally of multiple fixtures 302 identified in the two-dimensional reference. The tally of multiple fixtures 302 may include some or all of the fixtures identified in the two-dimensional reference and may be used to generate an estimate for completion of a project illustrated by, or otherwise represented by, the two-dimensional reference.

Referring now to FIG. 3B, in the user interface 300 a user may specify to a controller that one of multiple views available is to be presented via the interface. For example, a user may designate via an interactive portion of a screen displaying the user interface 300 that a region view 301B be presented. The region view 301B may identify one or more regions and/or spaces 303B-306B identified via processing by a controller, such as, for example, via an AI engine running on the controller. The region view 301B may include information about one or more regions 303-306 delineated in the region view 301B of the user interface 300. For example, the controller may automatically generate and/or display information descriptive of one or more of: user displays, printouts or summary reports showing a net interior area 307 (e.g., a calculation of square footage available to an occupant of a region), an interior perimeter 308, a type of use a region 303B-306B will be deployed for, or a particular material to be used in the region 303B-306B. For example, Region 4 306B may be designated for use as a bathroom; and flooring and wallboard associated with Region 4 may be designated as needing to be waterproof material.

Referring now to FIG. 3C, a gross area region view 301C and 309 is illustrated. As illustrated in FIG. 3B, a user interface may include interactive devices for display of additional parameters, such as, for example, one or more of: a net interior area 307 may generate a designation of a value that is in contrast to a gross area 310 and exterior perimeter 311. The selection of gross area 310 may be more useful to a proprietor charging for a leased space, but may be less useful to an occupant than a net interior area 307 and interior perimeter 308. One or more of the net interior areas 307, interior perimeter 308 gross area 310 and exterior perimeter 311 may be calculated based upon analysis by an AI engine of a two-dimensional reference.

In addition, a height for a region may also be made available to the controller and/or an AI engine, then the controller may generate a net interior volume and vertical wall surface areas (interior and/or exterior).

In some embodiments, an output, such as a user interface of a computing device, smart device, tablet and the like, or a printout or other hardcopy, may illustrate one or both of: a gross area 310 and/or an exterior perimeter 311. Either output may include automatically populated information, such as the gross area of one or more rooms (based upon the above boundary computations) or exterior perimeters of one or more rooms.

In some embodiments, the present invention calculates an area bounded within a series of polygon elements (such as, for example, using mathematical principals or via pixel counting processes), and/or line segments.

In some embodiments, in an area of a bounded by lines intersecting at vertices, the vertices may be ordered such that they proceed in a single direction such as clockwise around the bounded area. The area may then be determined by cycling through the list of vertices and calculating an area between two points as the area of a rectangle between the lower coordinate point and an associated axis and the area of the triangle between the two points. When a path around the vertices reverses direction, the area calculations may be performed in the same manner, but the resulting area is subtracted from the total until the original vertex is reached. Other numerical methods may be employed to calculate areas, perimeters, volumes, and the like.

These views may be used in generating estimation analysis documents. Estimation analysis documents may rely on fixtures, region area, or other details. By assisting in generating net area, estimation documents may be generated more accurately and quickly than is possible through human-engendered estimation parameters.

With reference now again to FIGS. 3B and 3C, regions 303B-306B defined by an AI engine may include one or more Rooms in FIG. 3B subsequently have regions assigned as “Rooms” in FIG. 3C.

Referring now to FIG. 3D, a table is illustrated containing hierarchical relationships between area types 322-327 that may be defined in and/or by an AI engine and/or via the user interface. The area types 322-327 may be associated with dominance relationship values in relation to adjacent areas. For example, a border region 312-313 (as illustrated in FIG. 3C) will have an area associated with it. According to the present invention, an area 315-318 associated with the border region 312-313 may have an area type 322-327 associated with the area 315-318. An area 312A included in the border region 312-313 may be allocated according to a ratio based upon a dominance ranking of one feature as compared to another feature, which may be represented as a hierarchical relationship between the features, such as, for example, adjacent areas (e.g., area 315 and area 317 or area 317 and area 318), the hierarchical relationship may be used to generate a dominance ranking of one area over another area, or to ascertain factors useful in one or both of: annotating a design element or modifying a design element. For example, a dominance ranking may allocate space used to calculate one or more of: an occupancy load; a width and/or area of an egress path; a width and/or area of a common path; a length of a dead-end; egress capacity; and travel distance from a furthest point. In this context, regions assigned a higher dominance ranking are designated to be inherently associated with elevated safety standards.

Some embodiments of the present invention allocate one or more areas according to a user input (wherein the user input may be programmed to override and automated hierarchical relationship or be subservient to the automated hierarchical relationship). For example, as indicated in the table, a private office located adjacent to a private office may have an area in a border region split between the two adjacent areas in a 50/50 ratio, but a private office adjacent to a general office space may be allocated 60 percent of an area included in a border region, and so on.

Dominance associated with various areas or regions may be systemic throughout a project, according to customer preference, indicated on a two-dimensional reference by two-dimensional reference basis or another defined basis.

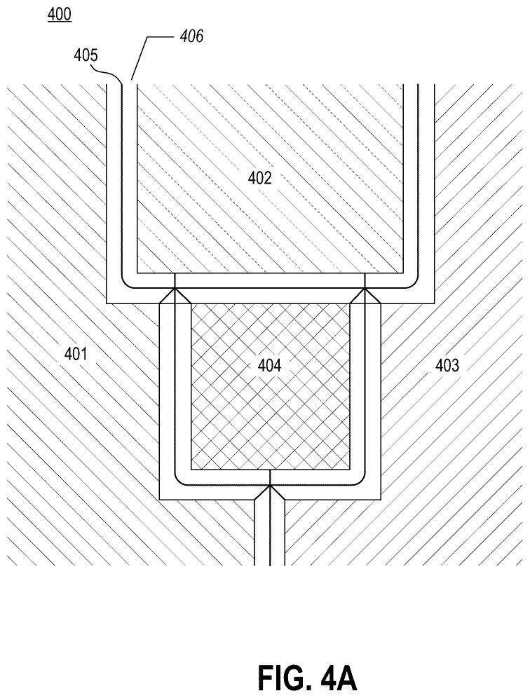

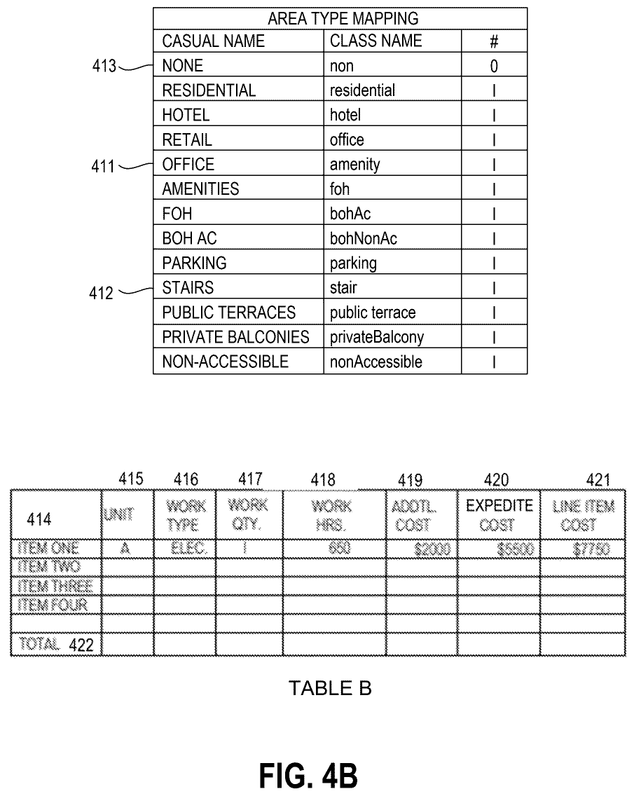

Referring now to FIG. 4A, an exemplary user interface 400 may include boundaries (which, as discussed above, may include one or more of: line segments, polygons, and icons) and regions overlaid on aspects included in a two-dimensional reference is illustrated. A defined space within a boundary (sometimes referred to as a region or area) may include an entire area within perimeters of a structure.

For example, a controller running an AI engine may determine locations of boundaries, edges, and inflections of neighboring and/or adjacent areas 401-404. There may be portions of boundary regions 405 and 406 that are initially not associated with an adjacent area 401-404. The controller may be operative via executing software in the AI engine to determine the nature of respective adjacent areas 401-404 on either side of a boundary, and apply a dominance-based ranking upon an area type, or an allocation of respective areas 401-404. Different classes or types of spaces or areas may be scored to be equal to, dominant (e.g., above) others or subservient (e.g., below) others.

Referring now to FIG. 4B, an exemplary table A indicating classes of space types and their associated ranks 411-413. In some embodiments, a controller may be operative via execution of software to determine relative ranks associated with a region on one or either side of a boundary. For example, area 402 may represent office space and area 404 may represent a stair-well. An associated rank lookup value for office space may be found at rank 411, and the associated rank lookup value for stairwells may be found at rank 413. Since the rank 412 of stairwells may be higher, or dominant, over the rank 411 of office space then the boundary space may be associated with the dominant stairs 412 or stairwell space. In some embodiments, a dominant rank may be allocated to an entirety of boundary space at an interface region. In other examples, more complicated allocations may be made where the dominant rank may get a larger share of boundary space than another rank allocated by some functional relationship. In still other examples (Table B), controller may execute logical code to be operative to assign pre-established work costs to elements identified within boundaries.

In some embodiments, a boundary region may transition from one set of interface neighbors to a different set. For example, again in FIG. 4A, a boundary 405 between office region 402 and stairwell 404 may transition to a boundary region between office region 402 and unallocated space 403. The unallocated space may have a rank associated with the unallocated space 403 that is dominant. Accordingly, the nature of allocated boundary space 405 may change at such transitions where one space may receive allocation of boundary space in one pairing and not in a neighboring region. The allocation of the boundary space 405 may support numerous downstream functionalities and provide an input to various application programs. Summary reports may be generated and/or included in an interface based upon a result after incorporation of assignment of boundary areas.

In another aspect, in FIG. 4B, a table 422 illustrates fields 414 that may have variable values 415-421 designated by an AI engine or other process run by a controller based upon the two-dimensional reference, such as a floor plan, design plan or architectural blueprint. For example, as illustrated, variables 415-421 may include a unit 415, a work type 416, work quantity 417, work hours 418, additional cost 419, expedite cost 420, and line-item cost 421. In some embodiments, the variables 415-421 may include aspects that may affect one or more of: one or both of: annotating a design element, modifying a design element, or modifying a physical version of the design element. In other embodiments, the variables 415-421 may include design considerations for the fields 414.

The determination of boundary definitions for a given inputted design plan, which may be a single drawing or set of drawings or other image, has many important uses and aspects as has been described. However, it can also be important for a supporting process executed by a controller, such as an AI algorithm to take boundary definitions and area definitions and generate classifications of a space. As mentioned, this can be important to support processes executed by a controller that assigns boundary areas based on dominance of these classifications.

Classification of areas can also be important for further aggregations of space. In a non-limiting example, accurate automatic classification of room spaces may allow for a combination of all interior spaces to be made and presented to a user. Overlays and boundary displays can accordingly be displayed for such aggregations. There may be numerous functionalities and purposes for automatic classification of regions from an input drawing.

An AI engine or other process executed by a controller may be refined, trained, or otherwise instructed to utilize a number of recognized characteristics to accomplish area classification. For example, an AI engine may base predictions for a type “/“category” of a region with a starting point of the determination that a region exists from the previous predictions by the segmentation engine.

In some embodiments, a type may be inferred from text located on an input drawing or other two-dimensional reference. An AI engine may utilize a combination of factors to classify a region, but it may be clear that the context of recognized text may provide direct evidence upon which to infer a decision. For example, a recognized textual comment in a region may directly identify the space as a bedroom, which may allow the AI engine to make a set of hierarchical assignments to space and neighboring spaces, such as adjoining bathrooms, closets, and the like.

Classification may also be influenced by, and use, a geometric shape of a predicted region. Common shapes of certain spaces may allow a training set to train a relevant AI engine to classify a space with added accuracy. Furthermore, certain space classes may typically fall into ranges of areas which also may aid in the identification of a region's class. Accordingly, it may be important to influence the makeup of training sets for classification that contain common examples of various classes as well as common variations on that theme.

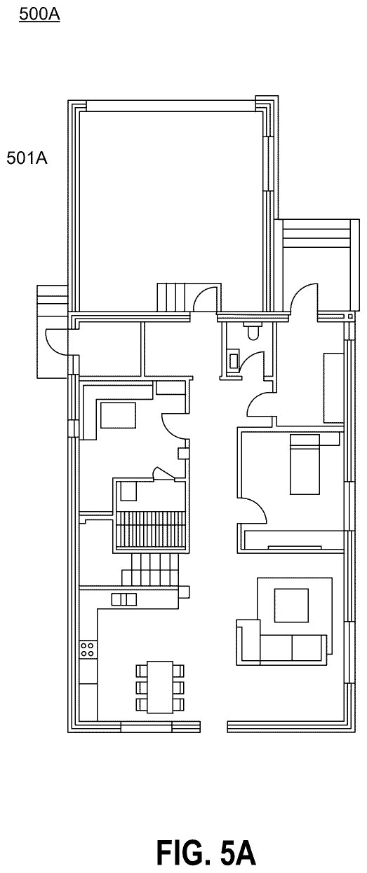

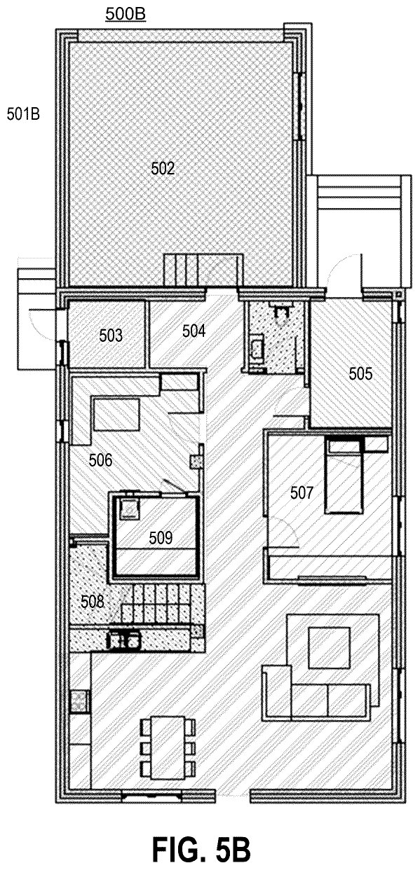

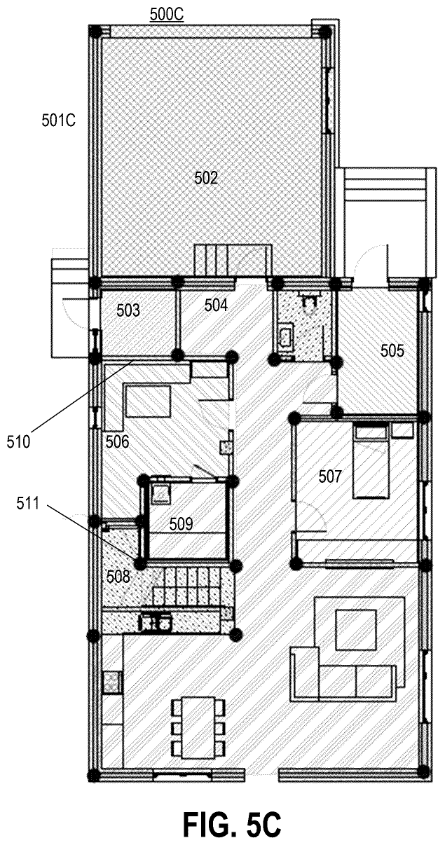

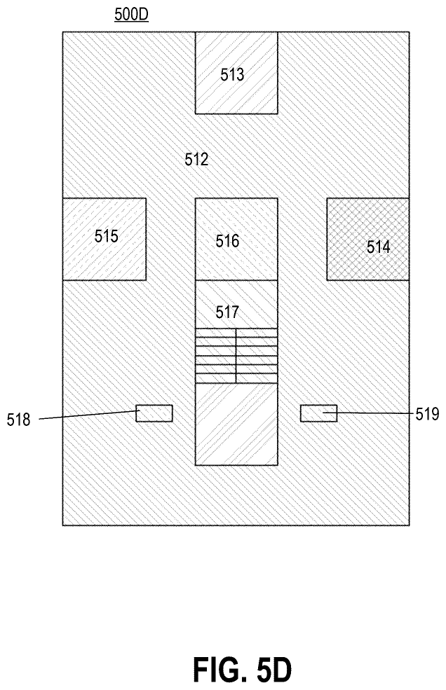

Referring now to FIGS. 5A-5D, a progressive series of outputs that may be included in various user interfaces are illustrated and provide examples of a recognition process that may be implemented in some embodiments of the present invention. Referring now to FIG. 5A, a relatively complex drawing of a floorplan may be input as a design plan 501A into a controller running an AI engine. The two-dimensional reference 501 may be included in an initial user interface 500A.

An AI engine based automated recognition process executes method steps via a controller, such as a cloud server, and identifies multiple disparate regions 502-509. Designation of the regions 502-509 may be integrated according to a shape and scale of the two-dimensional reference and presented as a region view 501B user interface 500B, with symbolic hatches or colors etc., as shown in FIG. 5B.

The region view 501B may include the multiple regions 502-509 identified by the AI engine arranged based upon a size and shape and relative position derived from the two-dimensional reference 501.

Referring now to FIG. 5C, a line segment view 501C may include identified boundary line segments 510 and vertices 511 may also be presented as an overlay of the regions 502-509 illustrated as delineated symbolic hatches or colors etc., as illustrated in FIG. 5C. Said line segments 510 may also be represented as symbols such as but not limited to dots. Such an interactive user interface 500C may allow a user to review and correct assignments in some cases. A component of the AI engine may further be trained to recognize aggregations of regions 502-509 spaces, or areas, such as in a non-limiting sense the aggregation of internal regions 502-509, spaces or areas.

Referring now to FIG. 5D, an illustration of exemplary aggregation of regions 512-519 is provided where a user interface 500D includes patterned portions 512-519 and the patterned portions 512-519 may be representative of regions, spaces, or areas, such as, for example, aggregated interior living spaces.

In some embodiments, integrated and/or overlaid aggregations of some or all: of regions; spaces; patterned portions; line segments; polygons; symbols; icons or other portions of the user interfaces may be assembled and presented in a user output and our user interface, or as input into another automated process. In some embodiments, selection or marking of the desired segments or design elements may be incorporated on the user interfaces 500A-500D as shown in FIGS. 5A-5D.

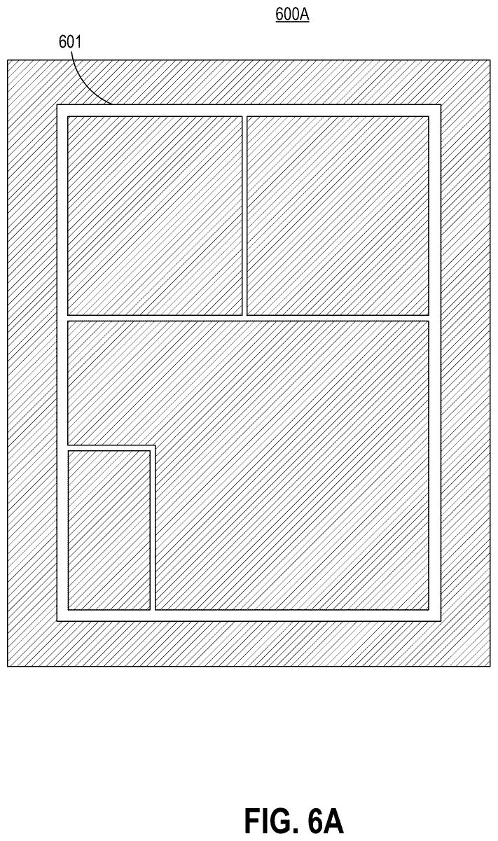

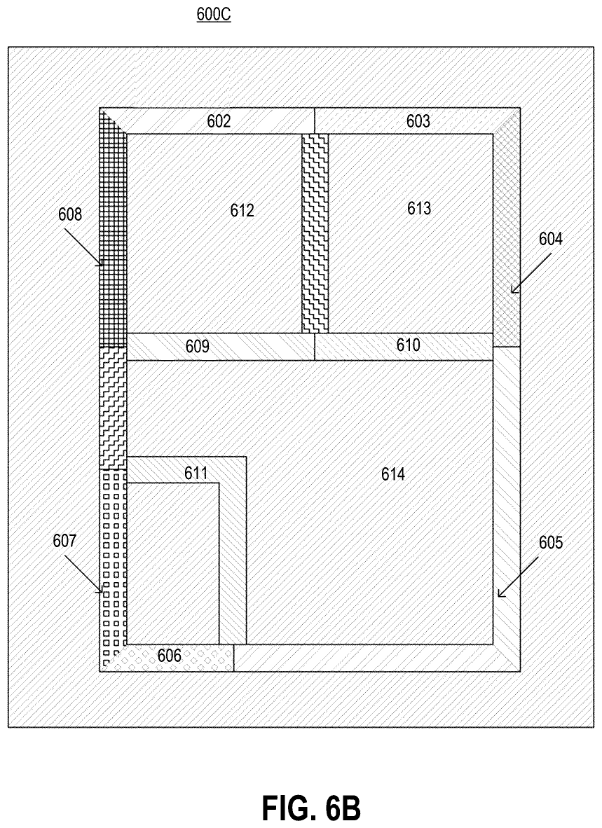

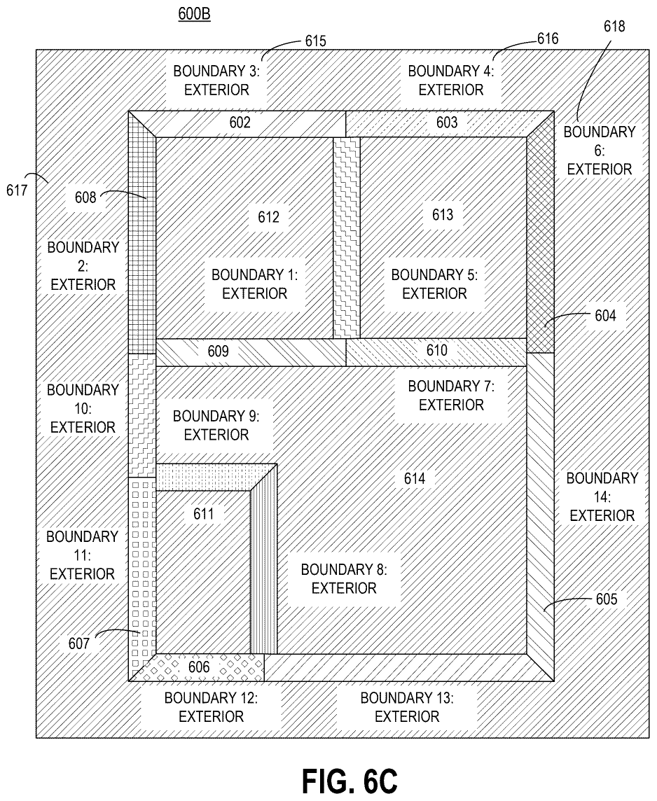

Referring now to FIGS. 6A-6C, in some embodiments, automated and/or user-initiated processes may include refinement of regions, spaces, or areas may involve one or both of a user and a controller identifying individual wall segments 211A from previously defined boundaries.

For example, in some embodiments, a controller running an AI engine may execute processes that are operative to divide a previously predicted boundary into individual wall segments. In FIG. 6A, a user interface 600A includes a representation of a design plan with an original boundary 601 defined from an inputted design.

In FIG. 6B, an AI engine may be operative to take one or more original boundaries 601 and isolate one or more individual line segments 602-611 as shown by different hatching symbols in an illustrated user interface 600B. The identification of individual line segments 602-611 of a boundary 601 enables one or both of a controller and a user to assign and/or retrieve information about the individual line segment 602-611 such as, for example, one or more of: the length of the segment 602-611, a type of wall segment 211A, materials used in the wall segment 211A, parameters of the segment 602-611, height of the segment 602-611, width of the segment 602-611, allocation of the segment 602-611 to a region 612-614 or another, and almost any digital content relevant to the segment.

Referring now to FIG. 6C, in some embodiments, a controller executing an AI engine or other method steps, may be operative, in some embodiments, to classify individual line segments 602-611 of a boundary 601 and present a user interface 600C indicating the classified individual line segments 602-611. The AI engine may be trained, and subsequently operative, to classify individual line segments 602-611 included in a boundary 601 in different classes. As a non-limiting example, an AI engine may classify walls as interior walls, exterior walls and/or demising walls that separate internal spaces.

As illustrated in FIG. 6C, in some embodiments, an individual line segment 602-611 may be classified by the AI engine and an indication of the classification 615-618, such as alphanumeric or symbolic content, may be associated with the individual line segment 602-611 and presented in the user interface 600C.

In some embodiments, functionality may be allocated to classified individual line segments 602-611, such as, by way of non-limiting example, a process that generates an estimated materials list for a region or an area defined by a boundary, based on the regions or area's characteristics and its classification. In some embodiments, selection or marking of the desired segments or design elements may be incorporated on the user interfaces 600A-600C as shown in FIGS. 6A-6C.

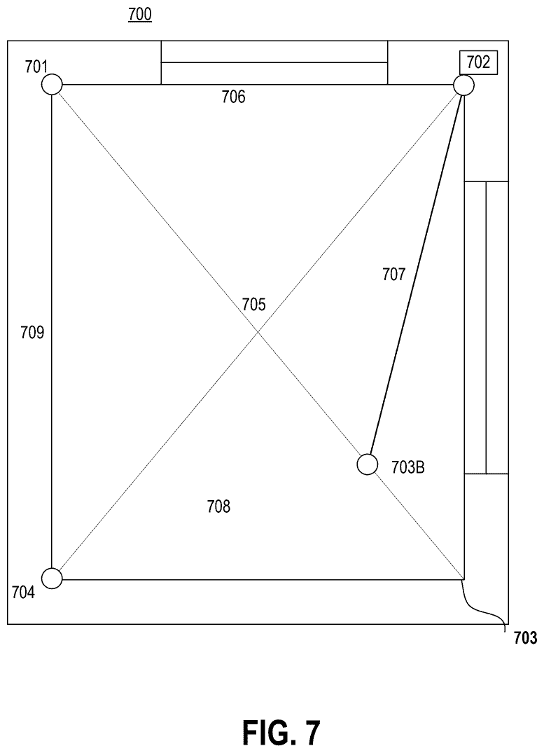

Referring now to FIG. 7, in some embodiments, a user interface 700 may include user interactive controls operative to execute process steps described herein (e.g. make a boundary determination, region classification, segmentation decision or the like) in an automated process (e.g. via an AI routine) and also be able to receive an instruction (e.g. from a user via a user interface, or a controller operative via executable software to perform a process) that modify one or more boundary segments.

For example, a user interface may include one or more vertex 701-704 (e.g., points where two or more line segments meet) that may be user interactive such that a user may position the one or more vertex 701-704 at a user selected position. User positioning may include, for example, user drag and drop of the one or more vertex 701-704 at a desired location or entering a desired position, such as via coordinates. A new position for a vertex 703B may allow an area 705 bounded by user defined boundaries 706-709 User interactive portions of a user interface 700 are not limited to vertex 701-704 and can be any other item 701-709 in the user interface 700 that may facilitate achievement of a purpose by allowing one or both of: the user, and the controller, to control dynamic sizing and/or placement of a feature or other item 701-709.

Still further, in some embodiments, user interaction involving positioning of a vertex 701-704 or modification of an item 705-709 may be used to train an AI engine to improve performance. Additionally, in some embodiments, user interaction involving positioning of a vertex 701-704 may comprise selection of a desired segment or design element in a design plan by marking and combining a plurality of vertex points similar to vertex 701-704.

An important aspect of the operation of the systems as have been described is the training of the AI engines that perform the functions as have been defined. A training dataset may involve a set of input drawings associated with a corresponding set of verified outputs. In some embodiments, a historical database of drawings may be analyzed by personnel with expertise in the field. user, including in some embodiments experts in a particular field of endeavor may manipulate dynamic features of a design plan or other aspects of a user interface to be used to train an AI engine, such as by creating or adding to an AI referenced database.

In some other examples, a trained version of an AI engine may produce user interfaces and/or other outputs based on the trained version of the AI engine. Teams of experts may review the results of the AI processing and make corrections as required. Corrected drawings may be provided to the AI engine for renewed training.

Aspects that are determined by a controller running an AI engine to be represented in a design plan may be used to generate an estimate of what will be required to complete a project. For example, according to various embodiments of the present invention, an AI engine may receive as input a two-dimensional reference and generate one or more of: boundaries, areas, fixtures, architectural components, perimeters, linear lengths, distances, volumes, and the like may be determined by a controller running an AI engine to be required to be required to complete a project.

For example, a derived area or region comprising a room and/or a boundary, perimeter or other beginning and end indicator may allow for a building estimate that may integrate choices of materials with associated raw materials costs and with labor estimates all scaled with the derived parameters. The boundary determination function may be integrated with other standard construction estimation software and feed its calculated parameters through APIs. In other examples, the boundary determination function may be supplemented with the equivalent functions of construction estimation to directly provide parametric input to an estimation function. For example, the parameters derived by the boundary determinations may result in estimation of needed quantities like cement, lumber, steel, wallboard, floor treatments, carpeting, and the like. Associated labor estimates may also be calculated.

As described herein, a controller executing an AI engine may be functional to perform pattern recognition and recognize features or other aspects that are present within an input two-dimensional reference or other graphic design. In a segmentation phase used to determine boundaries of regions or other space features, aspects that are recognized as some artifact other than a boundary may be replaced or deleted from the image. An AI engine and/or user modified resulting boundary determination can be used in additional pattern recognition processing to facilitate accurate recognition of the non-wall features present in the graphic.

For example, in some embodiments, a set of architectural drawings may include many elements depicted such as, by way of non-limiting example, one or more of: windows, exterior doors, interior doors, hallways, elevators, stairs, electrical outlets, wiring paths, floor treatments, lighting, appliances, and the like. In some two-dimensional references, furniture, desks, beds, and the like may be depicted in designated spaces. AI pattern recognition capabilities can also be trained to recognize each of these features and many other such features commonly included in design drawings. In some embodiments, a list of all the recognized image features may be created and also used in the cost estimation protocols as have been described.

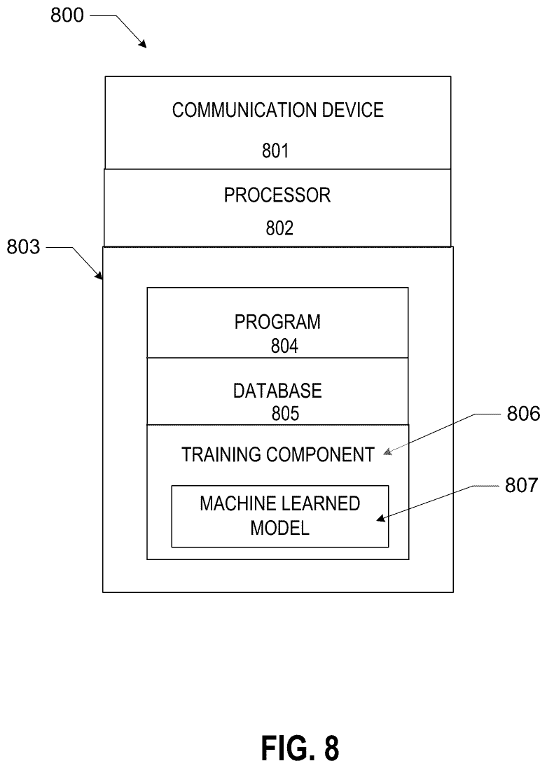

Referring now to FIG. 8 a schematic diagram of an automated controller is illustrated that may be used to implement various aspects of the present invention, in various embodiments, and for various aspects of the present invention, controller 800 may be included in one or more of: a wireless tablet or handheld device, a server, a rack mounted processor unit. The controller may be included in one or more of the apparatuses described herein, such as a Server, a smart device, a PC, and a Network Access Device. The controller 800 includes a processor unit 802, such as one or more semiconductor-based processors, coupled to a communication device 801 configured to communicate via a communication network (not shown in FIG. 8), such as a VPN, the Internet, WAN, cellular network, or other conduit capable of transferring digital information. The communication device 801 may be used to communicate, for example, with one or more online devices, such as a server, a personal computer, a laptop, or a handheld device.

The processor 802 is also in communication with a storage device 803. The storage device 803 may include any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 803 can store a software program 804 with executable logic for controlling the processor 802. The processor 802 performs instructions of the software program 804, and thereby operates in accordance with the present invention. In some embodiments, the processor may be supplemented with a specialized processor for AI related processing. The processor 802 may also cause the communication device 801 to transmit information, including, in some instances, control commands to operate apparatus to implement the processes described above. The storage device 803 can additionally store related data in a database 805. The processor and storage devices may access an AI training component 806 and database, as needed which may also include storage of machine-learned models 807.

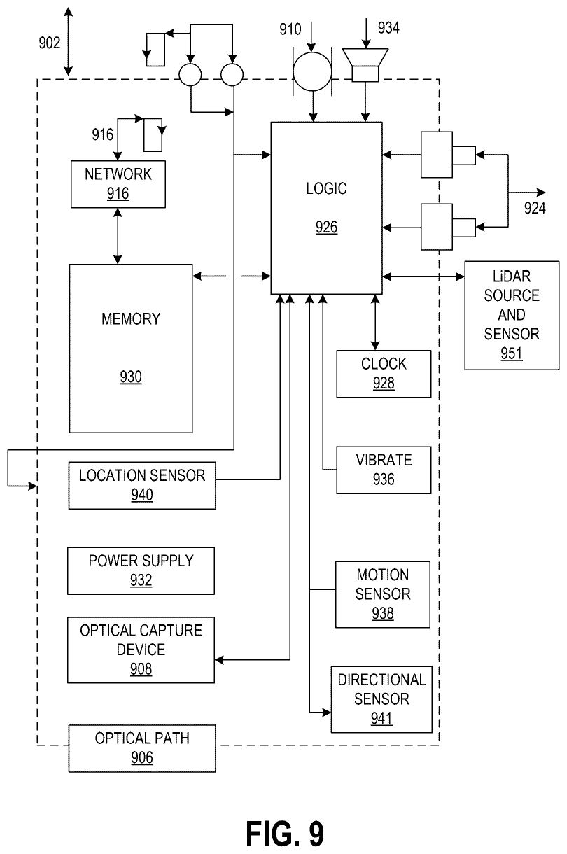

Referring now to FIG. 9, a block diagram of an exemplary mobile device 902 is illustrated. The mobile device 902 comprises an optical capture device 908 to capture an image and convert it to machine-compatible data, and an optical path 906, typically a lens, an aperture, or an image conduit to convey the image from the rendered document to the optical capture device 908. The optical capture device 908 may incorporate a Charge-Coupled Device (CCD), a Complementary Metal Oxide Semiconductor (CMOS) imaging device, or an optical Sensor 924 of another type.

A microphone 910 and associated circuitry may convert the sound of the environment, including spoken words, into machine-compatible signals. The microphone 910 may also be utilized by users to provide audio annotations (or for speech-to-text annotations) of the present invention. Input facilities may exist in the form of buttons, scroll wheels, or other tactile Sensors such as touchpads. In some embodiments, input facilities may include a touchscreen display.

Visual feedback to the user is possible through a visual display, touchscreen display, or indicator lights. Audible feedback 934 may come from a loudspeaker or other audio transducer. Tactile feedback may come from a vibrate module 936.

A motion Sensor 938 and associated circuitry convert the motion of the mobile device 902 into machine-compatible signals. The motion Sensor 938 may comprise an accelerometer that may be used to sense measurable physical acceleration, orientation, vibration, and other movements. In some embodiments, motion Sensor 938 may include a gyroscope or other device to sense different motions.

A location Sensor 940 and associated circuitry may be used to determine the location of the device. The location Sensor 940 may detect Global Position System (GPS) radio signals from satellites or may also use assisted GPS where the mobile device may use a cellular network to decrease the time required to determine location.

The mobile device 902 comprises logic 926 to interact with the various other components, possibly processing the received signals into different formats and/or interpretations. Logic 926 may be operable to read and write data and program instructions stored in associated storage or memory 930 such as RAM, ROM, flash, or other suitable memory. It may read a time signal from the clock unit 928. In some embodiments, the mobile device 902 may have an on-board power supply 932. In other embodiments, the mobile device 902 may be powered from a tethered connection to another device, such as a Universal Serial Bus (USB) connection.

The mobile device 902 also includes a network interface 916 to communicate data to a network and/or an associated computing device. Network interface 916 may provide two-way data communication. For example, network interface 916 may operate according to the internet protocol. As another example, network interface 916 may be a local area network (LAN) card allowing a data communication connection to a compatible LAN. As another example, network interface 916 may be a cellular antenna and associated circuitry which may allow the mobile device to communicate over standard wireless data communication networks. In some implementations, network interface 916 may include a Universal Serial Bus (USB) to supply power or transmit data. In some embodiments, other wireless links may also be implemented.

As an example of one use of mobile device 902, a reader may scan an input drawing with the mobile device 902. In some embodiments, the scan may include a bit-mapped image via the optical capture device 908. Logic 926 causes the bit-mapped image to be stored in memory 930 with an associated timestamp read from the clock unit 928. Logic 926 may also perform optical character recognition (OCR) or other post-scan processing on the bit-mapped image to convert it to text.

A directional sensor 941 may also be incorporated into the mobile device 902. The directional device may be a compass and be based upon a magnetic reading or based upon network settings.

A LiDAR sensing system 951 may also be incorporated into the mobile device 902. The LiDAR system may include a scannable laser light (or other collimated) light source which may operate at nonvisible wavelengths such as in the infrared. An associated sensor device, sensitive to the light of emission may be included in the system to record time and strength of returned signal that is reflected off of surfaces in the environment of the mobile device 902. In some embodiments, as have been described herein, a 2-dimensional drawing or representation may be used as the input data source and vector representations in various forms may be utilized as a fundamental or alternative input data source. Moreover, in some embodiments, files which may be classified as BIM input files may be directly used as a source on which method steps may be performed. BIM and CAD file formats may include, by way of non-limiting example, one or more of: BIM, RVT, NWD, DWG, IFC and COBie. Features in the BIM or CAD datafile may already have defined boundary aspects having innate definitions such as walls and ceilings and the like. An interactive interface may be generated that receives input from a user indicating a user choice of types of innate boundary aspects a user provides instruction to the controller to perform subsequent processing on.

In some embodiments, a controller may receive user input enabling input data from either a design plan format or similar such formats, or also allow the user to access BIM or CAD formats. Artificial intelligence may be used to assess boundaries in different manners depending on the type of input data that is initially inputted. Subsequently, similar processing may be performed to segment defined spaces in useable manners as have been discussed. The segmented spaces may also be processed to determine classifications of the spaces.

As has been described, a system may operate (and AI Training aspects may be focused upon) recognition of lines or vectors as a basic element within an input design plan. However, in some embodiments, other elements may be used as a fundamental element, such as, for example, a polygon and/or series of polygons. The one or more polygons may be assembled to define an area with a boundary, as compared, in some embodiments, with an assembly of line segments or vectors, which together may define a boundary which may be used to define an area. Polygons may include different vertices; however common examples may include triangular facets and quadrilateral polygons. In some embodiments, AI training may be carried out with a singular type of polygonal primitive element (e.g., rectangles), other embodiments will use a more sophisticated model. In some other examples, AI engine training may involve characterizing spaces where the algorithms are allowed to access multiple diverse types of polygons simultaneously. In some embodiments, a system may be allowed to represent boundary conditions as combinations of both polygons and line elements or vectors.

Depending upon one or more factors, such as processing time, a complexity of the feature spaces defined, and a purpose for AI analysis, simplification protocols may be performed as have been described herein. In some embodiments, object recognition, space definition or general simplification may be aided by various object recognition algorithms. In some embodiments, Hough type algorithms may be used to extract diverse types of features from a representation of a space. In other examples, Watershed algorithms may be useful to infer division boundaries between segmented spaces. Other feature recognition algorithms may be useful in determining boundary definitions from building drawings or representations.

In some embodiments, the user may be given access to movement of boundary elements and vertices of boundary elements. In examples where lines or vectors are used to represent boundaries and surrounding areas, a user may move vertices between lines or center points of lines (which may move multiple vertices). In other examples, elements of polygons such as the user may move vertices, sides, and center points. In some embodiments, the determined elements of the space representation may be bundled together in a single layer. In other examples, multiple layers may be used to distinguish distinct aspects. For example, one layer may include the AI optimized boundary elements, another layer may represent area and segmentation aspects, and still another layer may include object elements. In some embodiments, when the user moves an element such as a vertex the effects may be limited only to elements within its own layer. In some examples, a user may elect to move multiple or all layers in an equivalent manner. In still further examples, all elements may be assigned to a single layer and treated equivalently. In some embodiments, users may be given multiple menu options to select disparate elements for processing and adjustment. Features of elements such as color and shading and stylizing aspects may be user selectable. A user may be presented with a user interface that includes dynamic representations of a feature, or other aspects of a design plan, and associated values and changes may be input by a user. In some embodiments, an algorithm and processor may present to the user comparisons of various aspects within a single model or between different models. Accordingly, in various embodiments, a controller and a user may manipulate aspects of a user interface and AI engine.

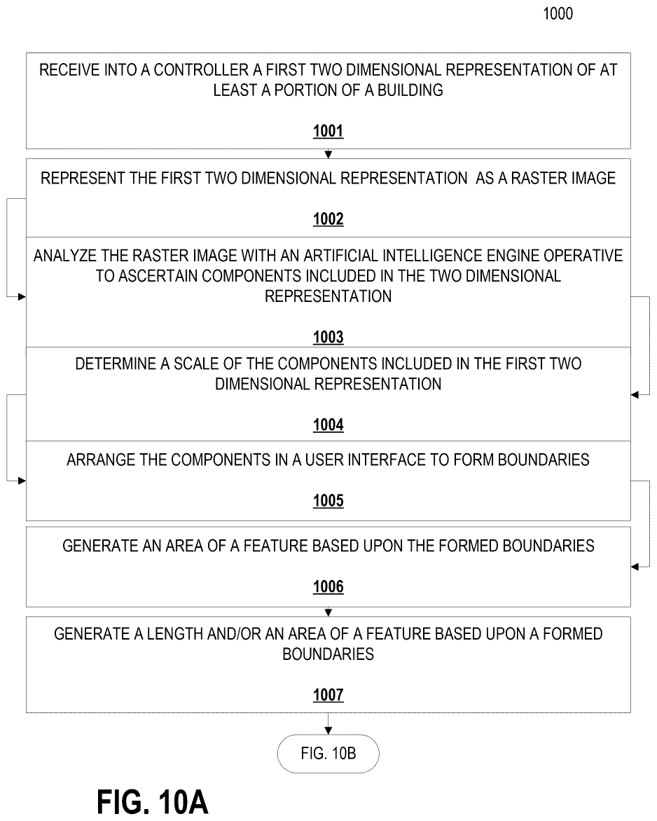

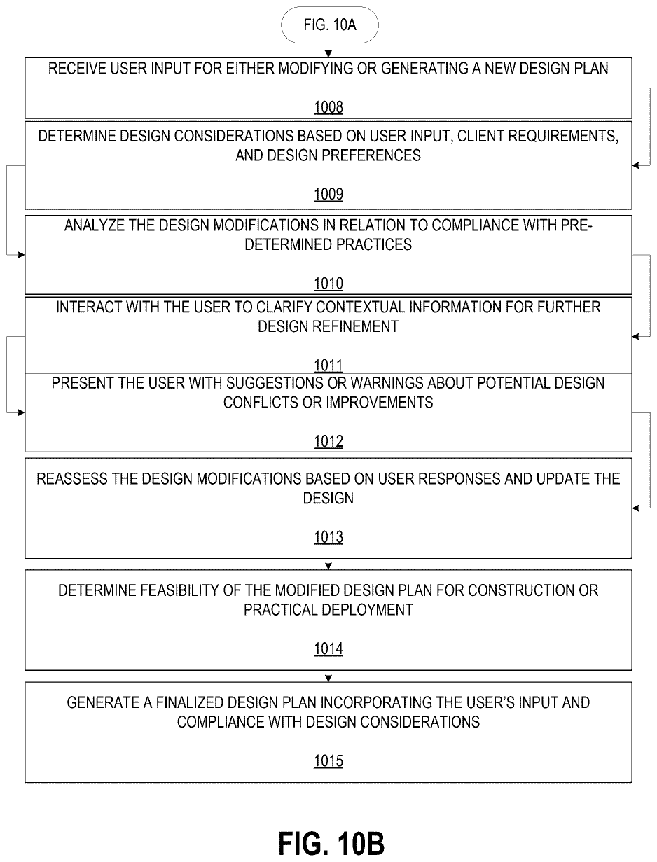

Referring now to FIGS. 10A-10B, method steps are illustrated for design plan generation and/or modification processes in some implementations of the present invention.

At step 1001, the process begins by receiving into a controller a first two-dimensional representation of at least a portion of a building. This two-dimensional representation may come from a variety of sources, including a design file from a CAD system, a scanned architectural drawing, or even a hand-drawn sketch. For example, a user may submit a blueprint of a residential building or a commercial floor plan. This step is the starting point where the controller accesses the design that forms the basis of all further modifications and analysis. The input file can be in various formats, such as DWG, DXF, PDF, JPEG, or even TIFF, representing different types of drawings, including technical schematics or hand-rendered layouts. This initial submission is vital for the controller's analysis because it provides the spatial framework, dimensions, and elements that the system will work with throughout the process.

At step 1002, the controller processes the received two-dimensional representation by converting it into a raster image. This conversion is important when the input file is in vector format, such as a DWG or DXF file, which stores data as geometric shapes, lines, and curves. Rasterization turns these elements into pixels, allowing the controller to work with a detailed grid-based representation of the design. This step is important for enabling the AI engine to interpret the design in a way that supports component recognition, boundary formation, and further manipulation of the design. For example, if the design includes multiple walls and doorways in vector format, they will be translated into a raster image composed of pixels that represent those elements. This step enables the system to analyze the plan as an image, which becomes the basis for AI-driven analysis in subsequent steps.

At step 1003, the controller employs an artificial intelligence engine to analyze the rasterized image and identify architectural components. These components may include elements such as walls, doors, windows, columns, and other features present in the design. For example, if the input file contains a blueprint of a house, the AI engine recognizes where walls begin and end, the placement of windows, and the dimensions of rooms. This process may involve segmentation techniques where the AI divides the image into distinct regions based on pixel patterns and contrast. This segmentation allows the system to discern individual components in the design and associate them with specific architectural elements. The system may also rely on a pre-trained model, which has been trained on thousands of architectural designs to recognize common features. Once the components are identified, they are tagged and categorized for use in later steps.

At step 1004, the system determines the scale of the components identified in the two-dimensional representation. Scaling is important because architectural drawings are often reduced or enlarged for presentation purposes, and the system needs to work with real-world dimensions. The controller may extract scale information directly from the input file, such as a dimension line or a scale bar included in the original drawing. If no scale information is present, the user may be prompted to provide known dimensions, such as the width of a doorway or the length of a wall. For example, the user could input that a doorway is three feet wide, and the system would use that information to proportionally calculate the size of all other elements in the design. This step is important to converting pixel-based data into accurate real-world measurements, allowing the system to manipulate the design with precision.

At step 1005, the controller arranges the identified components into a user interface to form boundaries between various spaces in the design. For example, walls identified by the AI engine in step 1003 are used to define the boundaries of rooms, hallways, and other architectural spaces. These boundaries are presented in the user interface, allowing the user to visualize how the different components relate to each other spatially. For example, in the design of an office floor plan, the system would use wall elements to separate individual office spaces, meeting rooms, and common areas. These boundaries are dynamic and can be adjusted by the user if needed. The user can interact with the interface by selecting boundaries to modify them, such as moving a wall or expanding a room, and the system will automatically update the design in real time based on those inputs.

At step 1006, the system generates an area for a feature based upon the boundaries that have been formed. Once the boundaries of rooms, hallways, and other spaces are defined, the system calculates the area of each enclosed space. For example, in a residential floor plan, the system will calculate the square footage of each bedroom, living area, kitchen, and other rooms. This information is important for both the user and the system, as it provides real-time feedback about the dimensions and proportions of spaces within the design. The system can use this area information to facilitate that the design adheres to user-specified requirements or spatial constraints, such as facilitating that a room meets minimum size requirements for comfort or function. The user can then adjust the layout if the calculated areas do not meet their expectations.

At step 1007, the system goes further to generate the length and/or area of a feature based upon a formed boundary. In this step, the system provides detailed dimensions for individual elements within the design. For example, the system may calculate the length of a hallway, or the area of a patio based on the boundaries formed in the previous steps. If the design includes special features such as curved walls or non-rectangular rooms, the system will use advanced algorithms to calculate the precise area and length of those features. This allows the user to gain a more comprehensive understanding of the design and make any important modifications. The system also provides measurements for specific architectural details, such as the width of doorways, the height of ceilings, or the surface area of windows, giving the user the detailed information needed to refine the design.

At step 1008, the system receives user input for either modifying an existing design plan or generating an entirely new design plan. The input provided by the user could be delivered through various modes, such as written text, voice commands, or even hand-drawn sketches. For example, a user may input, “Create a new design plan for a three-bedroom house with a garden area and two bathrooms,” or provide instructions like, “Move the kitchen to the left of the living room in the current plan.” The system interprets these inputs and initiates the process of design modification or generation. The user may also provide further detailed inputs, such as room dimensions, preferences regarding door placement, or any specific aesthetic or functional requirements.

At step 1009, the system determines design considerations based on the user's input, client requirements, and pre-configured design preferences. These considerations include factors like spatial constraints, the number of rooms, room functionality, and design aesthetics. For example, if a user requests a house design in accordance with cultural principles, the system automatically incorporates relevant spatial guidelines. Similarly, if the client requirements specify the use of certain materials or eco-friendly design standards, the system takes this into account. The system may also refer to building regulations, such as accessibility standards for physically challenged individuals, or design preferences such as open floor plans or specific room adjacencies. This step facilitates that the final design meets the specific expectations and constraints that are important to the user or client.

At step 1010, the system analyzes the design modifications or generation process in relation to compliance with pre-determined practices. These practices may include preferred architectural methods, ergonomic principles, or spatial optimization techniques. For example, the system checks whether the proposed changes conform to best practices in space utilization, such as maintaining a certain distance between the stove and the sink in a kitchen. This analysis may also involve assessing whether the modifications adhere to specific functional requirements, like having sufficient egress routes in case of an emergency. The system may also evaluate energy efficiency considerations, facilitating that rooms receive adequate sunlight, or that heating and cooling requirements are optimized.

At step 1011, the system interacts with the user to clarify contextual information for further refinement of the design. If the initial input from the user is ambiguous or lacks required details, the system asks clarifying questions to understand the user's true intent. For example, if the user requests to move a bedroom but does not specify its new location, the system may ask, “Would you like to place the bedroom adjacent to the bathroom for convenience?” or “Do you have a preferred direction for the windows?” This step facilitates that the system fully comprehends the user's intentions and incorporates them accurately into the design. By facilitating this interaction, the system enhances user control over the final layout while maintaining practical design integrity.

At step 1012, the system presents the user with suggestions or warnings about potential design conflicts or areas for improvement. For example, if the user has placed a window in a location that could cause privacy issues or disrupt structural integrity, the system will alert them, suggesting alternative placements. Additionally, the system may provide suggestions for optimizing the design further, such as increasing the size of a living room by slightly reducing the adjacent storage space. These warnings and suggestions are vital in helping the user create a functional and aesthetically pleasing design while avoiding design pitfalls that may not be obvious initially.

At step 1013, the system reassesses the design modifications based on the user's responses to suggestions or warnings and updates the design accordingly. For example, if the system warns the user that a proposed wall placement would block natural light, and the user accepts this feedback, the system will modify the design to include an alternative solution, such as moving the wall or adding more windows. This reassessment facilitates that the design continuously evolves based on user preferences while mitigating design flaws or inefficiencies. The system is capable of iterative updates, adjusting the design plan step by step as the user refines their preferences or addresses conflicts identified by the system.

At step 1014, the system determines the feasibility of the modified design plan for construction or practical deployment. This involves analyzing whether the design can be realistically constructed within the given constraints, such as material availability, budgetary considerations, or site-specific limitations. For example, if the user requests a large rooftop garden, the system will assess whether the structural integrity of the building can support such a feature. If the design plan exceeds practical constraints, the system may notify the user and offer alternatives, such as adjusting material choices or changing the dimensions to make the design more feasible. This feasibility analysis is important to prevent unrealistic design choices and facilitate that the final plan can be built without major complications.

At step 1015, the system generates a finalized design plan that incorporates both the user's input and compliance with all relevant design considerations. This design plan may include the user's aesthetic preferences, functional requirements, and any adjustments made through the interactive process. The final plan is then ready for presentation or further action, such as sharing with clients or builders, or exporting to construction documentation formats. For example, the finalized design plan may show detailed floor layouts, including furniture placement, lighting arrangements, and access points, all conforming to the user's specifications while adhering to ergonomic, structural, and aesthetic standards.

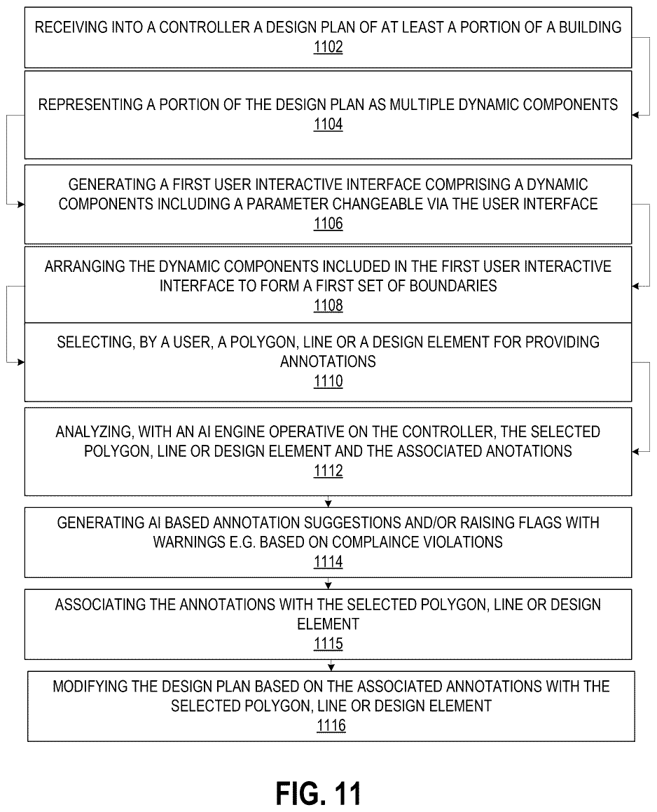

Referring now to FIG. 11, a system including one or more controllers (comprising AI engine) may be configured to perform particular operations or actions by virtue of having executable software, firmware, hardware, or a combination of them that in operation cause the controllers to be operative to perform method steps for annotating design elements, and analyzing annotations for providing automated annotation suggestions and for determining non-compliance to best practices or predefined rules within a collaborative environment.

At step 1102, receiving into a controller a design plan, which may be a static design plan, such as, for example, a design plan in PDF format, of at least a portion of a building or other structure.

At step 1104, the method may include representing a portion of the static design plan as multiple dynamic components. The dynamic components include, for example, one or more polygons, lines, and arcuate segments.

At step 1106, the method may include generating a first interactive user interface including at least some of the multiple dynamic components representing a portion of the design plan, each dynamic component including a parameter changeable via the interactive user interface.

At step 1108, the method may include arranging the dynamic components included in the first interactive user interface to form a first set of boundaries, the first set of boundaries including a respective length and area, and the first set of boundaries defining at least a portion of a first unit.

At step 1110, the user selects a design element within the first interactive user interface. This design element may be a polygon representing a room, a line indicating a boundary, or any specific feature on the design plan that requires further detail, installation instructions or clarification. The selection process is intuitive, allowing users to simply click or tap on the desired element within the interface. Other ways to select the design elements are also discussed in various embodiments of the present invention.

At step 1112, once a design element is selected, the AI engine operative on the controller analyzes the selected design element and its associated annotations. This analysis includes understanding the spatial context of the design element, its dimensions, the implications of its location, and any previously associated annotations or data. The AI uses this analysis to inform and enhance the subsequent steps of the annotation process.

At step 1114, the AI engine generates annotation suggestions, which can include text, images, and multimedia elements. These suggestions are based on a database of best practices, user preferences, past annotations, and compliance with best practices. These suggestions can be similar to the past annotations to the similar design elements or AI generated suggestions based on machine learning past annotations. For example, if a window (design element) is selected, the AI engine may suggest annotations related to glazing options, energy efficiency ratings, or aesthetic design considerations. Moreover, if the system detects potential non-compliance with best practices or predefined rules based on the selected element's attributes or the annotations, it may raise flags with warnings, prompting the users to adjust the design or update the annotations accordingly.

At step 1115, the system further associates the annotations with the selected design element. This association facilitates that the annotations are correctly positioned relative to the element and are displayed within the user interface in a manner that other users (possibly with appropriate permissions) can easily understand and interact with.

At step 1116, the process involves modifying the design plan based on the associated annotations with the selected polygon, line, or design element. This step plays a significant role in enhancing the design by allowing the system to interact intelligently with specific components of the plan. The system, powered by the AI engine and GAN capabilities, identifies annotations linked to design elements like polygons, lines, or other architectural features. These annotations contain important information such as dimensions, materials, spatial relationships, or functional properties, which guide the system in making modifications.

For example, consider a scenario where a user selects a polygon representing a room in a floor plan. The polygon may have annotations linked to it that specify the room's intended purpose (e.g., living room), preferred dimensions, or material finishes. When the user opts to modify this room, perhaps resizing it to fit new furniture, the system retrieves the associated annotations to understand the room's context. It may suggest keeping the room within certain size limits for practical use or adjusting adjacent spaces to accommodate the change. The system uses the annotations as a reference point to preserve the integrity of the design while enabling the requested modifications.

In another example, the user may select a line representing a wall in the design. The annotations associated with this line may specify its structural load-bearing capacity, material type, and its relationship to nearby rooms or features. If the user wishes to move or resize this wall, the system refers to the annotations to make informed decisions. For example, if the wall is load-bearing, the system may suggest reinforcing it or adjusting the design to maintain structural stability while still allowing the desired modification.

This step also applies to design elements beyond just polygons and lines. Suppose the user selects a design element like a door or window. The associated annotations may contain information about dimensions, placement restrictions (such as proximity to corners or other windows), and aesthetic requirements. When the user requests to move or resize the door, the system leverages the annotations to recommend changes that preserve functionality and compliance with design preferences or building standards.

Annotations may also include compliance information, such as accessibility requirements or energy efficiency standards. For example, if the user modifies a window's placement, the system could automatically adjust the window size or suggest additional shading based on energy-efficiency annotations. Similarly, the system could facilitate that door modifications meet accessibility guidelines by referring to annotations specifying minimum clearance for wheelchair access.

Through step 1116, the system provides a responsive, context-aware design experience. By interpreting annotations linked to selected polygons, lines, or design elements, the system facilitates that modifications align with both user preferences and practical constraints. Additionally, this step allows the system to offer real-time feedback and suggestions, streamlining the modification process while maintaining the quality and functionality of the design.

In the context of the present invention, architectural features may also refer to the core elements of a building's design that define its structural, aesthetic, and functional characteristics. These features include fundamental components such as load-bearing walls, columns, beams, and floors, which provide the required structural support for the building. Roofs and ceilings, as part of the architectural features, define the upper boundary of the space, contributing to both protection from environmental factors and the overall aesthetic. Windows and doors, though part of design elements, are also considered architectural features due to their impact on light, ventilation, access, and exterior appearance. Staircases, balconies, and terraces are additional architectural features that connect different levels or offer outdoor space. Building facades, whether decorative or functional, contribute to the exterior identity of the structure. Features like arches, cornices, pilasters, and moldings add to the architectural style, while materials such as glass, concrete, wood, or brick define the texture and durability of the building. Skylights, courtyards, and atriums introduce natural light and openness to the interior design. Additionally, specialized features such as domes, spires, or overhangs may reflect cultural or regional influences, while HVAC systems, ductwork, and mechanical shafts integrate the building's functional needs. These architectural features work together to create both the physical integrity and visual coherence of the design plan, which the system evaluates and modifies to optimize performance, user preferences, and compliance with design considerations.

Some embodiments of the present invention enable the collaborative platform to serve not just as a static repository of design plans but as a dynamic, intelligent system that guides users through the annotation process, helps maintain compliance, and facilitates a more efficient design workflow. For example, upon selecting a staircase element (design element), the system may suggest annotations regarding tread depth standards, highlight potential accessibility issues, or even propose alternative designs that are better suited to the overall building layout. This intelligent guidance may serve to streamline the collaborative process, making the system invaluable to architects, engineers, and other stakeholders involved in the design and building process.

In some embodiments of the present invention, the system's capabilities extend beyond the creation and management of annotations within design plans. The AI engine, through an integrated and responsive user interface, may offer intelligent equipment recommendations based on selected design elements, annotations context, or modifications within the design plan.

Upon selection of a design element for annotation or modification, the AI engine may analyze the context and specifics of the change, such as the function of the space, dimensions of the design element, or materials specified in annotations. Leveraging this information, the AI may then suggest equipment(s) that is optimally compatible with the design requirements. These suggestions may include a variety of equipment(s) from different brands, along with detailed pricing information.

The system may also integrate with third-party vendor databases to pull real-time pricing and availability data, providing users with a possible comprehensive shopping experience within the platform. Users can review these recommendations, compare options, and even access reviews or ratings within the same interface.

For example, if a user annotates a design element to convert a space into a high-traffic area, the AI engine may recommend durable flooring options available from specific brands and present the cost implications directly within the interface. If the annotation specifies the need for an eco-friendly HVAC system, the system may suggest several models that meet the latest environmental standards, complete with efficiency ratings and prices.

Moreover, the platform may also offer a feature to directly add these recommended equipment to a virtual cart, facilitating immediate or later purchases. The platform may also automatically update a takeoff, material list, workforce requirements, project budget or other related project aspect. Platform integration into such associated functions may streamline bidding, procurement, labor engagement, supply chain, and other related processes, facilitating project planning and execution phases that are closely aligned. Required resources may be accounted for and procured efficiently.

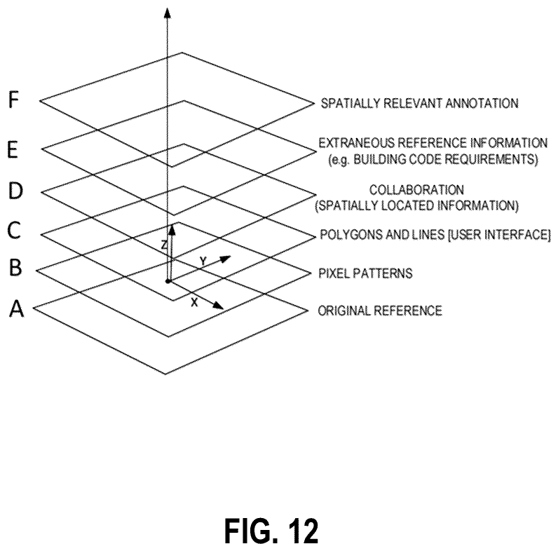

Referring now to FIG. 12, a conceptual framework showing multiple layers involved in the AI-powered collaborative system for spatial annotations, creation, and modification of a design plan, represented as levels A through F. FIG. 12 showcases a comprehensive system is described that facilitates the generation or modification of a design plan using a multi-layered AI-powered collaborative platform. This process leverages artificial intelligence to enable a seamless and efficient collaboration environment, integrating user inputs, compliance checks, and contextual annotations at various stages of the design plan.

At Level A, the system begins by receiving a baseline design reference, which may include an architectural drawing, a floor plan, or a three-dimensional representation of a building or portion of a building. This design plan serves as the foundational layer upon which all further analyses and modifications are built. For example, a static floor plan for a multi-story office building may be uploaded as the starting point for subsequent modifications. The system reads the design, extracts the important components such as walls, rooms, doorways, and more, to prepare it for transformation in subsequent levels.

Once the design plan is uploaded, it progresses to Level B, where the original reference is transformed into pixel patterns. This transformation allows the system to process the design plan on a pixel-by-pixel basis, giving the AI engine the ability to discern finer details in the architectural layout. The AI engine uses the pixel data to detect shapes, lines, polygons, and other important design elements such as windows and doors. For example, a user uploading a hand-drawn sketch of a residential house would have that sketch converted into pixel data, which allows the system to accurately analyze the layout and identify key features like room dimensions and wall placements.

At Level C, the system organizes these pixel patterns into dynamic elements within the user interface, such as polygons, lines, and boundaries. This level serves as the visual layer, allowing users to interact with the design. For example, a polygon may represent a room, while a line may represent a boundary or wall. These elements are interactive and adjustable. The user interface presents these elements in such a way that the user can select individual components, such as a room polygon or a wall line, and modify them as needed. In one example, a user could move a boundary line to resize a room or adjust the placement of a door to improve room accessibility.

The collaborative platform comes into play at Level D, where multiple users can engage with the design plan simultaneously. In this level, the system supports real-time collaboration, enabling stakeholders from different teams to work on the same design plan, each contributing according to their role. For example, an architect could be working on the structural layout while an interior designer simultaneously makes changes to the room aesthetics or furniture placements. The collaborative platform facilitates that all changes are synchronized in real-time, with updates instantly reflected on every user's interface. This level of cooperation greatly enhances productivity and reduces the delays typically associated with sequential design modifications.

Moving up to Level E, the system integrates various compliance protocols and third-party platforms. In this embodiment, the AI engine facilitates that modifications made to the design plan comply with standards such as fire safety, energy efficiency, accessibility (such as the American Disabilities Act), and other building regulations. For example, if a user attempts to place a door too close to a staircase, the system may flag this as a potential hazard and suggest an alternative placement. This level also connects the system to third-party vendor databases. For example, if the user specifies that a room requires soundproofing, the system may automatically present a list of available soundproofing materials, pricing options, and suppliers. Users can also link the design plan to product catalogs, labor marketplaces, or advertising platforms for seamless integration of materials and labor needs.

At Level F, users can engage deeply with the dynamic components, polygons, lines, walls, rooms, and boundaries within the system. This level enables users to add spatial annotations to specific design elements, such as noting the type of materials to be used for a wall, specifying load-bearing capacities, or tagging rooms with specific functions like “conference room” or “guest bedroom.” The AI engine can also provide automated annotation suggestions, so that the design adheres to best practices and any relevant compliance standards. For example, when a user selects a room, the AI may suggest appropriate materials for flooring based on the room's intended use, such as recommending tiles for a bathroom or hardwood for a living room. Additionally, the AI engine may propose cost estimates, labor requirements, and even update budget projections based on the modifications.

An exemplary scenario illustrating this process may involve an office renovation project where the user uploads an existing floor plan at Level A. The system then transforms the floor plan into pixel data at Level B, allowing the AI engine to identify walls, rooms, and fixtures. At Level C, these elements are organized into dynamic shapes in the user interface, allowing the user to interact with them. Several team members, including an architect, interior designer, and project manager, collaborate at Level D, modifying the layout in real-time. The system checks for compliance with fire safety and accessibility regulations at Level E and presents suggestions for materials at this stage. Finally, at Level F, users annotate rooms with their intended purpose, assign responsibilities to team members for various tasks, and approve or reject design modifications based on AI-driven suggestions.

In another embodiment, a user working on a residential design may modify a kitchen layout by selecting the polygon representing the kitchen space. The system at Level C recognizes the boundaries of the kitchen and allows the user to adjust the size or move components like the kitchen island. At Level F, the AI engine suggests that the kitchen needs more ventilation, prompting the user to add a window. The system automatically checks the compliance for ventilation and lighting regulations before updating the final design.

The multi-layered approach described in FIG. 12 allows for a robust and intelligent system that integrates real-time collaboration, compliance checks, material sourcing, and automated suggestions to optimize the design process. By leveraging AI and collaborative tools, the system provides a powerful framework for generating and modifying design plans efficiently and effectively.

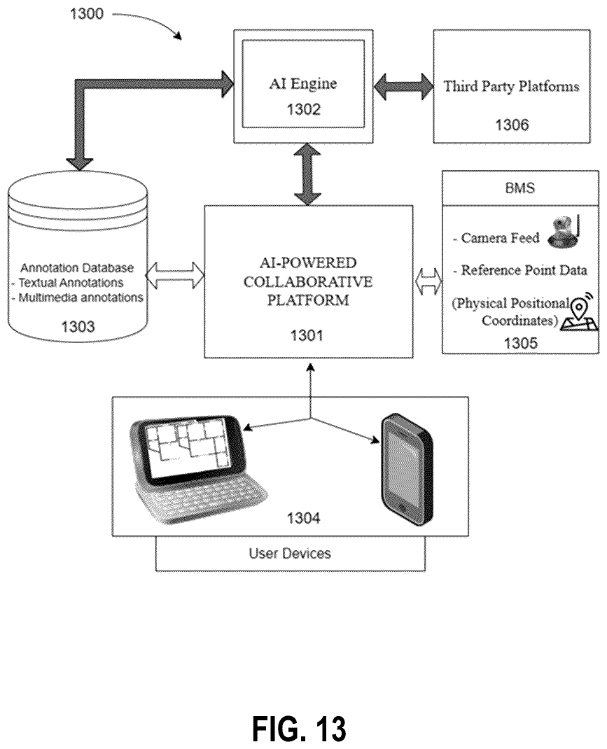

FIG. 13 illustrates an exemplary system 1300 which constitutes the core of the AI-powered collaborative platform 1301, supporting architectural, engineering, and construction industries via enhanced collaborative capabilities.

At the heart of system 1300 is the AI Engine 1302, which processes vast amounts of data, learns from user interactions, and delivers intelligent, context-aware suggestions. It is a dynamic component that continuously evolves, becoming more sophisticated with each annotation, modification, or interaction carried out by users.

An annotation database 1303 is a comprehensive repository that houses textual annotations and multimedia annotations. These may be static entries and/or serve as a dynamic knowledge base for training the AI Engine 1302. The database 1303 may enable the AI Engine 1302 to provide automated, precise annotation suggestions and to learn the nuances of various project types and user preferences.

In some embodiments of the present invention, the AI Engine 1302 leverages the comprehensive annotation database 1303, which is an aggregation of past textual and multimedia annotations, to refine and enhance its suggestion capabilities. This learning process involves the AI Engine 1302 analyzing patterns, keywords, and contexts from the stored annotations to understand the types of annotations that are typically associated with various design elements. As users interact with the system, the AI Engine 1302, drawing upon this historical data, suggests automated annotations that are relevant to the current design element being reviewed or modified. It can recommend textual annotations that have been frequently used in similar contexts or generate new annotations, both textual and visual (images or video clips), that are informed by the collective intelligence embedded within the annotation database 1303. This process not only speeds up the annotation phase by providing users with a repository of potential annotations to choose from but also facilitates consistency in documentation and adherence to best practices that have been established over the lifecycle of numerous projects.

Third party platforms 1306 represent an extended ecosystem connected to the AI Engine 1302, encompassing vendors for supplies, labor marketplaces for staffing needs, compliance with best practices, brand catalogs for equipment and fixtures, and advertising platforms for targeted product placements. This integration allows for a seamless procurement process, labor management, and equipment selection directly from the collaborative platform.

A building management system (BMS) 1305 serves as the sensory network of the actual physical structure of the design plan, feeding real-time data such as camera feeds into the AI Engine 1302. This input allows the collaborative platform 1301 to track changes within the physical building, adjust design plans accordingly, and facilitate that the annotations remain accurate and up-to-date.

In some embodiments of the present invention, the AI Engine 1302 may be configured to scrutinize data streams from multiple cameras strategically installed throughout the physical structure of a building (such processes may be for example: iterative, perpetually or at scheduled intervals). These cameras function as the eyes of the system, capturing live footage that reflects the current state and ongoing activities within the premises. The AI Engine 1302 employs advanced image recognition algorithms and machine learning techniques to identify any deviations or alterations from the established digital design plan. When changes are detected, ranging from structural modifications to repositioning of design elements, the AI Engine 1302 automatically updates the digital representation of the design plan to mirror the altered reality within the physical building. This facilitates that the digital design plan remains a living document, accurately synchronized with the building's physical evolution. The updated design plan can then be used to inform stakeholders, guide further development, and serve as a reliable reference for maintenance and operational purposes.

In some embodiments, the AI Engine 1302 can harness camera feed data to craft visual annotation suggestions, enhancing the user's annotative experience. By analyzing real-time imagery, the AI Engine 1302 can detect spatial dynamics and propose annotations that visually represent suggestions for design alterations or highlight areas requiring attention.

The BMS 1305 also incorporates a sophisticated network of reference location points, installed a various locations in the physical building, which provide a high level of accuracy in determining positional coordinates of selected design elements on the design plan. These reference points may include an array of IoT devices, such as Wi-Fi access points, RFID sensors, and Bluetooth beacons, each contributing to a detailed spatial matrix. Wi-Fi nodes can offer a broad coverage of signal-based location data, while RFID tags provide pinpoint precision for item tracking, and Bluetooth beacons grant the ability to detect and interact with user devices at close range. Together, these reference points create a multi-dimensional grid within the physical structure, enabling the BMS 1305 to triangulate and determine the precise real-world coordinates of any selected design element within the digital plan.

User devices 1304, such as laptops, tablets, or smartphones, can connect to the AI-powered collaborative platform 1301. They enable users to access design plans, annotate, perform modifications, share updates with other team members, receive notifications, and delve into details of design elements.

For example, a user on a construction site can use a tablet to scan a QR code on a newly installed component, which may bring up the design plan on the platform. The AI Engine 1302 may then display relevant annotations, suggest modifications based on the latest BMS data, or even pull up installation videos from the annotation database 1303.

In some embodiments of the present invention, the system may be equipped with an integrated proximity detection feature that enhances on-site workflow efficiency. As a user traverses the construction site, their proximity to annotated design elements is actively monitored through various cameras or location reference points, such as Wi-Fi access points, RFID sensors, and Bluetooth beacons, which are distributed (installed) across the site. When the user enters a predefined proximity to an annotated design element, these sensors work in concert with the BMS 1305 to detect their presence and communicate with the AI Engine 1302.

Upon recognition of the user's proximity to the specified location, the AI Engine 1302 triggers an immediate response. A notification is sent to the user's device, potentially with a prompt to access detailed information. This notification may include a direct link that opens up the relevant section of the digital design plan on the user's device, highlighting the annotations and presenting any associated instructions or multimedia guides. This may be especially useful for installation processes, safety checks, or quality inspections, where immediate access to the detailed plans and notes can significantly streamline on-site tasks.

Furthermore, as users interact with the design plan through their devices, the AI Engine 1302 can learn their preferences, for example, automatically suggesting a particular brand of fixtures known to meet the user's quality standards or cost targets, based on previous selections stored in third party platforms 1306.

Moreover, the system can be integrated with augmented reality (AR), where a user points their device at a space, and the AR overlays the digital annotations and design elements onto the live camera feed, allowing for an immersive and interactive experience.

In some embodiments of the present invention, the system may further encompass an advanced cost estimation and vendor integration module. This module is functional to provide users with an extensive analysis of the total costs associated with the installation of equipment, the required labor count, and the associated labor costs. Upon the selection and annotation of design elements that necessitate equipment installations or modifications, the AI engine comprehensively evaluates the scope of work and calculates an estimated cost.

The AI engine may tap into a database (including from third-party platforms) of historical installation costs, labor rates, and time-to-completion metrics to predict the overall expenses. It may factor in current market trends, seasonal labor availability, and even regional economic conditions to enhance the accuracy of the estimation.

For a more competitive and economical approach, the system may include a feature that facilitates the integration of multiple vendor platforms, enabling a bidding process for the contract of work. Users can submit a portion of the design plan along with specifications and annotations to a network of potential contractors and vendors who, in turn, can provide their quotes directly through the platform.

Additionally, the system may offer a project timeline simulation based on the selected equipment and labor projections, allowing users to visualize the potential project flow and make informed decisions about scheduling and resource allocation.

In a more advanced implementation, the system may also integrate with electronic procurement and project management tools, automating the process of request for proposals (RFPs), bid collection, and contract management. It may also feature smart alerts for users when bids are received, or deadlines for bid submission are approaching.

Furthermore, the system may provide a sustainability index score by analyzing the selected equipment and materials against environmental standards, giving users insight into the environmental impact of their choices and the potential for green building certifications.

By encompassing these features, the embodiment underscores the platform's role not just as a design tool but as an integral component of the project management ecosystem, streamlining workflows from conceptual design to the final stages of construction and installation.

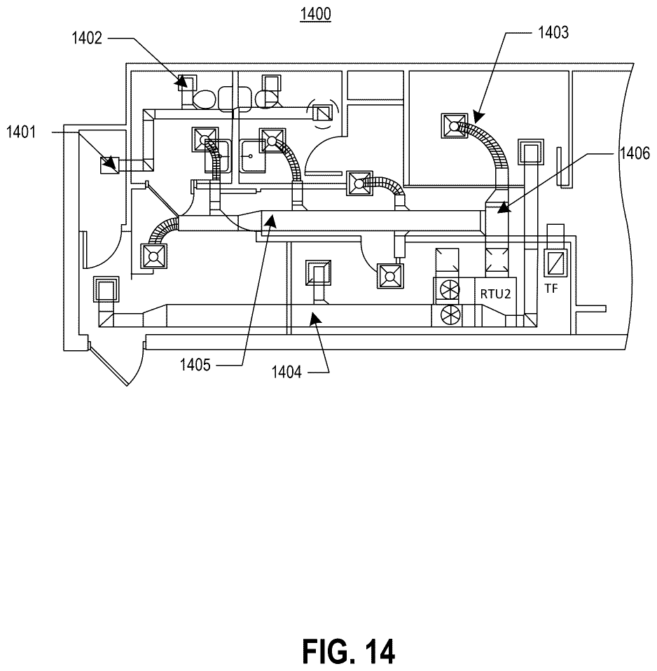

Referring now to FIG. 14, an exemplary automatically generated design plan 1400 is illustrated, showing the airflow paths 1401-1406 within a building's HVAC system. The design plan 1400 has been generated by a system (having AI and GAN capabilities) based on a user's input commands and the system's analysis of airflow requirements (I.e., design considerations as discussed in FIG. 1G). FIG. 14 exemplifies how the AI engine and GAN engine integrated into the platform can create complex HVAC layouts by analyzing and suggesting the most efficient paths for air circulation, ventilation, and temperature control.

In this embodiment, the airflow paths 1401-1406 represent the direction and flow of air through various components of the HVAC system. These paths can be modified by the system based on real-time analysis of airflow needs and user commands. The airflow path 1401, for example, may represent an air supply duct responsible for distributing air to various rooms, while path 1402 could represent a return air duct responsible for pulling air back to the system for re-circulation.

The design plan 1400 is dynamic and interactive, meaning the user can provide further commands to adjust the airflow paths 1401-1406. For example, the user may input a command to reposition airflow path 1403 to avoid potential obstructions in the ceiling or walls. The system would analyze the user's command in real-time, consider factors like duct size, room volume, and unimpeded airflow, and suggest an optimal new path for airflow path 1403. The system may even simulate the airflow to show the user how the modified path would affect the efficiency of the HVAC system.

The system also takes into account building deployment objectives, such as energy efficiency and room-specific air conditioning needs. For example, the user may specify that a particular room needs a higher airflow due to higher foot traffic or sensitive equipment stored inside. In response, the system can increase the size of airflow path 1404 or suggest the addition of an extra air vent in that room to balance the air distribution.

The AI engine integrated into the platform can process a variety of parameters, including room size, equipment load, and even external weather conditions, to optimize the airflow paths 1401-1406. For example, airflow path 1405 may be automatically adjusted to minimize the number of sharp turns in the duct system, as too many turns may reduce airflow efficiency. The system can prompt the user with suggestions, asking if fewer bends are preferred to increase airflow velocity.

Furthermore, users can configure the airflow paths 1401-1406 for different operational scenarios, such as winter and summer modes, by leveraging the system's ability to simulate how temperature changes outside the building may impact the internal airflow. The system can suggest modifications like additional insulation or altering the velocity of airflow path 1406 to conserve energy during different seasons.

Moreover, the user may input a specific command asking the system to balance airflow between multiple rooms. In such cases, the system can analyze all the airflow paths and suggest increasing the diameter of airflow path 1402 or splitting it into multiple ducts for uniform air distribution across multiple zones.

In another embodiment, the AI system can suggest alterations based on maintenance needs. For example, airflow path 1405 may be repositioned to be more accessible for cleaning and repairs. The user can further request real-time simulations of the adjusted airflow to understand how changes in duct layout may affect the system's performance.

Furthermore, the system may also integrate airflow compliance standards based on the building's purpose. For example, in commercial kitchens or data centers, where higher air circulation is required, the system may recommend larger ducts or additional air inlets to accommodate the increased load. The airflow paths 1401-1406 would be generated accordingly and the user could specify further details, such as noise reduction preferences, which may require airflow path 1401 to be rerouted through soundproofed sections of the building.

In some embodiments, the AI engine may also include predictive maintenance capabilities, where sensors embedded in the HVAC system provide real-time data on the airflow paths. If airflow path 1406 shows a reduction in efficiency due to wear or blockage, the system can notify the user and suggest modifications or repairs to facilitate optimal functionality.

Additionally, the AI-powered design plan may also factor in cost considerations during design. For example, if the user requests a low-cost solution, the system can minimize the number of materials used for airflow path 1402 by proposing a more direct route for ducts and avoiding areas that would require complex construction changes. Conversely, if energy efficiency is prioritized, the system could propose insulating airflow path 1403 to reduce heat loss in colder climates.

Moreover, users can simulate how external factors, such as local climate conditions, affect the internal HVAC system. If airflow path 1404 is found to be inefficient due to heat gain from an adjacent uninsulated wall, the system could propose shifting the duct to a cooler area of the building or adding insulation.

The AI-powered system can also be used collaboratively, where multiple users, such as HVAC technicians, architects, and project managers, can interact with the design plan. They can provide input for specific sections of the airflow system, annotate airflow paths 1401-1406, and propose design changes that better align with the building's functional needs.

Finally, the AI system's ability to continuously learn from user inputs facilitates that the design process becomes more streamlined over time. If a particular design adjustment, like rerouting airflow path 1405, proves to be highly efficient, the system can store that configuration and suggest it for future design projects in similar building structures.

By integrating real-time simulations, user commands, and building requirements, the system is capable of generating a comprehensive and adaptive HVAC design plan as exemplified by airflow paths 1401-1406 in FIG. 14.

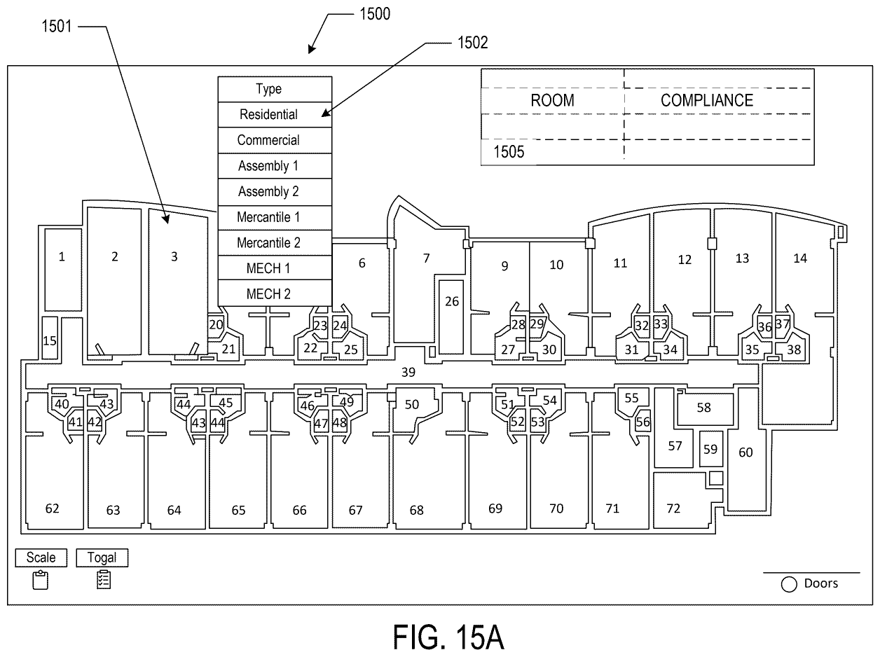

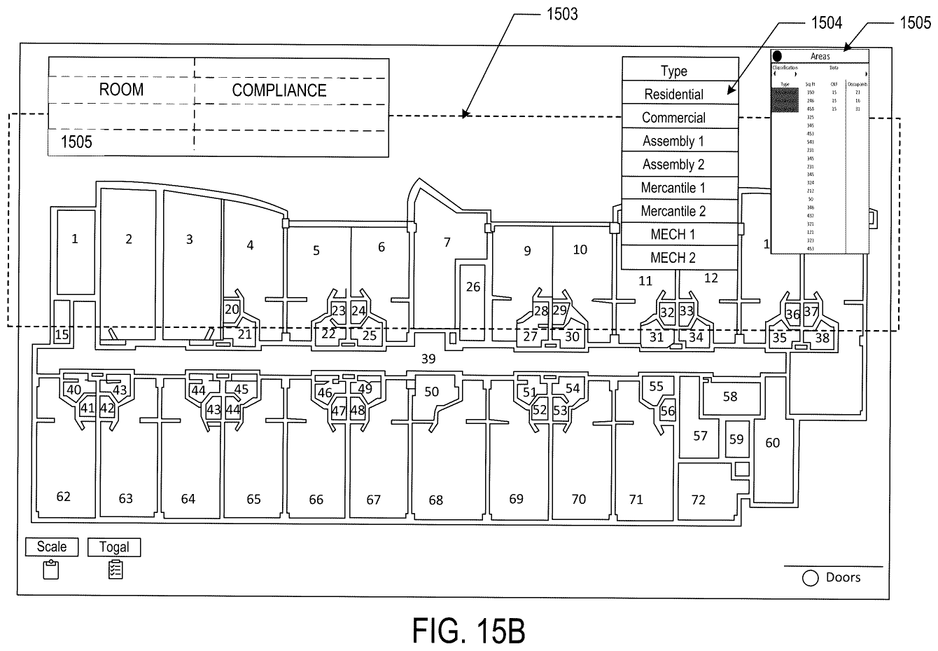

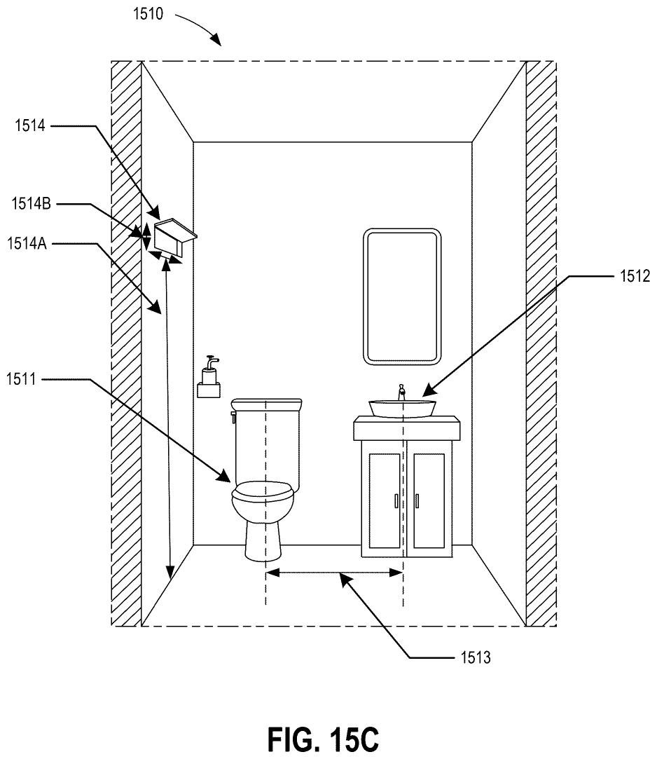

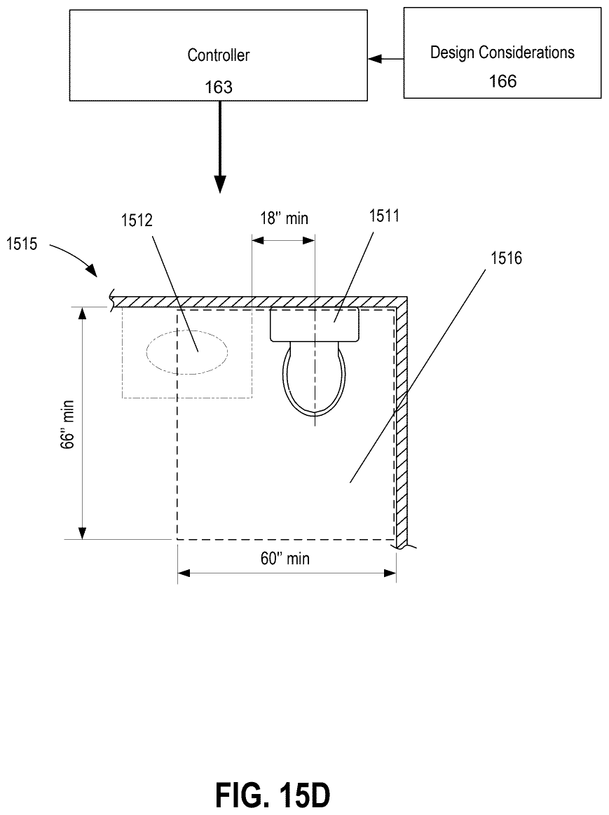

Referring now to FIG. 15A, an exemplary user interface 1500 is illustrated, showing a design plan that has been analyzed by the AI engine for further modification requirements. The design plan displayed in this interface exemplifies how the system processes user inputs, compliance considerations, and client requirements, and highlights areas that need to be addressed or modified. The AI engine has used its capabilities to review the design and identify sections, like area 1501, that need to be redesigned. These areas, highlighted in red, indicate where potential violations, errors, or unmet design considerations have been identified. The color-coding system provides immediate visual feedback to the user, enabling them to quickly focus on the parts of the design that require further attention.

In this embodiment, area 1501, shown in red, may represent an under-ventilated space in a building's HVAC system or a room that violates a user-defined specification such as inadequate dimensions for specific use. The red color signifies that these areas are problematic, and the user must address them before proceeding with the finalization of the design. The AI engine is continually analyzing design aspects like space usage, airflow, and room layout to determine if they comply with predefined standards or the user's inputted requirements.

When the user clicks on a red-highlighted area like 1501, a pop-up window 1502 appears, providing further details about the issue. The information in the pop-up may include specifics like “type of a space”, “insufficient space for assembly use”, “incorrect placement of air ducts”, or even “non-compliance with ADA (Americans with Disabilities Act) standards.” In addition to the details of the issue, the pop-up window may present suggestions generated by the AI engine on how to fix the identified problem. For example, the AI engine may recommend resizing a room, repositioning doors, or adding ventilation systems.

In this way, the AI engine acts not only as an analytical tool but also as a proactive design assistant, offering solutions and suggestions that are based on both user inputs and built-in intelligence about best practices and standards. The user can then decide to accept or modify these suggestions, further personalizing the design to suit the project's needs.

In another example, the pop-up window 1502 may provide additional insights such as the room's current dimensions, the type of space, and a list of standards that the area currently fails to meet. The user can click through multiple options to decide the best course of action, whether to adjust the dimensions, reposition features, or simply delete the problematic area. Additionally, the pop-up may contain links to external references, like compliance databases, allowing users to cross-check the design with third-party standards.

The green-colored areas on the design plan represent spaces where the design fully meets all the predefined conditions. These areas comply with user inputs, client requirements, design considerations, and any applicable compliance standards like energy efficiency or safety regulations. For example, a green-colored room may be one where the HVAC airflow is optimally designed according to the room's function, or where room dimensions align perfectly with the user's inputs, such as a well-sized office space that meets accessibility requirements.

The AI engine is operative via programmable software to continuously analyze the interaction between the different components of the design, which means that a change in one section may affect another. For example, increasing the size of one room may create new problems, such as blocking windows in an adjacent room or overcrowding a hallway. The system's real-time analysis will immediately flag these new issues, updating the color-coded system to reflect the current state of the design.

Furthermore, the user interface 1500 can also display a list of issues or pending tasks related to the problematic areas, helping the user systematically work through the design modifications. For example, if the user is working on an office building design, the system may flag a red area due to non-compliance with fire safety codes, perhaps because a fire exit is missing or poorly positioned. In the pop-up window 1502, the system may suggest relocating the fire exit, rerouting corridors, or enlarging certain spaces to meet egress requirements. The user may then have the option to implement these changes manually or let the AI engine redesign the space automatically using its GAN capabilities.

For each red area, the system can also generate a cost estimation for the required changes. For example, if the problem involves resizing rooms, the AI engine may calculate how much additional material would be needed, as well as how much extra labor and time would be required to make the changes. The pop-up window 1502 could display these cost estimations directly, giving the user a comprehensive understanding of the financial implications before making any decisions.

As part of the user's ability to further interact with the design, they may instruct the system to redesign a specific red area 1501 based on revised user inputs or client requirements. For example, after reviewing the pop-up, the user could input a new command such as, “Increase the square footage of area 1501 by 20% to comply with workspace regulations.” The AI engine will then recalculate the entire layout, adjusting neighboring areas and facilitating that the newly generated design still complies with all other applicable standards.

In addition to being a powerful tool for identifying problems and solutions, the user interface 1500 can also serve as a collaborative platform where multiple stakeholders, such as architects, engineers, and clients, can review the same design plan. Each stakeholder may focus on different aspects of the design, adding their own annotations or making specific changes. For example, an engineer may focus on the HVAC system, while an architect may prioritize spatial design, and the client may be interested in aesthetic elements. The system can track these inputs, ascertain whether the inputs conflict, and update a design plan in real-time.

Moreover, the GAN capabilities of the system enable it to generate multiple design iterations based on a single set of commands. For example, if the user instructs the system to “correct all red areas,” the GAN can automatically generate a few different options for fixing the problems, allowing the user to select the best version from a set of AI-generated alternatives.

The AI engine's ability to track and log all user inputs and commands facilitates that every modification is documented. If at any point the user decides to revert to an earlier version of the design, they can do so by accessing a history of changes maintained by the system. This feature is particularly useful in collaborative projects where multiple users are making adjustments simultaneously.

Referring now to FIG. 15B, it illustrates how a user can interact with a design plan through an intelligent interface to refine or redesign specific areas using the system's AI engine and GAN engine. In this example, the user has selected one or more spaces in the design plan, highlighted by selected area 1503, to prompt the system to analyze those spaces for possible modifications or optimizations. This process can include a deep analysis of each space's compliance with user-defined inputs, design considerations, or any predetermined standards such as ADA (Americans with Disabilities Act) requirements, fire safety codes, or ventilation standards.

When the user selects an area 1503, the system automatically analyzes it and generates a pop-up window 1504. This pop-up window 1504 contains detailed information about the selected space, including the type of space, such as whether it is designated for commercial, residential, or mixed-use purposes. The type of space is important for the AI engine to determine what standards or guidelines need to be applied. For example, if the selected space is commercial, the AI engine may flag areas that require changes to accommodate accessibility requirements or adjust the airflow to account for a high-occupancy zone.

Additionally, the pop-up window 1504 may offer a breakdown of what needs to be redesigned in each selected space. For example, the system may highlight that in one of the selected spaces, the ventilation is inadequate, or the room dimensions do not meet the required spatial standards for a particular type of preferred building practice. The GAN engine can then generate multiple design alternatives that rectify these issues. The user is given the option to either manually modify these areas or allow the system to automatically redesign the space according to optimal configurations generated by the AI and GAN engines. The design alternatives provided by the system may include rearranging walls, adjusting room dimensions, or changing door placements to improve the overall layout or functionality of the selected space.

The pop-up window 1504 also displays how each room in the selected area relates to surrounding spaces. For example, if the user selects multiple adjoining rooms, the AI engine may analyze how the redesign of one room affects adjacent rooms. In such cases, the AI engine considers both the functional flow between spaces and the technical aspects such as structural integrity, ventilation, and fire safety pathways. If a wall is moved, the system checks to facilitate that other architectural elements like windows, doors, and structural beams remain aligned with the updated design. The pop-up may further suggest optimal dimensions for corridors or egress points to meet safety requirements.

Adjacent to the pop-up window is a table 1505, which provides additional details about the selected areas, such as their exact dimensions, square footage, and other relevant information. This table may include metrics like ceiling heights, volume, and load-bearing capacities. These details allow the user to review specific aspects of each space before making any decisions on modifications. The table 1505 may also compare the current design with design standards or user-defined parameters. For example, if a room in the selected area 1503 is intended to be a workspace, the table could show that the current dimensions are insufficient to comfortably accommodate the number of people specified by the user, prompting the need for resizing.

Moreover, the table 1505 may display warnings or recommendations related to the dimensions of the selected areas. For example, if a particular room fails to meet compliance for an office space, such as insufficient space for wheelchair access, the system will indicate this discrepancy in the table, giving the user actionable insights. The user can then either manually modify the design plan or allow the AI engine to automatically generate suggestions for resizing the space. This type of detailed feedback facilitates that the user can make informed decisions when refining the design.

In some embodiments, the user can also input new commands directly into the pop-up window 1504 to guide the redesign process further. For example, the user may specify that certain rooms should not exceed a certain width or that a particular section of the design should accommodate a specific number of workstations. The AI engine would then analyze these inputs in real-time, facilitating that the modifications meet the user's specifications. The system's AI and GAN engines will continue to monitor the interconnectedness of these changes, adjusting other areas of the plan as required to maintain a cohesive and functional layout.

In addition to providing immediate design solutions, the AI engine can also generate a visual simulation of how the redesigned spaces will look. The table 1505 may include links to 3D renderings or walkthroughs of the modified areas, enabling the user to visualize the results before finalizing any changes. This capability is especially useful in complex design projects where spatial relationships between rooms, corridors, and communal areas must be meticulously planned to optimize both aesthetics and functionality.

For example, if the selected area 1503 includes a conference room that requires adjustments to meet fire safety codes, the pop-up window 1504 may show multiple redesign options. The AI engine may recommend moving certain elements such as exits or storage spaces to create a safer and more compliant layout. The user can preview these adjustments using 3D renderings provided in the table 1505 to facilitate that the changes align with their overall vision for the space. By providing visual feedback and comprehensive data about the selected areas, the user is empowered to make strategic decisions about the design plan.

In another example, if the selected area 1503 is part of a commercial space, the pop-up window 1504 may highlight areas where lighting or ventilation systems need to be enhanced for energy efficiency. The GAN engine could generate suggestions that involve repositioning windows or adding energy-efficient lighting fixtures. The user may accept these recommendations directly from the table 1505, which also calculates the cost and time required for implementing these modifications.

The AI engine may also assess the sustainability of the materials used in the selected areas. For example, if the selected area 1503 is being redesigned for a green building project, the table 1505 could display suggestions for replacing conventional materials with eco-friendly alternatives. The system could cross-reference external vendor databases to source sustainable building materials, integrating this information directly into the design plan.

Referring now to FIG. 15C, it illustrates an exemplary water closet area 1510, which may have been flagged as an area requiring redesign in FIG. 15A. The controller of the present invention analyzes the spatial configuration and design elements within the water closet area 1510 to determine if they meet user requirements, compliance standards such as ADA (Americans with Disabilities Act), or other design considerations. This space, like the rest of the design plan, may be subjected to various automated checks by the controller to identify potential improvements or non-compliance.

In FIG. 15C, the water closet area 1510 contains several elements that may require redesign or modification. The controller analyzes the distance 1513 between the water closet 1511 and the sink 1512, as proper spacing is important for usability, accessibility, and compliance with certain regulations. For example, according to ADA guidelines, the distance between a toilet and a sink must accommodate enough space for a wheelchair to maneuver if the design is intended for accessible use. If this spacing does not meet these guidelines, the controller may automatically generate suggestions and/or make adjustments. For better accessibility, the ADA recommends that the distance should be wide enough for a 30-inch by 48-inch clear floor space around the water closet 1511, allowing unobstructed access to the sink 1512.

Further, the controller may also analyze the height and placement of the ventilation window 1514. In the case of this design plan, the dimensions and height of the window may not meet design standards for ventilation in small, enclosed spaces such as bathrooms. The height 1514A of the window from the floor to the base of the window may need to be adjusted to facilitate that it is at a comfortable height for opening or closing manually, if required. The controller may suggest that the window height be raised or lowered based on user inputs, the room's ceiling height, or design standards for natural ventilation in enclosed spaces. In some embodiments, if the window is positioned too high, it could restrict proper airflow, and the controller may recommend lowering it or increasing its size.

In addition to height, the controller examines the dimensions 1514B of the window. Depending on the size of the room and its intended purpose, ventilation requirements can vary significantly. For example, a larger window may be required to facilitate proper air circulation and prevent moisture buildup, which could lead to mold or other structural damage. If the window 1514 does not meet these requirements, the controller could suggest resizing the window, possibly enlarging it or repositioning it to allow better airflow or light penetration.

The redesign process within the water closet area 1510 may extend to other elements as well. For example, if the placement of the water closet 1511 does not comply with certain design principles, such as proximity to a wall or the entrance, the controller may suggest relocating the water closet to a more optimal position. ADA standards also require that there be sufficient clearance around the water closet for individuals who use mobility devices, such as wheelchairs. If this clearance is inadequate, the controller would flag this issue and generate an updated design with the correct measurements.

The controller's redesign suggestions are informed by design considerations, such as ADA compliance, user-specific preferences, and best practices for space efficiency. For example, in a public restroom, ADA guidelines recommend that grab bars be installed on the sidewall nearest the toilet. The system may flag the absence of such bars or suggest the placement of additional safety features to make the space compliant with relevant accessibility standards.

In some embodiments, the system may also take into account a flow of traffic within the bathroom area, facilitating that there is enough clearance for ease of movement. For example, if the room's dimensions are too small to accommodate more than one person comfortably, the controller may suggest expanding the bathroom or reallocating adjacent spaces to improve flow.

The controller also considers privacy concerns, particularly in public or semi-public spaces. If the window 1514 is too low or improperly positioned, it may compromise privacy. In such cases, the controller could suggest either repositioning the window or installing frosted glass to maintain privacy while still allowing for adequate ventilation. These suggestions would be based on both user preferences and local preferred building practices, which often dictate specific privacy requirements for bathrooms.

Another example of potential modifications is the sink 1512. The system may analyze whether the sink 1512 is positioned at the correct height, particularly for users with mobility issues. ADA guidelines recommend that the sink height should be within a range that allows wheelchair users to comfortably access the sink without obstruction. If the sink is mounted too high or too low, the system will recommend modifications to bring it into compliance. The design could also be adjusted to include a pedestal sink or a floating sink to provide additional knee clearance for wheelchair users.

Moreover, the system may analyze the space between the water closet 1511 and the adjacent walls to determine if there is enough clearance for ease of use. In small bathrooms, it is important to have at least eighteen inches of clearance from the centerline of the toilet to any adjacent wall or obstruction, as per ADA guidelines. If this clearance is not met, the controller may flag the issue and provide design alternatives, such as moving walls or resizing fixtures to create the required space.

The soap dispenser and mirror placement above the sink 1512 are other elements that may be analyzed. In commercial bathrooms or ADA-compliant spaces, soap dispensers and mirrors must be positioned at accessible heights. If these elements are too high or too low, the system may flag them for adjustment to accommodate a wider range of users, including those in wheelchairs.

Referring now to FIG. 15D, it illustrates how the controller 163 may generate or modify the design of a water closet area 1515, considering specific spatial and accessibility requirements based on design considerations 166. In this embodiment, the controller 163 analyzes the space within the water closet area 1515 and provides a recommended clearance between various elements. For example, the controller 163 may establish an appropriate distance of eighteen inches between the water closet 1511 and the adjacent sink 1512. This spacing allows for better user comfort and maneuverability within the confined space of a restroom.

The controller 163 may further design the water closet area 1515 by maintaining a minimum front clearance 1516 of 60 inches in front of the water closet 1511. This front clearance 1516 may be required for facilitating that wheelchair users can easily approach, transfer onto, and exit the water closet. The ample space also helps facilitate turning and movement for individuals with mobility challenges, adhering to ADA (Americans with Disabilities Act) guidelines or similar accessibility standards.

In some embodiments, the system may also take into account user-specific requirements or additional design considerations, such as the placement of accessible amenities or grab bars as part of the water closet design. The 66-inch minimum clearance for the overall area height further enhances the space's usability for different types of users, providing a functional and accessible layout.

The controller 163 may additionally suggest optimizing other components in the water closet area, such as the height of the sink 1512, so that it is within reach of both standing users and those in wheelchairs.

In some embodiments, the system's controller 163 is configured to analyze the water closet area 1515 within the design plan. Upon analyzing the spatial arrangement of the water closet 1511 and the sink 1512, the controller 163 evaluates a distance between these two elements based on predefined design considerations 166, such as accessibility requirements or preferred building practices, including guidelines like the Americans with Disabilities Act (ADA).

For example, if the controller 163 detects that the distance between the water closet 1511 and the sink 1512 is insufficient for wheelchair access or does not meet ergonomic standards for user comfort, the controller 163 will modify the design by adjusting the placement of these fixtures. The system may increase the distance between the water closet 1511 and the sink 1512 to meet accessibility standards, providing enough space for easy movement. Additionally, the controller 163 may factor in the overall layout of the bathroom, such as the position of doorways, windows, and other fixtures, to optimize both the design and functionality of the water closet area 1515. After making these adjustments, the updated design plan is generated, so that the space meets the predefined design considerations 166 while maintaining an efficient and accessible layout.

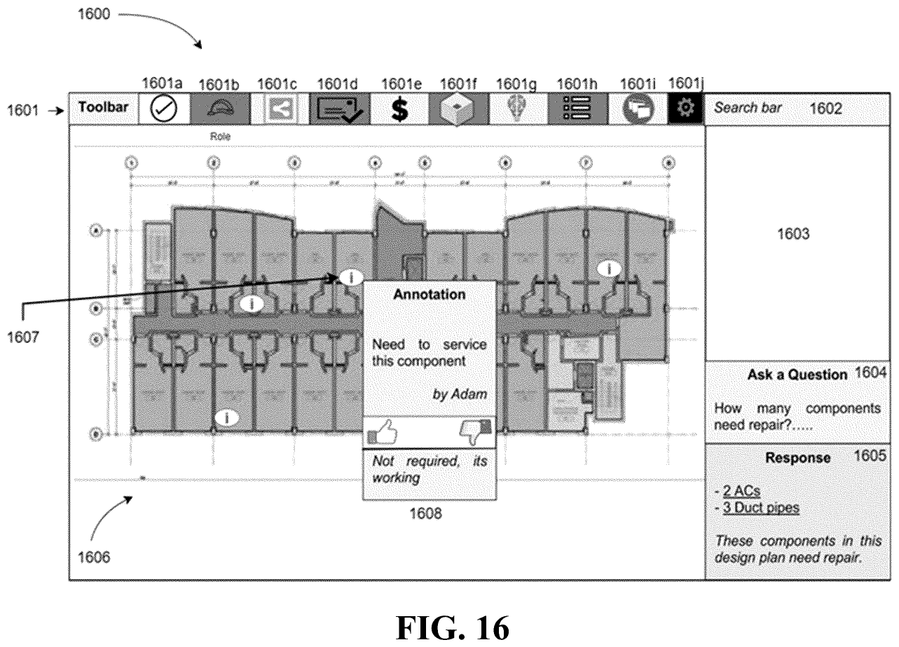

Referring now to FIG. 16, an exemplary interactive & collaborative user interface 1600 of an AI-powered system operative via executable software to provide spatial annotation process for construction and design projects. The spatial annotation process may affect design generation and modification processes of the present invention, as discussed in various embodiments. The interface 1600 shows a design plan 1606 adorned with various dynamic components. Many of these dynamic components (design elements) may comprise a respective annotation icon 1607, indicating that those elements have been annotated on the current design plan. These icons, when clicked, prompt an annotation window 1608 to appear, providing details such as the nature of the annotation, the contributor's identity, and options for interaction, including the ability to like, dislike, or comment. Such user interactions are used by the AI engine, which learns from this engagement to either automatically validate (approve or disapprove) annotations or offer intelligent annotation suggestions in future annotation processes.

A search bar 1602 is a powerful feature on the interface 1600, enabling users to quickly locate specific elements of the design plan within the collaborative platform (environment). For example, team members can input search queries such as “completed walls,” “remaining electrical fittings,” or “pending plumbing sections,” and receive instant results (within section 1603), making it an indispensable tool for project tracking and management. Moreover, the search functionality may be augmented by advanced filtering options which allow users to refine their search based on various criteria such as completion status, material type, or assigned personnel, further tailoring the search experience to the user's immediate needs. This enables a project manager to monitor the real-time status of construction tasks, a procurement officer to assess material requirements, or a safety inspector to evaluate compliance across the site, all through a few keystrokes.

Further, in a question section 1604, users can inquire about various aspects related to the design plan, such as queries regarding the details of certain design elements or clarification on annotation particulars. The AI engine analyzes these questions against the design plan, dynamic components, annotations, and associated data, providing prompt, accurate automated responses 1605, thus effectively acting as an intelligent assistant.

A toolbar 1601 offers an array of tools (1601a-1601j) for comprehensive project management and design interaction. A ‘Select’ option 1601a, for example, allows for the precise selection of design elements for annotation or modification and the sharing of specific plan segments or sections with other team members or stakeholders. Tool 1601b displays the roles and responsibilities assigned to team members, enhancing clarity in project management and task delegation. The tool 1601b may offer possibility to assign or change roles of the team members and see who are responsible for which task.

A ‘Share’ option 1601c facilitates distribution and sharing of design plan sections, design elements, or associated annotations with other stakeholders or team-members, facilitating collaborative continuity. With check compliance option 1601d, users can review compliance status of various government compliances and identify any breaches of best practices or project rules, facilitating that the project adheres to all regulatory standards.

Cost management may be handled by tool 1601e, where users can access real-time cost estimations, modify budgets, and manage procurement directly within the platform. Some embodiments may give users insight into the fiscal impact of every aspect of the design plan with no artificial delay in timing (sometimes referred to as “real time”). For example, if an architect decides to switch from hardwood to laminate flooring, tool 1601e will recalculate the material costs and update the budget with no time delay other than processing time.

Moreover, if a project manager wants to explore the financial repercussions of adding an additional floor to a building, tool 1601e can promptly adjust the estimated labor costs and additional resources needed. It enables users to play with different scenarios and see how each decision affects the overall budget, helping to prevent cost overruns and facilitate the project stays financially feasible. Additionally, procurement is streamlined through this tool, allowing users to directly engage with vendors and suppliers. If a construction lead identifies the need for more electrical wiring due to a design change, they can use tool 1601e to immediately reach out for quotes, place orders, and even track delivery statuses, all from within the platform.

Another feature 1601f allows for 3D visualization and navigation of the design plan, further enriched by real-time camera feeds from the physical site, creating a holistic and immersive view of the project's progression. This 3D visualization goes beyond static images, enabling stakeholders, team-members to virtually walk through the architectural design, rotate views to examine structural elements from all angles, and zoom in on specific details for a closer look.

For example, an interior designer may use the 3D navigation to visualize how natural light flow into a room at different times of the day, while a safety inspector may simulate evacuation routes during an emergency. The real-time camera feeds from the construction site further enhance this feature by providing a live comparison between the current state of construction and the 3D model. This real-time camera feed integration allows project managers to monitor progress remotely, conduct virtual site walks, and even catch potential issues before they become real problems.

AI-generated insights, important for informed decision-making, are accessible through 1601g feature, where users can also contribute to the training and refinement of the AI engine. Integration with third-party platforms, represented by 1601h feature, enables connections to vendors, code compliance services, and other important external resources. For example, the platform can integrate with a vendor management system, allowing users to directly solicit bids, place orders for materials, and even track shipments in real time.

A tool 1601i serves as an annotation center, where users can review all annotations and respond to any assigned tasks, while tool 1601j houses customizable settings options, allowing users to tailor the interface to their preferences and requirements.

Each of these features may support the workflow, from initial planning to final execution, facilitating the platform remains a central hub for coordination, communication, and management throughout the lifespan of a construction project.

In some embodiments of the present invention, an AI-powered collaborative platform is provided for spatial annotation process within architectural and construction projects. Initially, a controller receives a detailed two-dimensional or three-dimensional static representation of a building's design plan. An AI engine, integral to this system, delves into the representation, identifying various architectural elements and their spatial arrangements as depicted through a complex pattern of pixels. This initial analysis lays the groundwork for an interactive user interface that showcases these elements, making them ready for user interaction and annotation.

Users engage with this interface, selecting design elements to annotate, thereby infusing the digital blueprint with valuable insights and specifications. The AI engine plays a pivotal role, determining the precise spatial coordinates of each annotated element, effectively bridging the gap between digital annotation and physical reality. These annotations are dynamically linked to their corresponding elements, facilitating real-time updates across the collaborative environment for all participants.

Further sophistication is introduced as the platform accommodates the movement of both digital and physical versions of design elements. When an element's position is adjusted within the building's layout or the actual construction site, its associated annotations are automatically realigned within the two-dimensional or three-dimensional static representation, maintaining an unwavering accuracy and relevance of the project documentation.

An innovative question-and-answer feature empowers users to inquire about various project aspects directly through the interface. Leveraging the latest data, including recent changes or updates, the AI engine responds with precise, automated answers, effectively serving as an intelligent assistant.

Through the integration of third-party platforms, the system extends its utility beyond mere annotation. It facilitates material procurement, compliance checks, and even labor hiring, streamlining project management tasks and facilitating adherence to relevant standards and regulations.

In some embodiments of the present invention, the method additionally comprises determining a scale of the components included in the design plan and/or generating a user interface including user interactive areas to change at least one of: a size and shape of at least one of the dynamic components, the dynamic components may include, by way of non-limiting example, one or more of: architectural features, polygons or arcuate shapes; regions, areas, spaces, travel paths, egress paths, dominance hierarchies, occupancy loads, doorways, stairs, or other portion of a design plan that may be modified.

In some embodiments, dynamic components may include a polygon and/or arcuate shape. A method of practice of the present invention may further include the steps of: receiving an instruction via the interactive user interface to modify a parameter of the polygon and modifying the parameter of the polygon based upon the instruction received via the interactive user interface. The parameter modified may include one or both of: an area of the polygon; and a shape of the polygon.

In another aspect a dynamic component may include a line segment and/or arcuate segment, and methods of practice may include one or more of: receiving an instruction via an interactive user interface to modify a parameter of the line segment, and the method further includes the step of modifying the parameter of the line segment based upon the instruction received via the interactive user interface. The parameter of the line segment may include a length of the line segment, and the method may additionally include modifying a length of a wall based upon the modifying of the length of the line segment.

The parameter modified may additionally include a direction of the line segment and the method may additionally include modifying an area of a room based upon the modifying of the length and direction of the line segment. A boundary may be set based upon reference to a boundary allocation hierarchy.

In another aspect, a price may be associated with each of the quantities of items to be included in construction of the building. In addition, a type of labor associated with at least one of the items to be included in construction of the building may be designated based upon AI analysis of the first two-dimensional reference (i.e., first design plan) and the second two-dimensional reference (i.e., second design plan), respectively.

Methods of practice may additionally include the steps of: determining whether a design plan received into the controller includes a vector image, and if one of the first and the second design plans received into the controller includes a vector image, converting at least a portion of the vector image into a raster image. Implementations of the described techniques may include hardware, a method or process, or computer software on a computer-accessible medium.

A dynamic component may include a line segment and/or vector, and the method may further include the steps of: receiving an instruction via the interactive user interface to modify a parameter of the line segment and/or vector and modifying the parameter of the line segment and/or vector based upon the instruction received via the interactive user interface. The modified parameter may include a magnitude of the line segment and/or vector and/or a direction of the vector.

The method may additionally include the step of training the AI engine based upon a human identifying portions of a design plan to indicate that it includes a particular type of item; or to identify portions of the design plan that include a boundary. The AI engine via may also be trained by reference to a boundary allocation hierarchy.

The methods may additionally include the steps of: determining whether the design plans received into the controller includes a vector image, and if the design plan received into the controller does include a vector image converting at least a portion of the vector image into a raster image; and/or whether a design plan includes a vector image format. Implementations of the described techniques and method steps may include hardware (such as a controller and/or computer server), a method or process, or computer software on a computer-accessible medium.

Still further, in some embodiments, the controller may assess how assignment of different classes of space to one or more designated areas may alter conformance of a design with a specified code. Furthermore, in some embodiments, particular attributes of a building may be analyzed based upon laws or regulations in effect within a geopolitical boundary encompassing the building. In some embodiments, multiple disparate user interfaces may be used to communicate calculated parameters associated with determined attributes.

There may be alternative methods of receiving data from various sources that can be used to generate a design or to supplement a design created in the manners as have been described previously. For example, the system may receive an architectural file with intelligent features of various kinds as discussed in further detail herein.

In some embodiments, a system according to the present invention may operate in concert with a BIM or CAD design system, for example, as an add-in to these design systems and then the present system may have access to design elements, location data and the like directly. In other examples, the present system may access BIM or CAD design system data by loading data files from said systems. In still further examples, the present system may operate to capture data from display screens that are displaying designs from the said BIM or CAD design systems. As an additional example, the present compliance assessment system exhibits its versatility by harmoniously integrating with prominent design frameworks like BIM or CAD. This integration facilitates a proactive approach to evaluate the compliance of building designs in the nascent or initial stages of the creative process, considering an array of potential best practices. This early-stage assessment not only facilitates that the design in progress aligns with regulatory standards but also serves as a strategic time-saving measure, optimizing the efficiency of the overall design workflow. The synergy between compliance analysis and design systems not only enhances the precision of the evaluation at early stages, but also contributes to a more streamlined and resource-efficient architectural and engineering endeavour.

In a non-limiting example, the present system may receive a file in one of the REVIT native formats such as files of types RVT, RFA, RTE and RFT. Embodiments may also include receiving non-Revit compatible file formats, such as, one or more of: BMP, PNG, JPG, JPEG, and TIF.

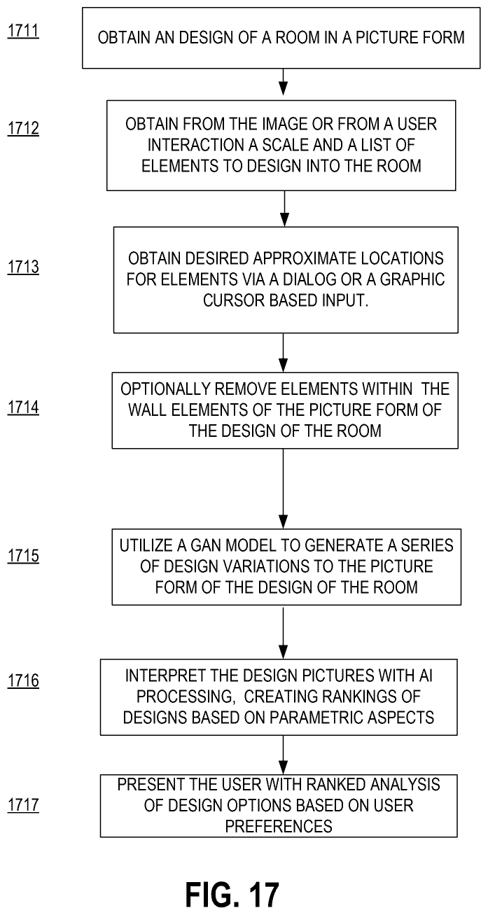

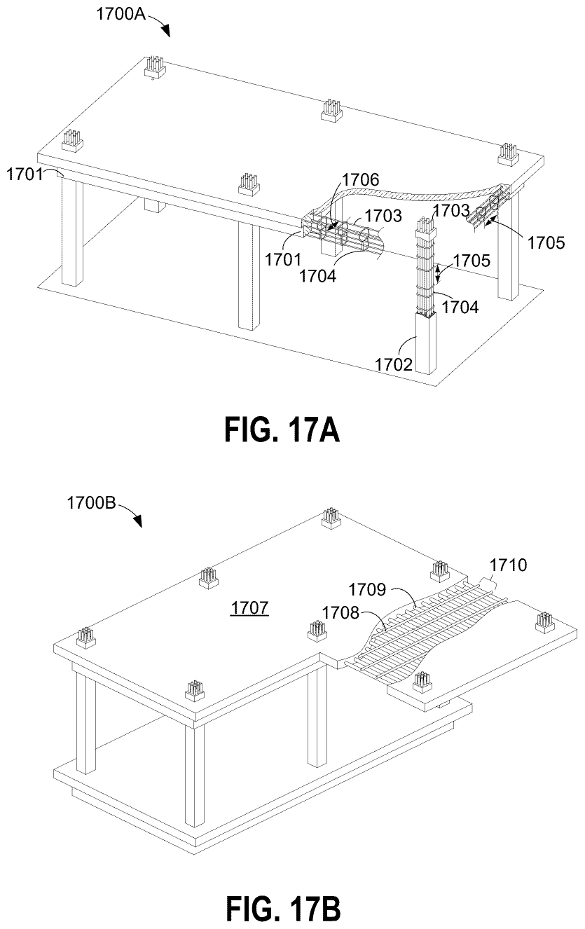

Referring now to FIGS. 17A-17B, exemplary structural design plans 1700A and 1700B are illustrated, which may be automatically generated by the controller (163) in accordance with the present invention. These figures depict structural components of a proposed building, specifically focusing on the design of columns, beams, and slabs. The controller, while generating these structural designs, refers to various design considerations, including the location of the building, the number of stories, and other important factors related to structural integrity and strength.

Referring now to FIG. 17, an exemplary processing flow is depicted. At block 1711, a user may submit attributes of a design plan. Although a complex generative adversarial model may be built to encompass various design plan types and various common elements of room types, it may also be practical to build individual working models for various room types where generative design is to be performed. Examples of various design plan element types and/or room types are described more fully below.

The submitted image at block 1711 may be of various types. The image may merely indicate walls and an indication of scaling of the image. The scaling may come from the imbedding into the design of a standard sizing calibration element such as a vernier or the like. In some other examples, textual annotations may indicate the scale of at least selected elements in the image. The classification aspects as have been described in previous sections may also be used to indicate different elements with different colors, shading or other distinguishing means, this process may be similar to segmentation or semantic segmentation aspects to be described herein.

The offered design picture in some other examples may include the presence of design elements incorporated into the space as well. For example, a bathroom may have toilets, sinks, exhaust fans, mirrors, and the like. Kitchens may have stoves, refrigerators, cabinets, counters, sinks and the like. Here too, the different elements may be indicated by different coloration or shading and may have textual classifiers associated with them either in the picture or in a table of reference between color and classifier. In some examples, a user may submit a two-dimensional design drawing and elect for the various classification algorithms as described herein to be performed to segment the different elements. Other algorithms may also be employed, and the user may provide a pre classified picture for generative processing in this processing flow. The annotation processing as described previously may be supplemented with this generative processing and in such cases, the overall design processor may be used by a user to select a portion of a design in process to submit at block 1711 in a picture format to process with the following generative processing resulting in design options returning to the overall system processing.

At block 1712, the user may indicate a nature of a scaling process provided in the drawing. For example, a menu may indicate the presence of a calibration element within the picture in some examples. In other examples, the user may provide a size calibration directly such as in a relationship of feet and inches or meters and centimeters to numbers of pixels for example. Furthermore, the user may also provide a list of elements to be included within the design space. In some examples, the user may be presented with menus that allow for a choice of a room type and then one or more sub menus that allow the user to select elements to be located within the design space.

In some examples, such as when the picture provides merely indications of walls without any elements internally located in the space, the generative process may edit the picture provided in block 1711 to add the specified elements. In some other examples, some or all of the selected room elements may already be located within the design picture provided in block 1711.

In some examples, algorithms may perform checking processes to determine whether consistency between a number and type of room elements and a size of the rooms in the design provided exists. Error messages and user dialogs may indicate consistency of physical sizing of elements to be chosen.

At block 1713, a process may occur to query the user for approximate placement of elements. In some examples, an element may be provided in the picture design already and the dialog to the user is whether the element should be allowed to be moved by the generative process and if so, a desired location for placement, such as the indication of a particular wall element. Thus, already included elements may be left where they are, or they may be moved in the generative process with higher “scores” related to placements closer to the desired placement location. For elements that do not exist in the provided picture, the user may be providing a desired location for when the element is added. In some examples, it may be allowable for a user to select the entire space to give the generative process full freedom to place the element in generated designs.

In some examples, multiple versions of a given element may be specified and treated as a separate segmentation element with an indicated location preference. It may be noted that for example, two sinks within a bathroom may be placed as separate elements. In some examples, as part of the location indication process, the user may also have ability to specify or edit style aspects or sizes of the element. These various degrees of freedom may have relevance when training an editing process in a generative adversarial based network model that is developed as will be described further. For description of the process flow illustrated in FIG. 17, it may be assumed that an AI generative model may be trained to allow the editing of an inputted design space with the context of the various types of user provided specifications and characteristic choice indications.

In some examples, especially when a user allows for degrees of freedom to the model, the generative process may involve the generation of numerous design instances, which may include ranking based on various aspects as described in later sections, to be presented to a user consistent with the steps that have occurred in blocks 1711-1713.

At block 1714, a generative process may occur to edit a provided picture design to remove elements from it. For example, if during the setup process the user has specified a different location for an element or has allowed the generative process freedom to move the element, then a generative editing process may be performed on the picture design to remove these elements leaving only walls and fixed elements.

In some examples, some internal walls within a room may be considered elements subject to freedom of movement or removal during the generative process. Here too, these internal walls may be removed from the image at this point. In some examples, the edited design may be presented to the user for feedback and potential additional processing before proceeding.

At block 1715, the picture form space design, which may be edited to remove transient features may be edited in a generative process to provide one or more exemplary design variations consistent with the picture design, the scale of features within said design space and placements of those features as/if specified by the user. There may be numerous approaches consistent with this processing utilizing aspects and processing of a GAN.

For example, in some examples, a particular trained GAN's latent space may be studied exhaustively to identify latent variables which may be used and modified to accomplish the various editing steps as have been described. In some other examples, specific GANs may be developed using large, annotated training datasets including relatively exhaustive and annotated examples of different elements incorporated into function space designs where the annotations also direct the processing to associate segmentation labels to be used to control synthesis and editing of feature aspects. Still further approaches may utilize classifiers of attributes in combination with the annotated databases. Some approaches may focus on a GAN's parameter space rather than its latent space. In a specific approach, which forms the basis of more detailed examples herein, and which are based on the EditGAN approach, where the GAN model is based upon jointly modeled images and their semantic segmentations using shared latent codes; editing of an image of a particular room type may be edited in a straight-forward manner.

In FIG. 17A, the structural design plan 1700A shows a detailed configuration of beams 1701, columns 1702, and the placement of reinforcing bars (rebars) 1703. The design of these elements may be influenced by factors such as the geographic location of the building. For example, if the proposed building is located in a coastal area, the controller may increase the density of rebars 1703 and apply anti-corrosive coatings due to the higher risk of corrosion caused by salt in the air. In contrast, for a hilly or seismic area, the controller may design the structure with more flexible joints 1704 and closer spacing 1705 between joints 1704 to provide greater resilience to seismic activity.

In the structural design of FIG. 17A, the controller not only generates the number and placement of columns 1702 and beams 1701 but also details the reinforcement, such as the required number of rebars 1703 within each column. The spacing 1706 between rebars 1703 is important for distributing loads efficiently across the structure. The controller may adjust the spacing 1706 to adhere to specific design considerations, like increasing the number of rebars for high-load areas such as the ground floor or reducing the spacing between rebars in high-wind areas for added stability. Moreover, joints 1704 between the rebars 1703 provide structural continuity and to absorb the stress that the structure may experience during daily use or under extreme conditions.

Similarly, FIG. 17B illustrates the structural design plan 1700B, focusing on the slab structure 1707. The slab structure 1707 is designed with horizontal rebars 1708 and vertical rebars 1709, which are important for maintaining the structural integrity of the floor and transferring loads across the building. The controller designs the slab structure 1707 with these reinforcements based on factors such as the type of load the slab will bear (e.g., residential vs. industrial), and environmental factors like temperature variations, which can affect the expansion and contraction of materials. For example, a slab in a cold climate area may have different rebar spacing 1710 to allow for thermal expansion, while a slab in a hot climate may require additional reinforcements to prevent cracking due to heat.

In both design plans 1700A and 1700B, the controller uses its AI and GAN engine capabilities to analyze and optimize structural components, so that they meet all relevant design considerations. These considerations may include not only the immediate structural needs but also long-term maintenance, cost-efficiency, and compliance with safety standards such as preferred building practices for seismic activity, wind resistance, or even fire safety. Each element, from the columns 1702 to the horizontal rebars 1708, may be designed with precision to maximize structural integrity, minimize material usage, and streamline the construction process.

The design generation process also allows for user input. A user may provide specific requirements for the building, such as the number of floors or the desired load-bearing capacity of the structure. The controller may then adjust the thickness of beams 1701 or the density of rebars 1703 within the columns 1702 accordingly. Furthermore, if the user specifies particular environmental challenges, such as proximity to an earthquake-prone zone, the controller may increase the flexibility of the joints 1704 and the density of the vertical rebars 1709 in the slab structure 1707.

The versatility of the controller in generating design plans 1700A and 1700B lies in its ability to combine user-defined parameters with established design considerations. This results in a highly adaptable and resilient structure that can be modified at any point in the construction process or even after construction has been completed. Whether the building is located in a high-wind coastal area, a high-seismic zone, or a dense urban environment, the structural design generated by the controller is flexible enough to account for various external factors, internal requirements, and long-term durability.

In some embodiments, the design plans (e.g., 1700A and 1700B) may include structural elements such as beams, columns, and slabs, which are integral to the building's stability. The controller, equipped with the AI engine, is configured to assess the structural integrity of these elements in response to user inputs for modifying the design plan (for example, as discussed in FIG. 1G-1J). For example, when a user requests to change the placement or size of a column or beam, the controller analyzes how this modification impacts the overall structural framework.

The controller evaluates the structural loads, the distribution of forces, and the potential stress points on the modified beams or columns. It considers predefined design considerations such as load-bearing capacity, material strength, and compliance with preferred building practices and safety regulations. For example, if a user attempts to reduce the size of a column that supports multiple floors, the controller may calculate whether the new column size can safely bear the load. If not, the system generates a warning or suggests alternative solutions, such as increasing the size of adjacent beams or adding reinforcement bars within the column.

The system may also assess slab configurations, so that the spacing between rebars, joints, and other important elements adheres to structural guidelines. After performing these assessments, the controller generates an updated design plan that incorporates the user's modifications while maintaining structural integrity, facilitating that the building remains safe and functional after the changes are implemented.

In the context of the present invention, structural elements may refer to the components that provide support, stability, and integrity to a building or structure. These elements include, but are not limited to, columns, beams, slabs, walls, and foundations, which work together to bear loads and distribute forces throughout the structure. Columns are vertical load-bearing elements that support beams, slabs, or other horizontal members, while beams are horizontal elements that transfer loads from floors or roofs to columns or walls. Slabs are flat horizontal surfaces, typically forming floors or ceilings, and can include reinforcement like steel bars (rebars) for added strength. Walls, which may be load-bearing or partition walls, serve both structural and spatial division purposes. Foundations, located at the base of the structure, transfer loads from the building into the ground, providing overall stability. Additionally, structural elements may include bracing systems, shear walls, trusses, and connections between components, which contribute to the building's ability to withstand forces such as gravity, wind, seismic activity, or other environmental factors. In certain cases, the design and placement of these elements also account for compliance with local preferred building practices, seismic standards, and the intended use or capacity of the building.

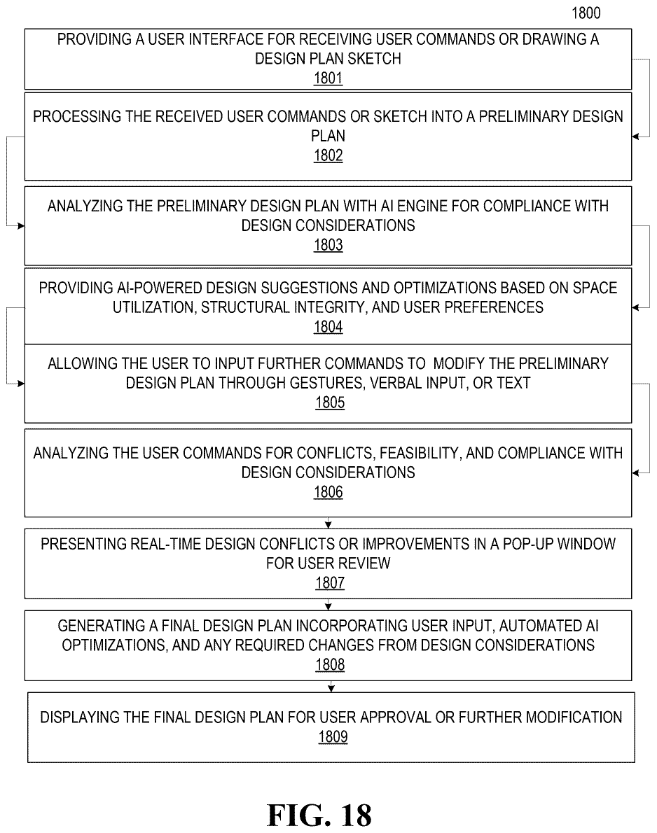

Referring now to FIG. 18, an exemplary flowchart 1800 represents method steps for design plan generation and modification in accordance with the present invention. The process begins with a user interface functional to receive various forms of user inputs, including commands or drawn sketches, and subsequently translates them into a preliminary design plan. The method leverages an AI-powered engine to analyze and optimize the design based on predefined design considerations such as structural integrity, spatial efficiency, and user preferences. Throughout the iterative process, the system enables real-time modifications by the user, offering interactive suggestions, detecting potential conflicts, and facilitating the feasibility of the proposed modifications. Ultimately, the method leads to the generation of a finalized design plan that aligns with both user-defined goals and compliance with relevant standards before it is presented for user approval or further adjustments. Each step within this flowchart embodies a dynamic interplay between user interaction and AI-driven design intelligence, facilitating the efficient creation and modification of complex architectural layouts.

At step 1801, the system provides a user interface for receiving user commands or allowing the user to draw a design plan sketch. This step involves an interactive platform where users can either directly input commands or use drawing tools to sketch out the layout of the design plan. For example, if the user prefers to use verbal commands, the interface may accept commands such as “Create a three-bedroom layout with a garden area,” while another user may choose to draw room boundaries manually with a stylus on a tablet. The system is flexible and responsive, allowing multiple forms of input, such as written, spoken, or gestured commands, and thereby tailors a design process to a user's preferred method of interaction.

At step 1802, the system processes the received user commands or sketch into a preliminary design plan. This process involves translating user input into a coherent design structure. For example, if the user has sketched out a rough floor plan, the system analyzes the sketch and converts it into architectural elements like walls, rooms, doors, and windows. Similarly, if the user has provided commands, the system interprets these commands into structured design components. For example, when a user instructs the system to “add a master bedroom with an attached bathroom,” the system generates a proportional layout and places the components accurately within the design plan, taking into account any previously input dimensions.

At step 1803, the preliminary design plan is analyzed by the AI engine for compliance with design considerations. The AI engine in the system reviews the preliminary design for aspects such as spatial distribution, accessibility, and adherence to preferred building practices or client-specific requirements. For example, in a residential design, the AI engine may check the room sizes against regulatory standards, such as ADA (Americans with Disabilities Act) requirements, facilitating that door widths and bathroom dimensions allow for wheelchair access. The AI engine's analysis can also include environmental considerations, like optimizing window placement to enhance natural lighting.

At step 1804, the system provides AI-powered design suggestions and optimizations based on space utilization, structural integrity, and user preferences. At this stage, the AI engine suggests enhancements to the design that may improve its efficiency or functionality. For example, the system may recommend rearranging certain rooms to maximize space utilization or propose changes in wall positioning to improve structural stability. Additionally, user preferences, such as specific materials or design styles (e.g., modern or traditional), are considered during this step. The system may suggest moving a window to optimize natural light in a bedroom or propose specific construction materials that align with the user's eco-friendly preferences.

At step 1805, the system allows the user to input further commands to modify the preliminary design plan through gestures, verbal input, or text. This step marks an interactive phase where the user is invited to refine the initial design. For example, after viewing the AI's suggestions, the user may verbally request, “Move the kitchen next to the living room,” or use a stylus to drag a room's boundary to resize it. The system adapts to the user's ongoing modifications, facilitating that every change is accurately reflected in real time within the design plan. This stage is highly dynamic, allowing iterative input from the user as they perfect the design to their liking.

At step 1806, the system analyzes the user commands for conflicts, feasibility, and compliance with design considerations. After the user makes modifications, the system checks the updated design for any conflicts or feasibility issues. For example, if a user moves a wall that interferes with a pre-established plumbing line or violates fire safety codes, the system identifies these problems. It can also determine whether the modifications are feasible in terms of construction or practicality. For example, moving a load-bearing wall may trigger a feasibility warning from the AI engine, which then proposes alternative solutions that meet the user's goals without compromising structural integrity.

At step 1807, the system presents real-time design conflicts or improvements in a pop-up window for user review. If the system detects any issues, it communicates them directly to the user through a pop-up window, offering suggestions or warnings about potential problems. For example, the pop-up may read, “The proposed kitchen location is too close to the bathroom, which violates hygiene codes. Would you like to move it?” The pop-up interface may also offer alternative solutions, such as moving the kitchen to a different area or adjusting the layout to facilitate compliance with design standards.

At step 1808, the system generates a final design plan incorporating user input, automated AI optimizations, and any required changes from design considerations. Once the user has made all desired modifications and the system has verified compliance with all relevant standards, the final design is generated. The AI engine integrates all elements, including user preferences, regulatory requirements, and structural optimizations, into a cohesive and executable design plan. For example, the final plan may include detailed specifications for each room, structural reinforcements based on the building's location, and suggested materials that align with both the user's budget and environmental considerations.

At step 1809, the system displays the final design plan for user approval or further modification. The user can review the entire design in a detailed format, which may include 2D blueprints or 3D models of the layout. The system offers the user an opportunity to either approve the final design or make additional tweaks before the plan is finalized. For example, a user may request a final adjustment, such as adding a small storage room or changing the dimensions of a particular space. Once the user is satisfied, the design is ready for the next steps, which could involve generating detailed construction plans, material lists, or sharing the design with other project stakeholders.

These steps outline the method for generating and modifying a design plan based on user inputs, where the system offers interactive AI-powered tools for design generation, analysis, and refinement, while considering various compliance and feasibility factors. Each stage allows for deep user involvement, supported by sophisticated AI analysis, facilitating that the final design is both user-centric and practical for implementation.

In some embodiments of the present invention, the design considerations used by the system for generating and modifying design plans are extensive and diverse, encompassing a wide range of factors that must be taken into account to produce a comprehensive, functional, and compliant design. These considerations are not limited to basic structural requirements but also integrate complex, context-sensitive parameters that adapt to different regions, climates, user preferences, regulatory standards, and project-specific objectives. The controller is operative via executable software to automatically factor in these considerations when generating or modifying a design plan, thus facilitating the outcome is tailored to the specific needs and constraints of the environment in which the building will be located or used.

### Geographical Location Considerations:

Geographical factors are among the most important design considerations that the system integrates. Depending on the location of the proposed building, the design may need to account for seismic activity, hurricane or cyclone risk, high winds, heavy rainfall, snow loads, or drought conditions. For example, buildings in earthquake-prone regions (e.g., California, Japan) require specialized structural integrity, including reinforced concrete, steel frames, and flexible foundations to absorb seismic energy. In coastal regions prone to hurricanes (e.g., the Caribbean, Southeast Asia), the system may design for wind-resistant structures, including deeper foundations, impact-resistant windows, and storm shutters. Additionally, the foundation depth, slope stabilization techniques, and drainage systems may vary significantly between mountainous areas and flat terrains, with hilly regions demanding stronger structural anchoring and slope drainage systems.

### Climate and Weather Conditions:

Design considerations also extend to the specific climate and weather conditions prevalent in the area. For example, buildings in hot, arid climates (e.g., the Middle East, Sahara) may incorporate reflective roofing materials, advanced insulation techniques, and passive cooling systems to reduce heat gain and optimize energy efficiency. On the other hand, buildings located in cold climates (e.g., Scandinavia, Alaska) may require enhanced thermal insulation, triple-glazed windows, and energy-efficient heating systems. The system is capable of recommending weather-specific materials such as concrete and steel in areas with fluctuating temperatures, where expansion and contraction are major concerns. It may also suggest designs with overhangs, sloped roofs, or rainwater harvesting systems in regions with high rainfall, facilitating effective water management and runoff.

### Regulatory and Compliance Considerations:

Regulatory compliance forms a major part of the design considerations the system integrates. This includes national, regional, and municipal preferred building practices, as well as international standards. For example, the system may facilitate that the design adheres to the American with Disabilities Act (ADA) standards in the United States, providing adequate accessibility features such as ramps, wide doors, and accessible restrooms. In Europe, the system may account for the Eurocodes, which are a set of structural design standards, ensuring that structural designs and the materials used are compliant with those standards. Fire safety regulations are another major consideration. For example, the system may incorporate fire exits, smoke detection systems, sprinkler systems, and fire-resistant materials based on local fire safety codes.

### Environmental and Sustainability Considerations:

Increasingly, environmental and sustainability considerations are a priority in design. The system may suggest environmentally friendly materials such as bamboo, recycled steel, or eco-concrete, and incorporate energy-saving designs like solar panels, green roofs, and rainwater recycling systems. In regions where sustainability certifications like LEED (Leadership in Energy and Environmental Design) or BREEAM (Building Research Establishment Environmental Assessment Method) are pursued, the system may optimize designs to meet the certification criteria, focusing on energy efficiency, water use reduction, and the sourcing of sustainable materials. For example, in drought-prone regions, the system may prioritize designs that integrate greywater recycling systems, low-water-use landscaping, and xeriscaping.

### Structural Integrity and Safety Considerations:

Structural integrity is another major design consideration. Depending on the building's intended use such as residential, commercial, or industrial, the system may recommend different structural materials, foundation types, and framing methods. In high-rise buildings, steel or composite materials may be recommended due to their high strength-to-weight ratio, while for low-rise buildings in rural areas, timber or brick may be more appropriate. The system also ensures that designs comply with local safety standards regarding structural load-bearing capacities, lateral loads (wind and seismic forces), and the overall stability of the structure. For example, buildings in flood-prone areas may need to be elevated above the floodplain, while those in snow-prone regions may require reinforced roofs with snow-load calculations.

### Aesthetic and Cultural Considerations:

In some cases, design considerations may also reflect aesthetic and cultural factors. In urban historical zones, the system may adhere to architectural guidelines that require buildings to blend with the surrounding environment in terms of appearance, color schemes, and materials. For example, in some geopolitical areas, strict architectural preservation rules exist, the present invention may be operative to receive user input to design according to such historical preservation rules and recommend designs that align with the traditional aesthetic of the area. In other contexts, cultural factors may be referenced to recommend the placement of doors, windows, or rooms according to cultural principles that promote harmony and balance.

### Functionality and User Preferences:

User preferences and functionality are equally important considerations. The system can accommodate a wide range of user inputs such as room sizes, layouts, and spatial configurations to meet the intended use of the building. For example, a user may require a large open-plan living area, additional bathrooms, or specific kitchen layouts, and the system can factor these preferences into the design while maintaining compliance with spatial, structural, and regulatory considerations. The system can also optimize for usability, ensuring that spaces like kitchens and bathrooms are positioned for maximum convenience, or that public spaces in commercial buildings are designed to handle the expected foot traffic.

### Technological Integration Considerations:

The system also takes into account the integration of technology into modern building designs. In smart buildings, the system may recommend designs that facilitate the installation of IoT devices, sensors, and automated systems. For example, it may propose cabling pathways, locations for smart thermostats, lighting controls, or security systems. In commercial buildings, the system may design server rooms with appropriate cooling systems, power supply units, and fire suppression systems. Similarly, designs for hospitals or healthcare facilities may include infrastructure for medical devices, patient monitoring systems, and sterile zones.

### Acoustic and Soundproofing Considerations:

Acoustic considerations are particularly important for buildings such as theaters, concert halls, and educational institutions. The system can incorporate soundproofing materials, suggest appropriate window placements, and design walls that minimize noise leakage. Additionally, in residential or commercial office buildings, it may suggest layouts and materials that reduce noise transfer between rooms, ensuring privacy and comfort for occupants.

### Cost and Budget Constraints:

In some cases, design considerations must align with the client's budget. The system can propose cost-effective alternatives to high-end materials or suggest phased construction plans that allow the building to be constructed in stages according to available funding. For example, the system may recommend affordable but durable materials like fiber cement siding for external cladding instead of more expensive materials like stone or brick.

### Adaptability and Future-Proofing Considerations:

The system may also account for adaptability and subsequent expansion. For example, the system may propose flexible space designs that can be easily converted from residential to commercial use, or from office space to residential apartments. It may also consider the potential need for future increases in building size, suggesting load-bearing walls or foundation designs that can accommodate additional floors in the future. Adaptable electrical and plumbing systems may also be recommended, allowing for easy modification or upgrade as technology evolves.

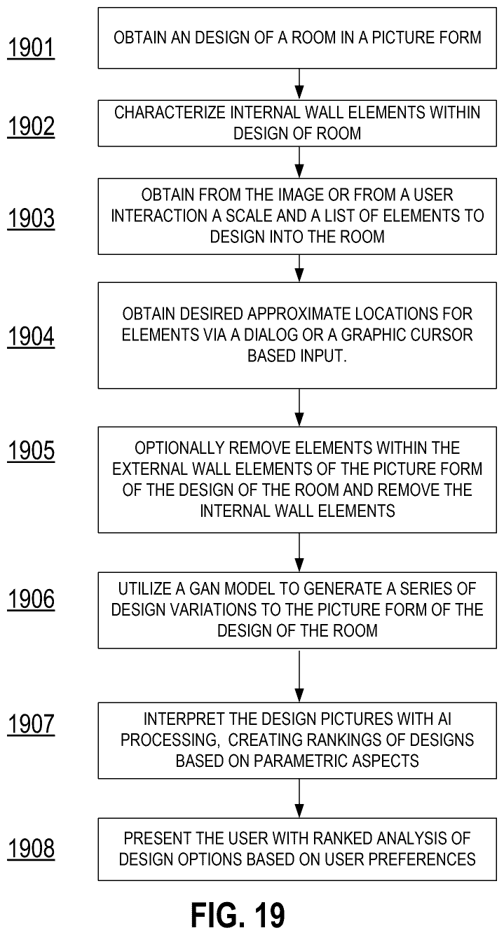

Referring to FIG. 19, a process is illustrated where select interior walls within a room type are available to the user and GAN model for editing. The editing may include changes in sizing, movement of location or orientation and elimination as non-limiting examples.

At step 1901, the process may start with obtaining a picture form of a room. The obtaining of a picture may include a user providing an image or interacting with a software package resulting in a selection of a room and a generation of an image data structure for the room.

At step 1902, a characterization of internal wall elements may be performed for the selected room. In some examples, a user may indicate these wall elements on a graphical interface. In other examples, an AI processing algorithm may indicate selectable wall elements it deems to be internal walls and provide these to a user for verification. By characterizing a wall as an internal wall element, the wall may be added to the list of room elements that may be modified, moved, or removed from a design during the AI based editing process. The movement of an internal wall may be tied to a need to fit one of the other moved elements in a new location or orientation for example.

At step 1903, elements from the image in addition to internal walls may be analyzed by an AI processing step or from a user interaction and these defined elements may provide for a scale and a list of elements to design into the room.

At step 1904, the processing may involve obtaining desired approximate locations for elements via a dialog or a graphic cursor-based input.

At step 1905, the processing may involve optionally removing elements within the external wall elements of the picture form of the design of the room including optionally removing internal wall elements.

At step 1906, a generative model such as a GAN based model may be utilized to generate a series of design variations to the picture form of the design of the room. In some examples, this may also include placing interior walls into a design as part of a generative process.

At step 1907, AI based process may further be used to interpret the resulting generative design pictures. The further processing may be used in creating rankings of designs based on parametric aspects such as logistics analysis, cost analysis, compliance analysis and the like.

At step 1908, the user may be presented with ranked analysis of design options based on user preferences.

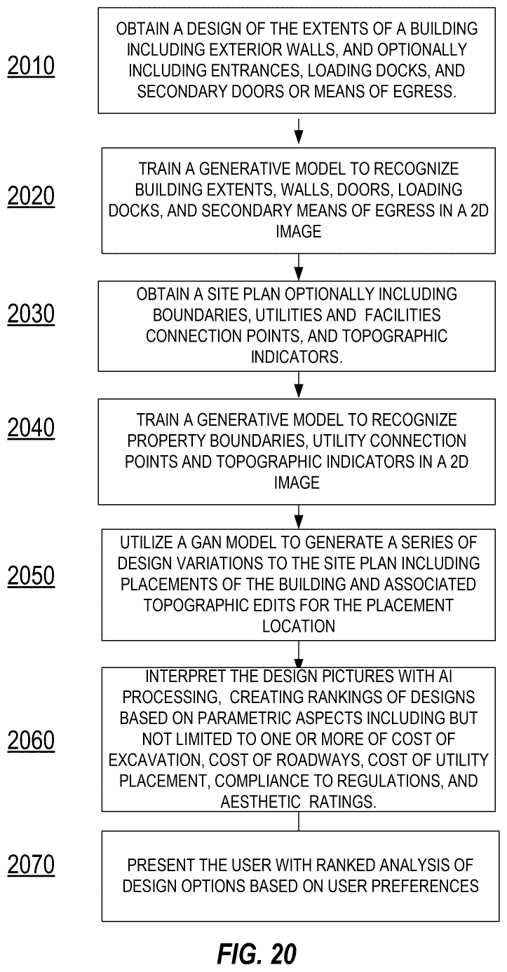

A different type of generative process may involve taking full building outlines and marrying them in a generative process upon a site plan type image. Referring to FIG. 20, exemplary method aspects for editing site plan images are described. At block 2010, the methods may include a step where a user obtains a design of the extents of a building. There may be many ways to obtain such a design. In some examples a modelling system may contain building models and architectural models, and it may be used to create a building extents image output. In other examples, a 2D image file may be obtained for a building design including a building extends figure. The image may be scanned from a hardcopy in some examples.

At block 2020, the AI analysis as has been described herein may be used to recognize various elements of a design including exterior walls, and optionally including entrances, loading docks, and secondary doors or means of egress. In some examples, the various identified elements may be color coded for semantic segmentation. Doors, entrances, loading docks and secondary doors may be important elements in site planning and make some orientations and placements more desirable than others. They also may create different excavation planning aspects as they create needs for grading of the site and associated cost. The building design may also provide identification of designed utilities connection points such as water, sewar, natural gas, electricity, and the like.

Proceeding to block 2030, a user may also obtain a site plan optionally including boundaries, utilities and facilities connection points, and topographic indicators. At block 2040, the various AI processing as have been described may be used to identify site boundaries, and the presence of utility connections including annotations for said utilities connection points. A model may also be built to identify topographic features such as elevation lines and a scale associated with them. In some examples, a user dialog may be presented to provide a scaling for features if they are not present on the site plan drawing. A user dialog may also be used to confirm an identification of the various features. In some examples, the various identified features may have different color shadings to identify semantic segmentations of the features. Pairs of site plan images and images with colorized items that have been segmented may be used in subsequent model training exercise.

Proceeding to block 2050, these image pairs may be used to train a generative model to recognize property boundaries, utility connection points and topographic indicators in a 2D image and associated editing steps. For example, a set of building examples, including site plans before and after their placement, which may have been prepared as in the steps outlined in blocks 2010 and 2020 may be used to create training sets for the effect of placing a building upon the site plan. When a building is placed, for example, the land may be excavated, affecting the topography in learnable and standard ways. For example, the building may have a generally flat placement aspect and thus excavation to even out hills and valleys on a given site may be planned. The semantically identified topographic lines before and after a building placement may be learned by an editing model. In some examples, more complicated placement aspects such as the location of multiple buildings upon a site plan may be trained. In some examples, different placements of a building may be associated with textual commands, to allow a trained model to be responsive based on textual commands. In other examples, graphical user interface commands may be trained in addition or instead of the training of textual commands.

Furthermore, the various utilities connections may be modelled in the training set. For example, a placement of a building in a particular location and with a particular rotational orientation may generate a plan path for underground placement of water, sewar and electric lines. Connecting a site plan's utility connection points to a building design's utility connection point may be trained into a model, however, in some examples a user interface may be provided to graphically lay out a desired routing path, at least as a starting point before generative processes are performed.

At block 2050, a resulting GAN model may be used to create at least a first design result of superimposing a building design upon a site plan. In some examples, an iterative process may generate multiple images from random starting points. In some other examples, an iterative process may adjust parameters between generative passes to create different designs for comparisons.

At block 2060, the various GAN model design outputs may be subjected to further analysis to again determine the various elements in the design. Using the assigned element aspects various estimation algorithms may be applied to create figures of merit for the building designs. In a non-limiting sense, for example, a cost estimate may be applied for excavation work and utilities costing. In an example, the topographic line elements in the initial site plan may be compared to the topographic elements in a design output and the comparison used to estimate the amount of cost for excavation based on topography changes. As well, the length of utilities routing may be applied both for an estimated cost of excavation as well as a cost for conduit, wiring, piping, and the like. There may also be estimates for compliance with various codes such as boundary set back requirements, if an estimate were to trigger a compliance issue, a further analysis may estimate a cost for a variance procedure for a given design. Roadway costs may be estimated based on a design's location of entrances, loading docks and the like compared with a roadway connection at a boundary. In some artificial intelligence models, an aesthetic rating may be trained from existing designs and public ratings of their aesthetics, and the resulting training provides an aesthetic rating for the various design options.

At block 2070, the various estimates may be presented to a user. A user dialog may be provided, in some examples, to allow a user to select which ranking criteria to apply to options as well as selecting how may options to display for a giving ranking criteria. Cost estimates may be assigned given selected parameters. In some examples, design options may be rated by users or clients and these ratings are used to train a customized model for the user or client and then iterative applied to generate new design options based on the perceived goodness in a particular round of generation of design elements.

In some examples, a user may provide editing instructions based on graphical user interfaces or textual commands to a given design/site map combination. The result may be a single graphic design result and thus ratings may be calculated for various parameters, but the results are not contrasted against a collection of results.

Editing of a design image using generative image processing tools may generate novel design options or user directed design modifications as a new image. There may be many different design tools and BIM system tools where incorporation of the new design may be desirable. In some examples, a processing tool may be developed to import the image into various design systems. As has been described in previous sections of this specification and in other specifications of the inventive entity, artificial intelligence tools may be used to process images and determine the presences of walls and other design elements in an automated fashion and may be used to create lines, polygons, and the like as elements of a design tool input. As has also been described herein, in some examples, the design tool input built from the raw image may include features where automated annotation may be applied as well. The result may be a generation of a file or data structure that may be imported into a design system to update a design containing the initial structure used to create an image for editing as has been described. In some examples, the processes related to the editing and incorporation into design tool inputs may be accomplished by a software tool running as an add-in, module, plug-in, interactive application, or other such feature of a design system or BIM system to allow other features to interact with designs resident in the system.

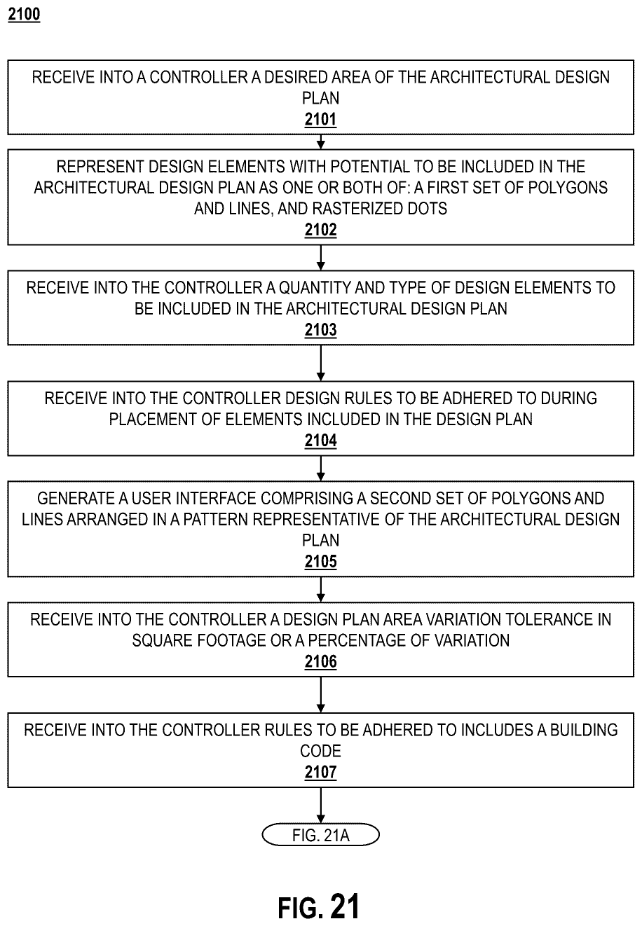

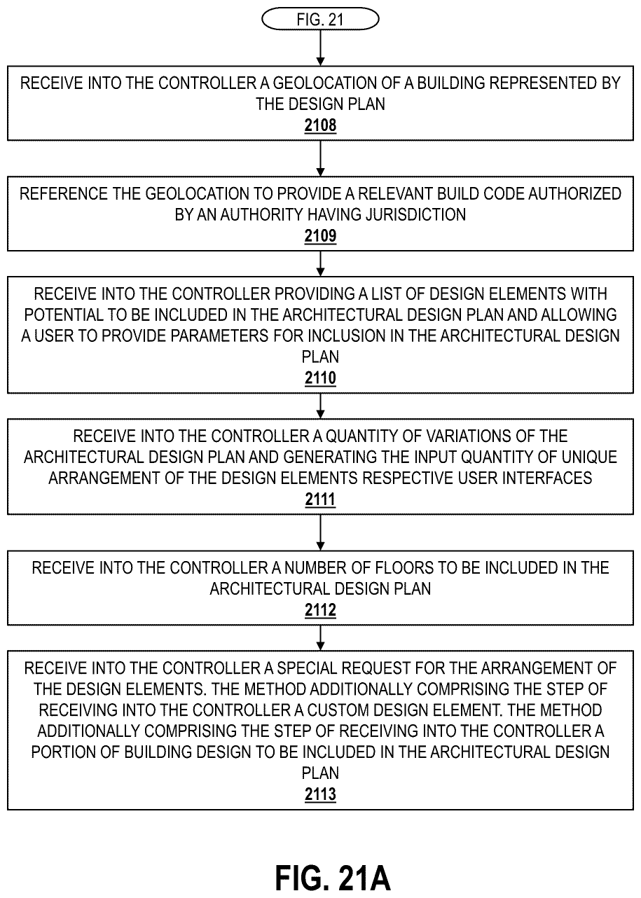

Referring now to FIGS. 21 and 21A, method steps that may be implemented in some embodiments of the present invention are illustrated. Method steps that may be practiced in some embodiments of the present invention may include one or more of the following actions in any order conducive to a desired output. In general, a user interface is generated that represents an architectural design plan and may be output as an architectural design plan. The user interface representative of an architectural design plan may be generated with one or more of:
At step 2101, method steps may include receiving into a controller a desired area of the architectural design plan;
At step 2102, method steps may include representing design elements with potential to be included in the architectural design plan as one or both of: a first set of polygons and lines, and rasterized dots;
At step 2103, method steps may include receiving into the controller a quantity and type of design elements to be included in the architectural design plan;
At step 2104, method steps may include receiving into the controller design rules to be adhered to during placement of elements included in the design plan; and
At step 2105, method steps may include generating a user interface comprising a second set of polygons and lines arranged in a pattern representative of the architectural design plan;
At step 2106 method steps may include receiving into the controller a design plan area variation tolerance in square footage or a percentage of variation;
At step 2107, method steps may include receiving into the controller rules to be adhered to comprises a building code;
At step 2108, method steps may include receiving into the controller a geolocation of a building represented by the design plan, wherein the geolocation is used to provide a relevant building code authorized by an authority having jurisdiction;
At step 2109, method steps may include receiving into the controller providing a list of design elements with potential to be included in the architectural design plan and allowing a user to provide parameters for inclusion in the architectural design plan;
At step 2111, method steps may include receiving into the controller a quantity of variations of the architectural design plan and generating the input quantity of unique arrangement of the design elements respective user interfaces;
At step 2112, method steps may include receiving into the controller a number of floors to be included in the architectural design plan;
At step 2113, method steps may include receiving into the controller a special request for the arrangement of the design elements;
At step 2114, method steps may include receiving into the controller a custom design element and at step 2115 receiving into the controller a portion of building design to be included in the architectural design plan.

The AI-powered collaborative platform for generating and editing design plans can be utilized in a variety of industries and applications. Additional applications for the above-described innovation may include but are not limited to one or more of the following:

Architecture and Construction: Architects and construction engineers can use the platform to collaboratively create and refine building designs. The AI algorithms can suggest structural improvements and identify potential issues, ensuring compliance with building codes and standards.

Product Design and Manufacturing: Product designers and engineers can leverage the platform to develop and iterate on product designs. The system's ability to handle various design formats and provide real-time feedback can significantly reduce the time from concept to production.

Urban Planning: Urban planners can use the platform to design and modify city layouts, infrastructure projects, and public spaces. The collaborative features allow for input from multiple stakeholders, ensuring comprehensive and inclusive planning.

Interior Design: Interior designers can create and edit room layouts, furniture arrangements, and decor plans. The AI can suggest aesthetic improvements and optimize space usage, enhancing the overall design quality.

Graphic Design: Graphic designers can collaborate on visual projects such as logos, advertisements, and marketing materials. The platform's version control and format conversion capabilities streamline the design process and ensure consistency across different media.

Engineering and Technical Drawings: Engineers can use the platform to create detailed technical drawings and schematics. The AI can assist in ensuring accuracy and adherence to industry standards, reducing the likelihood of errors.

Education and Training: Educational institutions can use the platform as a teaching tool for design-related courses. Students can collaborate on projects, receive AI-driven feedback, and learn from real-time suggestions and corrections.

Game and Animation Design: Game developers and animators can use the platform to design environments, and animations and settings used in the gaming environment. The AI can assist in optimizing designs for performance and visual appeal.

### Machinery Design:

Machinery designers can collaborate on apparatus designs, such as for example, machinery included in a building, elevators, automated doorways, windows, screens, kitchen equipment, etc. from concept sketches to detailed engineering drawings. The AI can help identify potential design flaws and suggest improvements, ensuring safety and performance standards are met.

Overall, the AI-powered collaborative platform enhances the efficiency, accuracy, and creativity of the design process across various fields, making it an invaluable tool for professionals and teams.

### CONCLUSION

A number of embodiments of the present invention have been described. While this specification contains many specific implementation details, they should not be construed as limitations on the scope of any claimable subject matter that may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings, and the detailed description thereto, are not intended to limit the present disclosure to the form disclosed, but to the contrary, the present disclosure is to cover all modifications, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” be used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

The design considerations used by the system are multi-faceted and comprehensive, ranging from fundamental structural integrity to advanced environmental, technological, and cultural requirements. By accounting for these diverse considerations, the system provides a robust framework for generating and modifying design plans that meet the unique needs of each project while remaining compliant with relevant regulations and user preferences.

### Glossary

“Artificial Intelligence” as used herein means machine-based decision making and machine learning including, but not limited to: supervised and unsupervised recognition of patterns, classification, and numerical regression. Supervised learning of patterns includes a human indicating that a pattern (such as a pattern of dots formed via the rasterization of a two-dimensional image) is representative of a line, polygon, shape, angle or other geometric form, or an architectural aspect, unsupervised learning can include a machine finding a pattern submitted for analysis. One or both may use mathematical optimization, formal logic, artificial neural networks, and methods based on one or more of: statistics, probability, linear regression, linear algebra, and/or matrix multiplication.

“AI Engine” as used herein an AI Engine (sometimes referred to as an AI model) refers to methods and apparatus for applying artificial intelligence and/or machine learning to a task performed by a controller. In some embodiments, a controller may be operative via executable software to function as an AI engine capable of recognizing aspects and/or tally aspects of a design plan that are relevant to generating an estimate for performing projects included in construction of a building or other activities related to construction of a building.

“Computer Aided Design,” sometimes referred to as “CAD,” as used herein shall mean the use of automation for the creation, modification, analysis, or optimization of a design plan or design plan file.

“Building Information Modeling” sometimes referred to as “BIM,” as used herein.

“Vector File” as used herein a vector file is a computer graphic that uses mathematical formulas to render its image. In some embodiments, a sharpness of a vector file will be agnostic to size within a range of sizes viewable on smart devices and personal computer display screens.

Typically, a vector image includes segments with two points. The two points create a path. Paths can be straight or curved. Paths may be connected at connection points. Connected paths form more complex shapes. More points may be used to form longer paths or closed shapes. Each path, curve, or shape has its own formula, so they can be sized up or down and the formulas will maintain the crispness and sharp qualities of each path.

A vector file may include connected paths that may be viewed as graphics. The paths that make up the graphics may include geometric shapes or portions of geometric shapes, such as: circles, ellipsis, Bezier curves, squares, rectangles, polygons, and lines. More sophisticated designs may be created by joining and intersecting shapes and/or paths. Each shape may be treated as an individual object within the larger image. Vector graphics are scalable, such that they may be increased or decreased without significantly distorting the image.

The terms “design plan,” “building plan,” “building design,” “floor plan,” “two-dimensional reference,” “two-dimensional or three-dimensional static representation,” or simply “design” are used interchangeably, often referring to the same or similar concepts in the context of architectural or construction documentation.

The present invention provides for systems of one or more computers that can be configured to perform particular operations or actions by virtue of having software, firmware, hardware, or a combination of them installed on the system that in operation causes or cause the system to perform the actions. One or more computer programs can be configured to perform artificial intelligence operations or actions by virtue of including instructions that, when executed by data processing apparatus, cause the apparatus to perform the actions.

### CONCLUSION

A number of embodiments of the present disclosure have been described. While this specification contains many specific implementation details, they should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings, and the detailed description thereto, are not intended to limit the present disclosure to the form disclosed, but to the contrary, the present disclosure is to cover all modifications, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” be used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for generating a design plan of a building, the method comprising the steps of:
a. receiving, by a controller, one or more user inputs through an interactive user interface, wherein the one or more user inputs comprise one or more of: written text, verbal commands, gestures, or a sketch drawn on the interactive user interface, and wherein the one or more user inputs relate to the generation of a design plan for at least a portion of the building;
b. analyzing, by the controller, the received one or more user inputs to generate an initial design plan based on the user inputs;
c. referencing, by the controller, a database of design considerations to determine if the initial design plan complies with the design considerations;
d. presenting, by the controller, one or more design conflicts on the interactive user interface if the initial design plan does not comply with the design considerations; and
e. generating, by the controller, an updated design plan based on one or both of: the initial design plan complying with the design considerations, and a resolution of the one or more design conflicts by a user providing additional inputs.

2. The method of claim 1, wherein the design considerations comprise one or more of: preferred design practices, building deployment objectives, building codes, client-specific requirements, structural integrity, environmental conditions, and geographic location of the building.

3. The method of claim 2, further comprising the step of: presenting, by the controller, a set of context-related questions to the user via the interactive user interface, and receiving corresponding user responses to refine the design plan.

4. The method of claim 3, further comprising the step of: determining, by the controller, an impact of the corresponding user responses on the design plan based on referencing the design considerations.

5. The method of claim 1, wherein the controller generates multiple design alternatives for the design plan based on the one or more user inputs and predefined style templates, including one or more of: modern, traditional, or minimalist.

6. The method of claim 1, wherein the controller analyzes the one or more user inputs to determine potential cost implications of the design plan and presents a cost estimate to the user via the interactive user interface.

7. The method of claim 5, wherein the controller further provides cost-saving suggestions to the user based on the design considerations and user inputs, and the method further comprises generating the updated design plan based on the cost-saving suggestions.

8. The method of claim 1, wherein the controller generates the design plan by arranging design elements as one or both of: a first set of polygons and lines, and rasterized dots, and wherein the design elements include one or more of: rooms, walls, doors, windows, fixtures, appliances, airflow paths, and structural components.

9. The method of claim 1, wherein the controller enables remote collaboration between multiple users, wherein each user interacts with the design plan to provide, modify, or approve annotations related to specific design elements.

10. The method of claim 9, wherein the annotations provided by users comprise one or more of: textual comments, graphical symbols, multimedia files, or notes regarding modifications to specific design elements.

11. The method of claim 1, wherein the one or more user inputs include a sketch drawn on the interactive user interface, and the controller interprets the sketch to generate the initial design plan by identifying spatial configurations, design elements, and architectural features.

12. The method of claim 1, wherein the controller generates warnings or alerts when the one or more user inputs result in non-compliance with the design considerations, and the warnings include suggestions for resolving the non-compliance.

13. The method of claim 1, wherein the controller automatically suggests furniture placement based on dimensions and function of spaces in the design plan.

14. The method of claim 1, wherein the controller determines a context of the one or more user inputs by analyzing environmental conditions, including climate, weather patterns, and geographic location of the building.

15. The method of claim 1, wherein the controller generates multiple design alternatives for the design plan based on predefined style templates, including one or more of: modern, traditional, or minimalist.

16. The method of claim 1, wherein the controller analyzes the design plan to identify areas of improvement or conflicts and provides modification suggestions before receiving additional user inputs.

17. The method of claim 1, wherein the controller enables remote collaboration between multiple users, allowing each user to provide, modify, or approve annotations related to specific design elements in the design plan.

18. The method of claim 1, wherein the controller determines potential cost implications of the design plan and presents a cost estimate to the user via the interactive user interface.

19. The method of claim 1, wherein the controller generates a set of context-related questions to clarify user preferences regarding one or more of: placement, dimensions, and orientation of design elements such as windows, doors, walls, spaces, furniture, fixtures, appliances, and airflow paths.

20. The method of claim 1, wherein the controller generates an updated design plan by incorporating cultural principles for buildings in geographical areas where such principles are practiced.

21. A method for modifying a design plan of a building, the method comprising the steps of:
a. receiving, by a controller, a design plan of at least a portion of the building, wherein the controller comprises one or both of: an Artificial Intelligence (AI) engine and a Generative Adversarial Network (GAN) engine;
b. analyzing, by the controller, the design plan, wherein the controller is configured to identify spatial configurations, design elements, and architectural features including one or more of: rooms, walls, doors, windows, airflow paths, and structural components;
c. receiving a user input for a modification of the design plan, wherein the user input is provided via one or more input methods, including text commands, verbal commands, gestures, or graphical sketches on an interactive user interface, and wherein the user input relates to modifying at least one of: spatial configurations, design elements, and architectural features;
d. determining, by the controller, a context of the modification of the design plan based on the user input and predefined design considerations, wherein the controller evaluates an impact of the modification of the design plan, analyzing how the user input may affect one or more of: spatial configurations, design elements, architectural features, building performance, client requirements, and compliance with the predefined design considerations; and
e. generating, by the controller, an updated design plan based on the user input and the determination of the context of the modification of the design plan.

22. The method of claim 21, further comprising the step of: presenting, by the controller, a set of context-related questions to a user via the interactive user interface, and receiving corresponding user responses to refine the design plan.

23. The method of claim 21, wherein a data base of design considerations includes one or more of: preferred building practices, structural integrity standards, environmental sustainability guidelines, cultural principles, and building codes.

24. The method of claim 21, wherein the controller generates warnings or alerts when the user input results in non-compliance with the predefined design considerations, and the warnings include suggestions for resolving the non-compliance.

25. The method of claim 21, wherein the controller automatically suggests furniture placement based on dimensions and function of spaces in the design plan.

26. The method of claim 21, wherein the controller determines the context of the user input by analyzing environmental conditions, including climate, weather patterns, and geographic location of the building.

27. The method of claim 21, wherein the controller generates multiple design alternatives for the design plan based on predefined style templates, including one or more of: modern, traditional, or minimalist.

28. The method of claim 21, wherein the controller analyzes the design plan to identify areas of improvement or conflicts and provides modification suggestions before receiving additional user inputs.

29. The method of claim 21, wherein the controller enables remote collaboration between multiple users, allowing each user to provide, modify, or approve annotations related to specific design elements in the design plan.

30. The method of claim 22, wherein the controller determines potential cost implications of the design plan and presents a cost estimate to the user via the interactive user interface.

31. An apparatus for generating a design plan of a building based on user inputs, the apparatus comprising:
a display screen for presenting an interactive user interface;
a digital storage medium comprising an executable software code; and
a controller operating one or both of: an Artificial Intelligence (AI) engine and a Generative Adversarial Network (GAN) engine, wherein the controller comprises a processor, and wherein the executable software code, when executed by the processor, causes the processor to:
a. receive, by the controller, one or more user inputs through the interactive user interface, wherein the one or more user inputs comprise one or more of: written text, verbal commands, and a sketch drawn on the interactive user interface, wherein the one or more user inputs relate to creation of a design plan for at least a portion of the building;
b. analyze the received one or more user inputs to generate an initial design plan based on the one or more user inputs;
c. reference a database of design considerations to determine if the initial design plan is in compliance with the design considerations;
d. recognize one or more design conflicts if the initial design plan is not in compliance with the design considerations; and
e. generate, if the initial design plan is not in compliance with the design considerations, an updated design plan based on one or both of: the initial design plan is in compliance with the design considerations, and a resolution to the one or more design conflicts.

32. The apparatus of claim 31, wherein the controller is further configured to generate a set of context-related questions based on the user inputs and receive corresponding user responses to refine the design plan.

33. The apparatus of claim 31, wherein the database of design considerations includes one or more of: preferred building practices, structural integrity standards, environmental sustainability guidelines, cultural principles, and building codes.

34. The apparatus of claim 31, wherein the controller is further configured to generate warnings or alerts when the user inputs result in non-compliance with the design considerations, and the warnings include suggestions for resolving the non-compliance.

35. The apparatus of claim 31, wherein the controller is further configured to automatically suggest furniture placement based on dimensions and function of spaces in the design plan.

36. The apparatus of claim 31, wherein the controller is further configured to determine a context of the user inputs by analyzing environmental conditions, including climate, weather patterns, and geographic location of the building.

37. The apparatus of claim 31, wherein the controller is further configured to generate multiple design alternatives for the design plan based on predefined style templates, including one or more of: modern, traditional, or minimalist.

38. The apparatus of claim 31, wherein the controller is further configured to analyze the design plan to identify areas of improvement or conflicts and provide modification suggestions before receiving additional user inputs.

39. The apparatus of claim 31, wherein the controller is further configured to enable remote collaboration between multiple users, allowing each user to provide, modify, or approve annotations related to specific design elements in the design plan.

40. The apparatus of claim 31, wherein the controller is further configured to determine potential cost implications of the design plan and present a cost estimate to a user via the interactive user interface.

41. The apparatus of claim 31, wherein the controller is further configured to analyze the design plan to determine an impact of user inputs on natural lighting within the building.

42. The apparatus of claim 31, wherein the controller is further configured to analyze the design plan to determine an impact of user inputs on airflow paths within the building.

43. The apparatus of claim 31, wherein the controller is further configured to analyze the design plan to determine an impact of user inputs on structural integrity, including beams, columns, and slabs.

44. The apparatus of claim 31, wherein the controller is further configured to generate real-time alternative suggestions to modify the design plan when the user inputs affect one or more of: spatial configurations, design elements, architectural features, building performance, client requirements, and compliance with the design considerations.

45. The apparatus of claim 31, wherein the controller is further configured to automatically update the design plan to include recommended alternative suggestions to modify the design plan.

46. The apparatus of claim 31, wherein the controller is further configured to update the design plan to include recommended alternative suggestions to modify the design plan based on acceptance by a user via the interactive user interface.

47. The apparatus of claim 31, wherein the controller is further configured to analyze a water closet area of the design plan and modify the design plan by adjusting a distance between a water closet and a sink based on the design considerations.

48. The apparatus of claim 31, wherein the controller is further configured to analyze the design plan to determine compliance with seismic safety standards and suggest structural reinforcements for buildings in earthquake-prone areas.

49. The apparatus of claim 31, wherein the controller is further configured to analyze the design plan to determine compliance with cultural principles for buildings in geographical areas where such principles are practiced.

50. The apparatus of claim 31, wherein the controller is further configured to generate a user interface comprising dynamic components, including polygons and lines, that represent the design plan and allow a user to modify the design plan by interacting with the dynamic components.
